(19) United States
(12) Patent Application Publication
(10) Pub. No.: US 2007/0289019 A1
(43) Pub. Date: Dec. 13, 2007

(54) METHODOLOGY, SYSTEM AND COMPUTER READABLE MEDIUM FOR DETECTING AND MANAGING MALWARE THREATS

(76) Inventor: David Lowrey, Littleton, CO (US)

Correspondence Address: TIMOTHY J. MARTIN, P.C., 9250 WEST 5TH AVE, LAKEWOOD, CO, 80226, US

(21) Appl. No.: 11/738,937

(22) Filed: Apr. 23, 2007

Related U.S. Application Data
(60) Provisional application No. 60/793,475, filed on Apr. 21, 2006.

(51) Int. Cl. G06F 12/14

(52) U.S. Cl. 726/24

(57) ABSTRACT

In a method for assessing threats within a computer system, hidden processes are detected in the system's memory, with each hidden process being identified as an associated assessment object. A reboot check is performed to identify any registry keys modified during shut down, and each modified registry key is also identified as an associated assessment object. A threat assessment is then performed on each identified assessment object to ascertain a threat level corresponding thereto.

### BACKGROUND

As computers and operating systems have become more sophisticated and complex, so to have the software designers that write the code that runs on these systems. While most programmers focus their efforts on creating new and useful software tools that increase worker productivity, some programmers spend their time writing malicious software, or malware, that is designed to disrupt the operation of a computer or to infiltrate and steal information stored on the computer.

One of the first types of malware developed is known as a virus. It had long been theorized that a computer program could reproduce itself much like a viral protein reproduces itself in a living host cell. With the wide spread acceptance of personal computers in the 80's, programmers began to experiment with this idea by writing software that would insert a copy of itself into the instructions contained in otherwise innocuous executable files. Generally, these viruses were written as a prank or to “see if it could be done,” rather than for malicious intent.

As the Internet became more accessible another type of malware, known as a worm, began to appear. Unlike a virus, a worm does not rely on a host program to propagate. Worms are self-supporting programs that typically propagate themselves across a network, such as the Internet, by exploiting security holes in network server programs. Also, with the overwhelming popularity of the Windows® operating system (OS), worms can easily spread themselves across the Internet to thousands of computers by exploiting a single security hole.

While early malware was intended to be an experiment or a prank, eventually malware was developed with the intention to destroy files and hard disks, to disrupt network communications, and to shut down websites, etc. Destructive malware may be motivated by revenge against a former employer, as a form of computer terrorism, or as a form of protest. More recently a profit motive has been the driving force behind malware development. Consumers now have the ability to perform a variety of financial transactions online, such as paying utility bills, managing a stock portfolio, checking their credit card balances, and transferring funds between bank accounts. All of these transactions involve the transmission of sensitive financial and personal information. This type of information is an attractive target for thieves and has given rise to the most costly forms of malware.

This profit-motivated category of malware includes, for example, spyware, loggers, and dialers. Spyware programs gather information about a computer user's online activities and push unwanted pop-up ads to the computer's browser. Spyware may also alter the web browser's behavior by redirecting certain links to advertisements or websites. The spyware creator benefits financially from residuals associated with the advertising or websites that are pushed to infected computers. Loggers allow a thief to log the keystrokes that a user inputs into their computer. Thieves use loggers to intercept information such as passwords, credit card numbers, or other account information that could enable a thief to directly steal funds from an unwary computer user's accounts. Finally, a thief can use a dialer program to cause an infected computer to automatically dial a 1-900 number, for example. A dialer program will usually leave the phone line open, thereby incurring toll charges by the minute, which can result in an astronomical phone bill.

Spyware, loggers, and dialers generally attack computers via a Trojan horse program. The Trojan horse is basically a piece of desirable software that is downloaded free of charge from the Internet. Attached to the desirable software, and unbeknownst to the person downloading it, is some form of malware. When the desirable software is loaded and installed onto the computer, the malware is also installed. Regardless of whether the malware is a virus, a worm, or some other type malware and no matter how the malware came to be on the computer, all of these programs are designed to remain anonymous and undetected. The malware cannot carry out its nefarious purposes unless it is actively installed and running on the computer. Therefore, modern malware is designed to not only avoid detection but to avoid removal as well.

One method employed by malware to avoid detection and removal is to manipulate the system registry. The system registry is a central hierarchical database managed by the operating system to store configuration information for users, applications, and devices. Malware must manipulate the registry because it is the primary way to start a process running at boot time. As the computer boots the Windows® OS, for example, will interrogate the startup keys and load whatever process is described. Thus, malware often manipulates the registry to ensure that it is loaded at boot time. Because the malware's lifetime is dependent on registry keys within the registry, it will go to great lengths to ensure that its registry keys are not modified or moved. Malware may hide itself from being shown in the application process list or it might change its file names, registry keys, or key values during the reboot process. Malware may attempt to prevent its removal by continuously rewriting its registry keys to the registry. These tactics pose a problem for anti-virus software, and can go undetected by currently available techniques which simply remove registry keys without taking into account these interdependencies.

Another method malware uses to avoid detection and removal is through distributed module sets that have the ability to reload each other. Computer systems have evolved from hosting single processes or modules into systems that can host hundreds of processes and modules simultaneously. Applications have seen a migration from simple single-executable pieces of code into large multi-executable systems. Malware has also evolved to exploit the computer system's multi-processing capabilities. Instead of a single piece of code contained within a single file, malware is spread out among several executable files or modules, with each file possibly located in a different directory on a hard disk.

Dependent modules ensure that all modules are in memory. For example, given a set of three modules A, B, and C, module A will ensure that modules B and C remain in memory. Similarly, module B ensures that modules A and C remain in memory. Finally, module C ensures that modules A and B remain in memory. Thus, should module A be removed from memory or bit source, modules B or C will try to reload or rewrite module A from a bit source. Likewise, should module B be removed from memory or bit source, modules A or C will try to reload it from a bit source. And finally, should Module C be removed from memory, modules A or B will try to reload it. Given the dependencies between the modules, removing them from memory becomes problematic, particularly if one is not cognizant of their interrelationships.

In many cases the sophistication of malware in preventing its detection and removal exceeds the sophistication of publicly available anti-virus software. Most anti-virus software relies on a signature-based method for detection. This is a reactive approach to detection of malware. In signature based malware detection schemes an anti-virus software manufacturer must first identify a computer that appears to be infected with an unknown malware. Next, the manufacturer must identify the actual file that contains the malware. After having identified the file that contains the malware, the manufacturer will create a signature file based on that file. The signature is usually created by a hash function performed on the malware executable. Once the signature file is created the manufacturer must then distribute the signature file to its customers. Once the end user has the signature file they must load the signature into their anti-virus software and then scan their system for the malware. All of this takes time that allows the malicious software to infect and cause damage to many computers. It is also worth noting that malware protection and removal is generally performed by the end user at the client computer, which can frustrate an administrator's efforts to efficiently address a widespread malware threat if he/she must visit each individual client computer in order to run software detection and removal programs.

The foregoing examples of the related art and its/their related limitations are intended to be illustrative and not exclusive. Other limitations may become apparent to those practiced in the art upon a reading of the specification and a study of the drawings.

### SUMMARY

Provided herein is an anti-malware tool that can detect, in real time, malicious software that is loaded or has been recently loaded onto a computer. Further, this anti-malware software has the ability to defeat the sophisticated techniques employed by malware developers to prevent the removal of malicious software. Also provided is the ability to remotely manage the anti-malware software in order to detect and remove such threats without having to be “onsite.” Broadly, threats are assessed by detecting and identifying hidden processes in the computer system's memory. In addition, a reboot check is performed to identify any registry keys that have been modified during a computer shutdown process. Each identified process and registry key is assessed to ascertain a threat level corresponding thereto. Anti-malware software also includes the ability to remove the threat from the computer once identified and assessed.

These and other objects of the present invention will become more readily appreciated and understood from a consideration of the following detailed description of the preferred embodiment when taken together with the accompanying drawings, in which:

### BRIEF DESCRIPTION OF THE DRAWINGS

Exemplary embodiments are illustrated in the referenced figures of the drawings. It is intended that the embodiments and figures disclosed herein be considered illustrative rather than limiting. In the figures:

FIG. 1 is a diagram of representative computing environment for implementing one or more aspects of the teachings herein;

FIGS. 2a-p are screenshots of various windows associated with the malware detection and removal application program;

FIG. 3a a high level flow diagram for detecting hidden processes in memory;

FIG. 3b is a more detailed diagram for detecting hidden processes in memory;

FIG. 4 represents a high level flow diagram for assessing threats;

FIG. 5 represents a routine for performing a reboot check in FIG. 4;

FIG. 6 represents a routine for saving startup values in FIG. 4;

FIG. 7 represents a routine for performing a reboot analysis in FIG. 4;

FIG. 8 represents a routine for identifying startup key protectors;

FIGS. 9a & b and 10 collectively represent a routine for creating a registry log event in response to detection of a startup key protector;

FIGS. 11a & b comprise a high level diagram for performing a threat assessment on a given ASSESSMENT object;

FIG. 12 represents a routine for assessing COM server threats;

FIG. 13 represents a routine for categorizing the threat level of an ASSESSMENT object as either SEVERE or HIGH;

FIG. 14 represents a routine for ascertaining if an ASSESSMENT object is trying to hide itself;

FIGS. 15a-c collectively represent a routine for determining if an ASSESSMENT object is trying to prevent itself from being unloaded;

FIG. 16a-i, 17a & 17b, collectively represent a routine for identifying common elements among ASSESSMENT objects;

FIG. 18 is a high level flow diagram of a cleaning process for managing threats;

FIGS. 19a & b, respectively, represent general and more detailed methods for removing processes and modules through DOS;

FIG. 20 represents a preferred procedure for writing catalog files during the 1^{st} and 2^{nd} passes of the cleaning phase;

FIGS. 21a & b, respectively, represent general and more detailed methods for terminating a computer process;

FIG. 22 represents a preferred routine for terminating process during the cleaning phase;

FIG. 23 represents a preferred approach for unloading a module;

FIGS. 24a & b represents a preferred routine for unloading modules during the cleaning phase;

FIGS. 25a-e, collectively, represent the operation of cleaning the registry during the cleaning phase;

FIG. 26 represents an approach for determining a new threat level for an ASSESSMENT object;

FIG. 27 is a high level flow diagram representing an exemplary method for remote management of malware detection and removal;

FIG. 28 is a representative network deployment diagram for implementing the remote management capabilities;

FIGS. 29a & b, respectively, represent the client and security server initialization processes; and

FIGS. 30a-43 represent the various commands exchanged between, and support by, the various systems in the remote management embodiment.

### DETAILED DESCRIPTION

Rather than waiting for conventional anti-virus software manufacturers to identify, develop, and distribute signature-based keys or files, a more proactive approach is needed to detect and remove malware. For example, there is a need for an anti-malware tool that can detect, preferably in real-time, malicious software that is loaded or has been recently loaded onto a computer. Further, there is a need for an anti-malware software tool that has the ability to defeat the sophisticated techniques employed by malware developers to prevent the removal of malicious software. An additional unresolved need is the ability to remotely manage anti-malware software in order to detect and remove such threats without having to be “on-site”. One or more of these, as well as other, unresolved needs are addressed by the present invention.

The following embodiments and aspects thereof are described and illustrated in conjunction with systems, devices, apparatus and methods which are meant to be exemplary and illustrative, not limiting in scope. In various embodiments, one or more of the above-described problems have been reduced or eliminated, while other embodiments are directed to other improvements.

In the following detailed description, reference is made to the accompanying drawings which form a part hereof, and in which is shown by way of illustration certain exemplary embodiments. The leading digit(s) of the reference numbers in the figures usually correlate to the figure number; one notable exception is that identical or similar components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention.

Various terms are used throughout the description and the claims which should have conventional meanings to those with a pertinent understanding of computer programming in general. Other terms will perhaps be more familiar to those more particular conversant in multithreaded programming and a windows operating system (OS). Additionally, various descriptive terms are used in describing the exemplary embodiments in order to facilitate an explanation of them, and to aid one's understanding. However, while the description to follow may entail terminology which is perhaps tailored to certain computing or programming environments or to the various embodiments themselves, the ordinarily skilled artisan will appreciate that such terminology is employed in a descriptive sense and not a limiting sense. Where a confined meaning of a term is intended, it will be explicitly set forth or otherwise apparent from the disclosure.

I. Introduction

A. Exemplary Computing Architectures and Environments

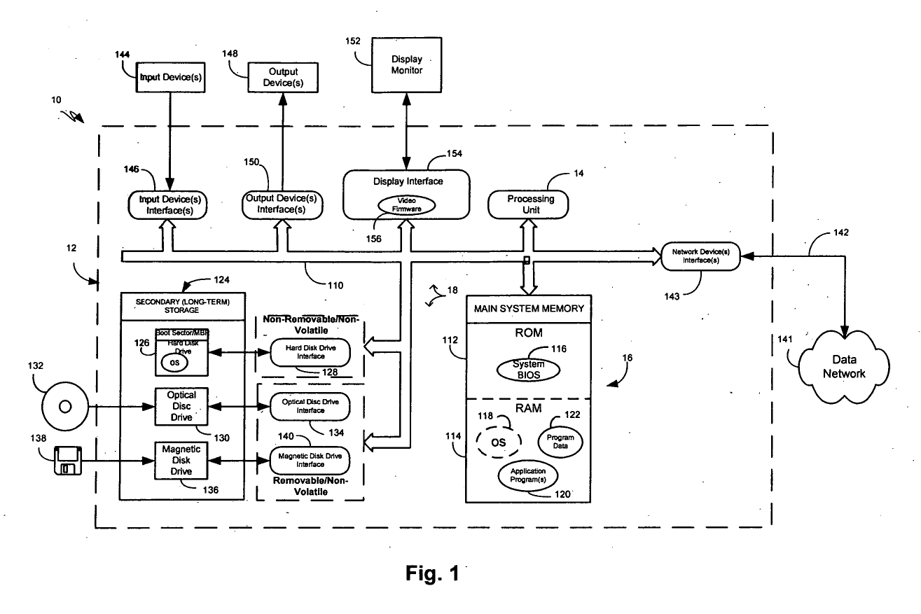

In its various forms, the invention can be implemented within a “standalone” computing architecture, or within a network architecture. The standalone computing architecture allows a user to assess malware threats to an individual computing system, while the network architecture conveniently permits remote management of threats associated with participating client computing systems. Initially, the standalone computing architecture will be described. In either case, however, a representative computing environment for use in implementing aspects of the invention may be appreciate with initial reference to FIG. 1 Representative computing environment 10 may utilize a general purpose computer system 12 for executing applications in accordance with the described teachings. The artisan should appreciate from the description to follow that general purpose computer system 12 may comprise either the “standalone” computing architecture, or one of the client systems in the network architecture.

With this in mind, computer system 12 may be adapted to execute in any of the well-known operating system environments, such as Windows, UNIX, MAC-OS, OS2, PC-DOS, DOS, etc. System 12 includes a processing unit 14 (e.g., a CPU) for executing instructions, a system memory 16 for storing programs and data currently in use by the system, and an input output (I/O) system, generally 18. These various components are interconnected by a system bus 110 which may be any of a variety of bus architectures. System memory 16 may include both non-volatile read only memory (ROM) 112 and volatile memory such as static or dynamic random access memory (RAM) 114. Programmable read only memories (PROMs), erasable programmable read only memories (EPROMs) or electrically erasable programmable read only memories (EEPROMs) may be provided. ROM portion 112 stores a basic input/output system (the system BIOS). RAM portion 114 stores an operating system (OS) 118, one or more application programs 120 (e.g., the CLEANIT application and the security driver described herein), as well as program data 122.

Various types of storage devices can be provided as more permanent data storage areas for the application programs and other data. These can be either read from or written to such as contemplated by secondary (long term) storage 124. Suitable devices may, for example, include a non-removable, non-volatile storage device in the form of a large-capacity hard disk drive 126 which is connected to the system bus 110 by a hard disk drive interface 128 such as ATA (IDE, EIDE), SCSI, FireWire/IEEE 1394, USB, or Fibre Channel. Hard disk drive 126 generally includes at least one bootable disk which stores the OS that is loaded into RAM 114 during a booting sequence, although the OS can alternatively be stored on removable media.

An optical disk drive 130 for use with a removable optical disk 132 such as a CD-ROM, DVD-ROM or other optical media, may also be provided and interfaced to system bus 110 by an associated optical disk drive interface 134. Computer system 12 may also have one or more magnetic disk drives 136 for receiving removable storage, such as a floppy disk or other magnetic media 138, which itself is connected to system bus 110 via magnetic disk drive interface 140. Remote storage over a network is also contemplated.

One or more of the memory or storage regions mentioned above may comprise suitable media for storing programming code, data structures, computer-readable instructions or other data types for the computer system 12. Such information is then utilized by processor 14 so that the computer system 12 can be configured to embody the capabilities described herein.

System 12 may be adapted to communicate with a data distribution network 141 (e.g., LAN, WAN, the Internet, etc.) via communication link(s) 142 so that, for instance, it can communicate with remote servers, clients, etc. Establishing network communications is aided by one or more network device interface(s) 143, such as a network interface card (NIC), a modem or the like suitably connected to the system bus 110. These can serve as a common interface for various other devices within a LAN and/or as an interface to allow networked computers to connect to external networks. System 12 preferably also operates with various input and output devices as part of I/O system 18. For example, user commands or other input data may be provided by any of a variety of known types of input devices 144 (e.g. keyboard, pointing device, game controller, power pad, digital camera, image scanner, modem, network card, touch screen, microphone) having associated input interface(s), generally 146. One or more output devices 148 (e.g. monitor or other suitable display device, printer, fax, recording device, plotter) with associated interfaces, generally 150, may also be provided. For instance, a display monitor 152 may be connected to the system bus 110 by a suitable display adapter 154 (i.e., video card) having associated video firmware 156.

Although certain aspects for a user's computer system may be preferred in the illustrative embodiments, the present invention should not be unduly limited as to the type of computers on which it can be implemented, and it should be readily understood that the present invention indeed contemplates use in conjunction with any appropriate information processing device (IPD) having the capability of being configured in a manner for accommodating the invention. Moreover, it should be recognized that the invention could be adaptable for use on computers other than general purpose computers (e.g. embedded computers), as well as general purpose computers without conventional operating systems.

Collectively, the malware detection and removal capabilities will be described in the context of a software programming architecture. The discussion of this software program, which embodies these capabilities, assumes (but does not require) a Microsoft Windows OS, such as Windows XP. In its preferred implementations the program is actually composed of two separate executable programs. One of these executables, which is referred to throughout this document as “CleanIt”, is initiated by the user and essentially exposes the user interface (UI). The other executable Is a windows driver program, which will be descriptively referred to throughout this document simply “the Driver”, or the “Security Driver”. The lifetime of the security driver is controlled by the CleanIt user space program—that is, CleanIt loads and unloads the Driver from memory as required.

The source code for the software was developed in a hybrid C/C++ syntax on an x86 machine running the Windows XP OS, and using the Microsoft Visual Studio environment as the development tools. The software programming, however, could be readily ported to other versions of the Windows OS, as well as non-Windows platforms such as Linux, Solaris®, BSD and others which are Unix-based. Further, the programming could be developed using several widely available programming languages with the software component(s) coded in a variety of manners, such as through subroutines, sub-systems, or objects depending on one's preferences or the language chosen. In addition, various low-level languages or assembly languages could also be used to provide the syntax for organizing the programming instructions so that they are executable in accordance with the description to follow. Thus, the preferred development tools utilized by the inventor should not be interpreted to limit the environment of the present invention.

Software embodying the present invention may be distributed in known manners, such as on computer-readable medium which contains the executable instructions for performing the methodologies discussed herein. Alternatively, the software may be distributed over an appropriate communications interface so that it can be installed on the user's computer system. Furthermore, alternate embodiments which implement the invention in hardware, firmware or a combination of both hardware and firmware, as well as distributing the modules and/or the data in a different fashion will be apparent to those skilled in the art. It should, thus, be understood that the description to follow is intended to be illustrative and not restrictive, and that many other embodiments will be apparent to those of skill in the art upon reviewing the description.

II. Standalone Implementation

A. General Architecture and Startup

The general architecture of CleanIt is preferably that of a multi-threaded application, though this is not a requirement. As the ordinarily skilled person will appreciate, a “thread” is a series of codes that retrieve processor time independently of the other threads, thus allowing the OS to achieve general overall speed improvement because individual threads can run while other threads are waiting for input. Of course, the artisan will also recognize from the description to follow that the invention need not be implemented as a multi-threaded application since other programming constructs could be employed without departing from the inventive concepts herein.

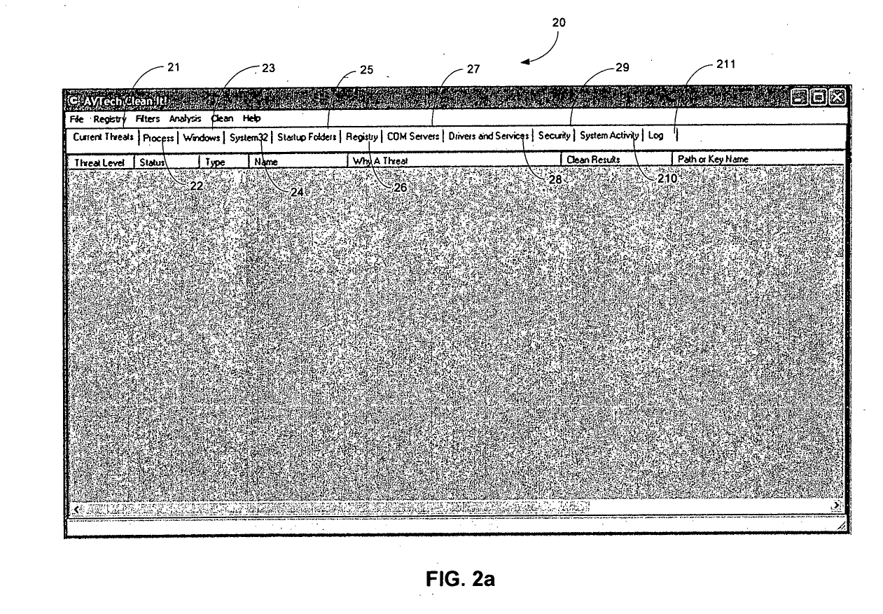

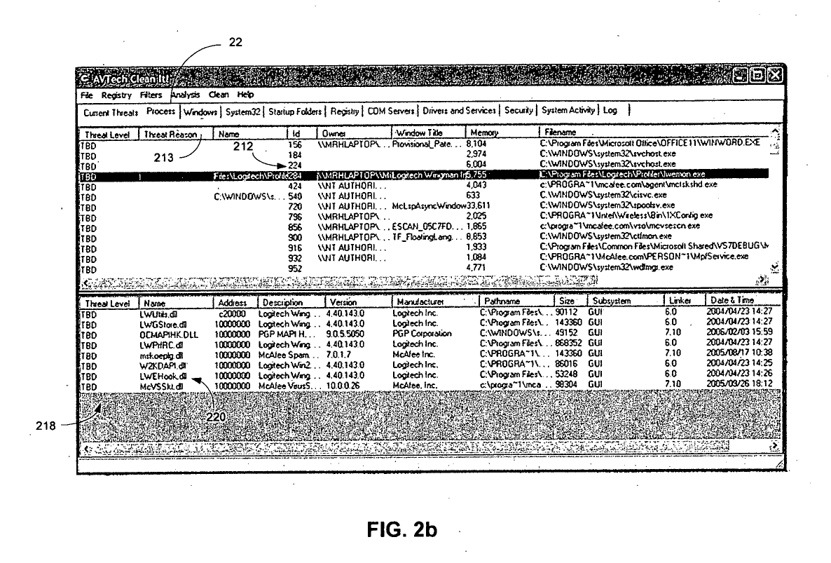

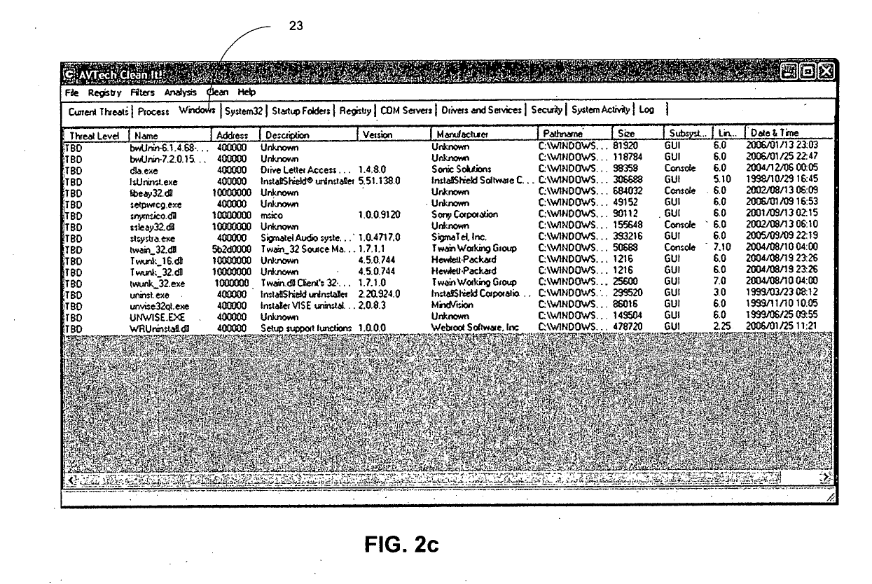

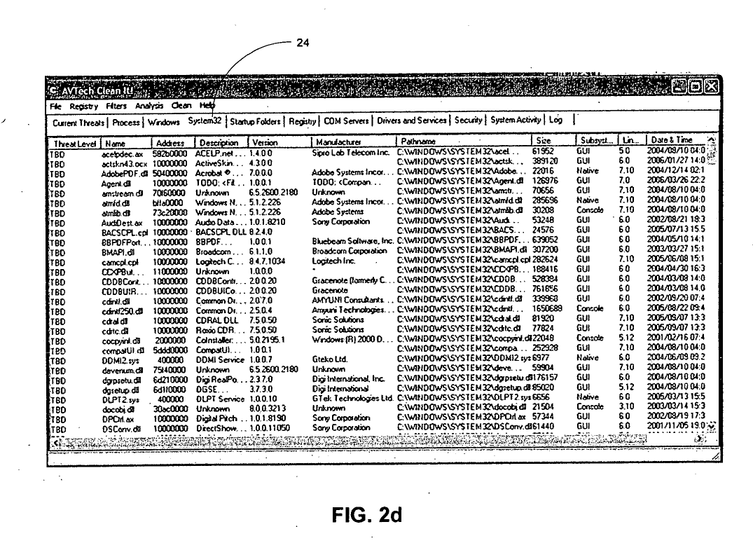

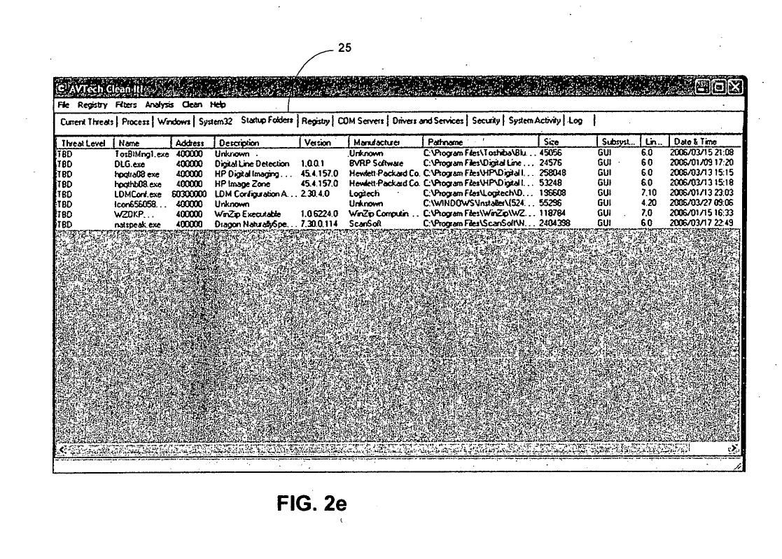

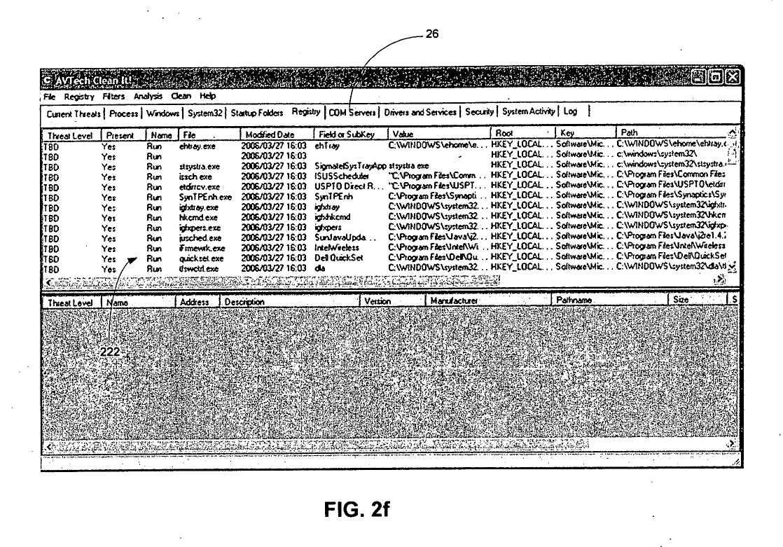

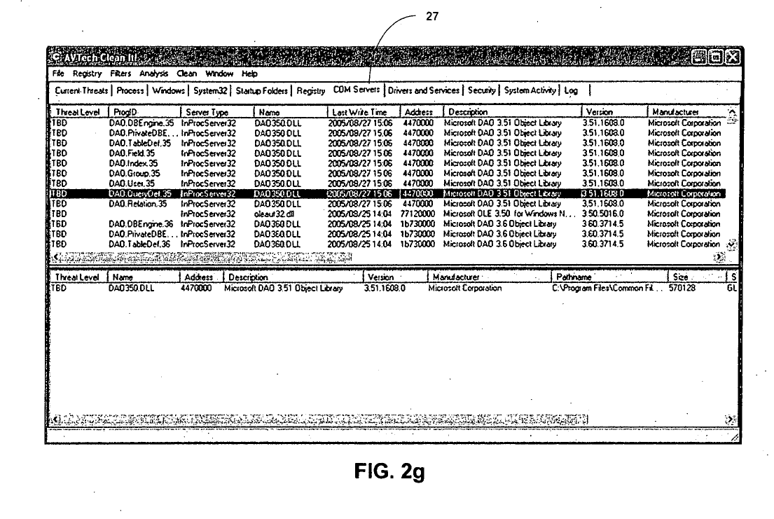

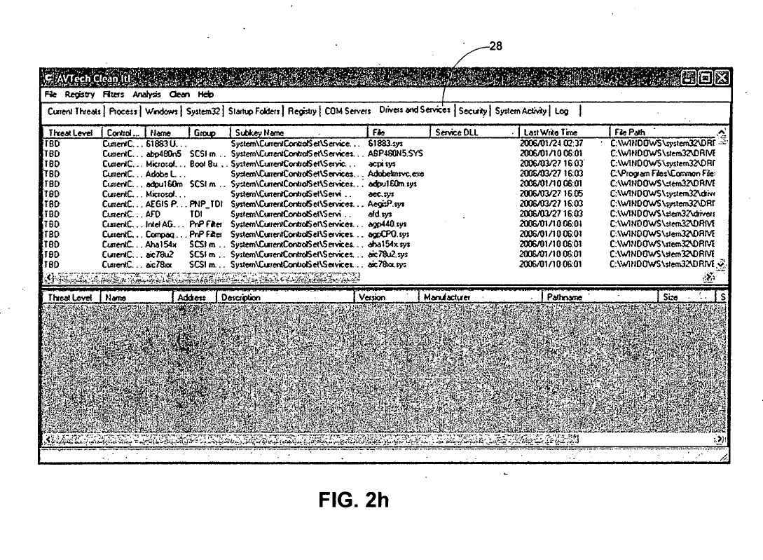

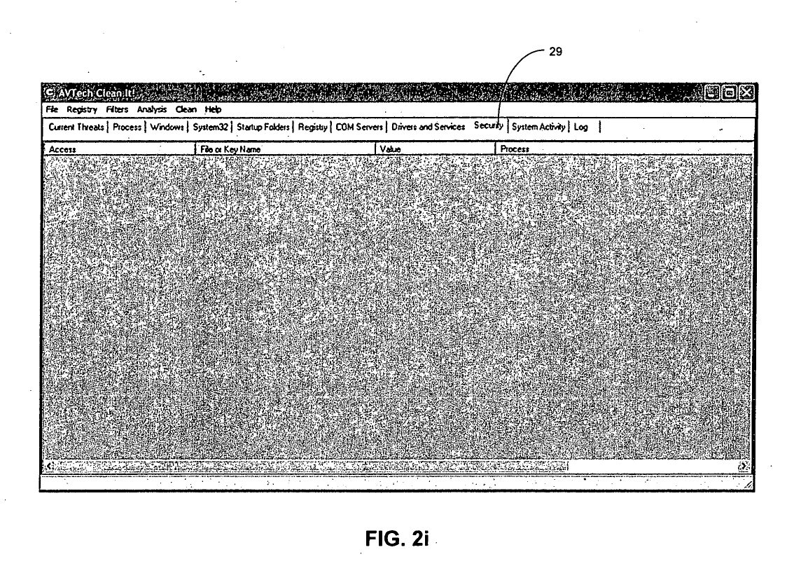

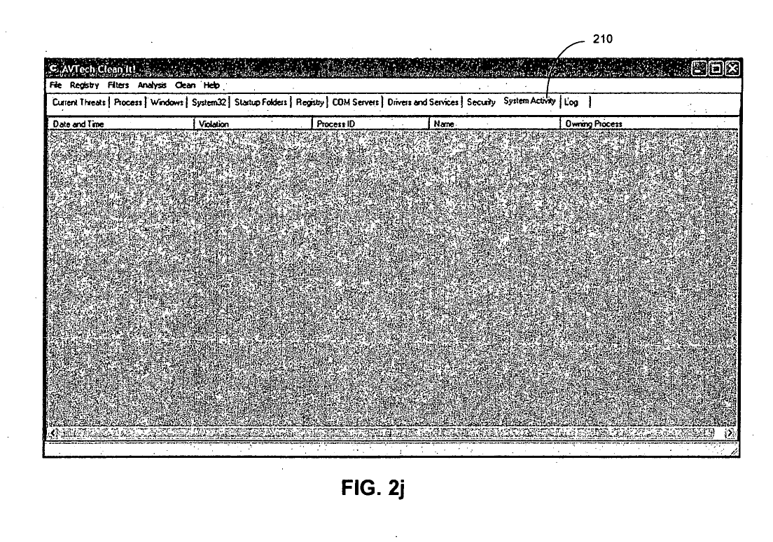

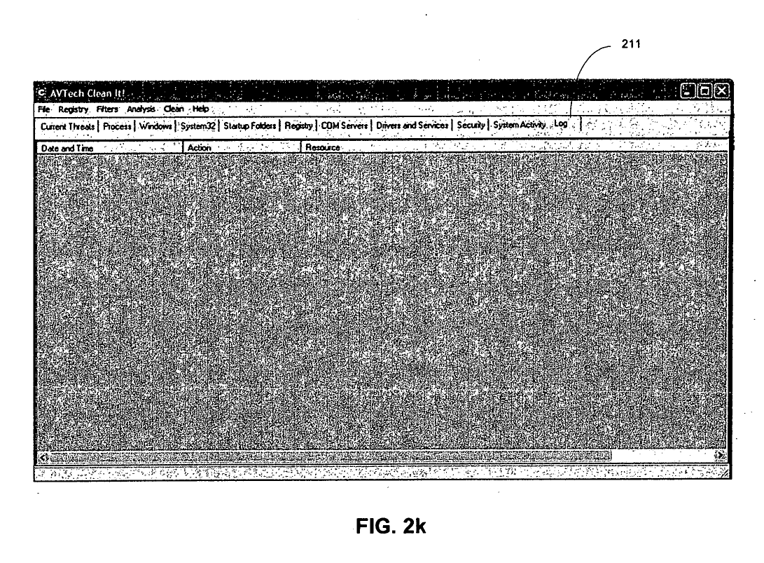

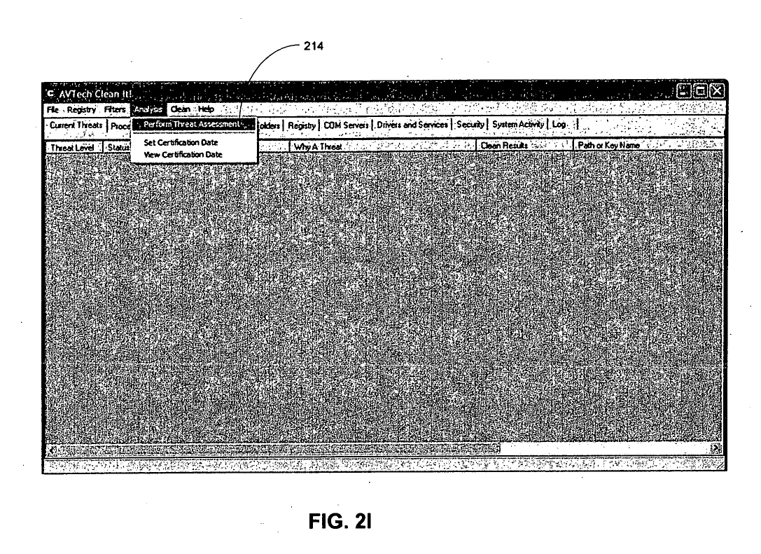

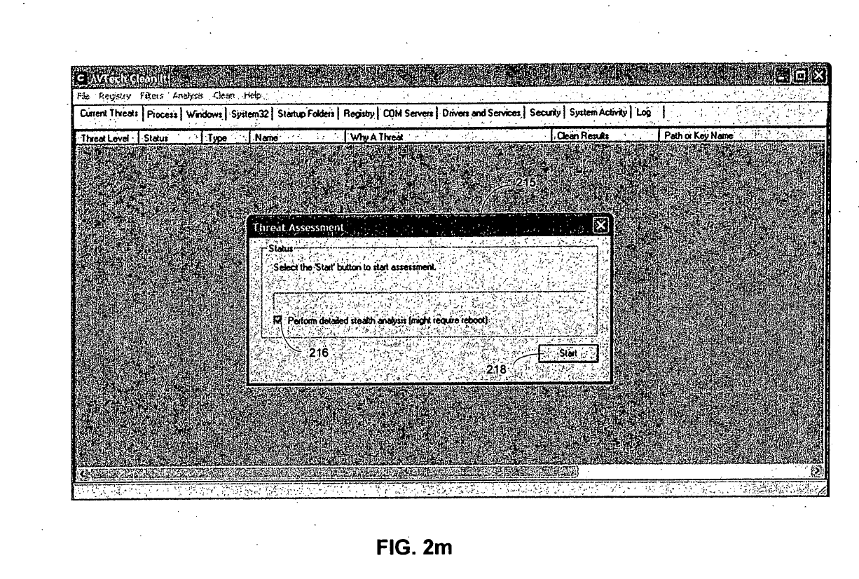

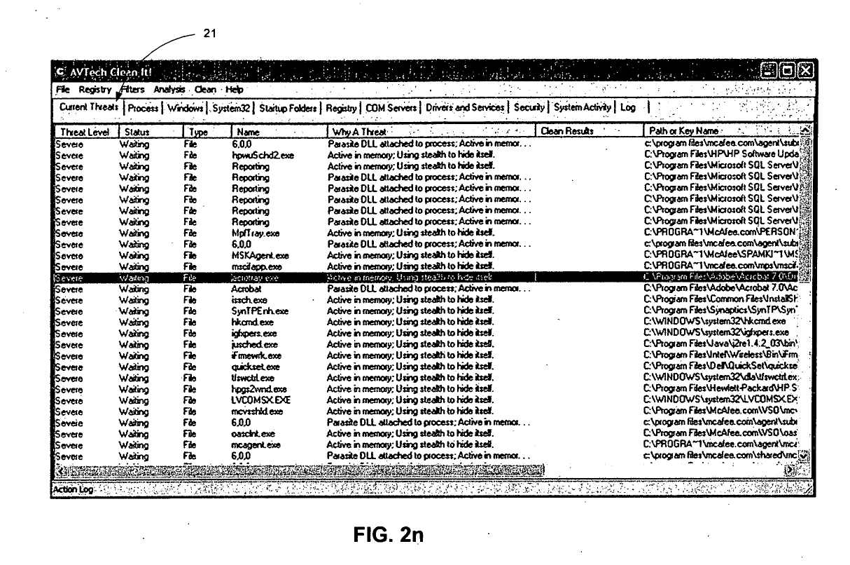

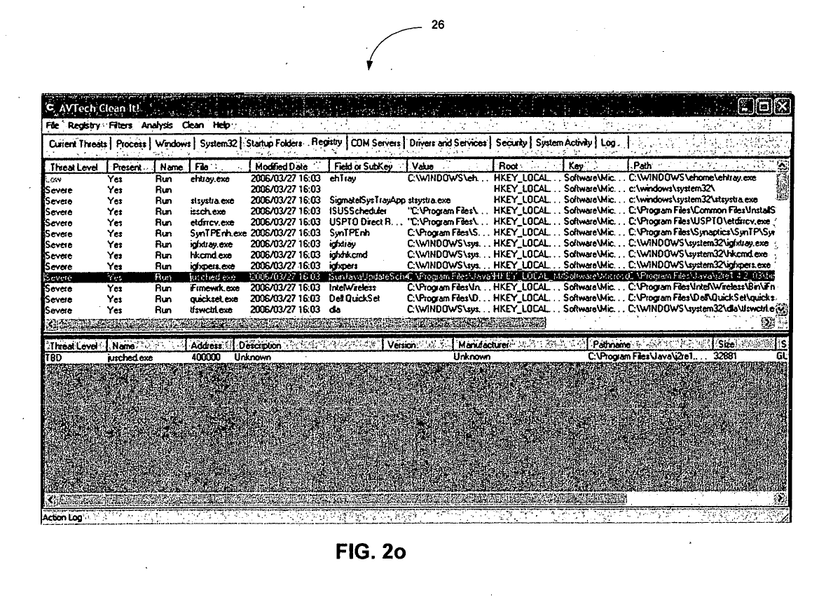

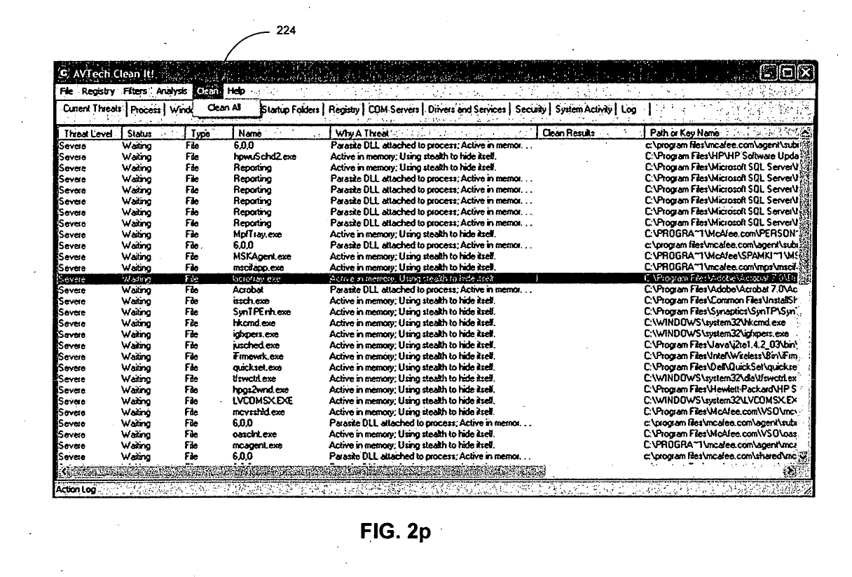

When the application begins the OS starts the main thread, which in turn starts a series of specific threads, such as a GUI thread, a process thread, a database thread, a registry thread, and a driver event thread. All user interaction is embodied within one single thread, namely, the GUI thread. When the GUI thread begins it creates several user Interface (UI) elements which enabled the user to interact with the CleanIt program. Specifically, UI elements known as tabs are created. These tabs provide an easy method for organizing and displaying pertinent information to the user. FIG. 2a shows the UI of the various tabs 21-211 in CleanIt's main application window 20. As will be appreciated, each tab within the program encapsulates a particular area of interest to the user. For example, the process tab 22 lists information related to processes found within the computer's memory. Programmatically, the various tabs 21-211 are preferably implemented as Win32 API windows, such that they have a specific structure, lifetime and information flow as specified by the Windows OS. CleanIt conveniently uses Win32 API windows to provide “canned” utility regarding UI interaction—e.g., mouse, display, etc. Of particular pertinence to the present description, is that Win32 API Windows use a messaging system for transferring information between different program elements. Also useful are the dynamic link libraries (DLLs), list modules, etc., that are included with the Windows OS. Typically, the non-user interface threads (e.g., the database thread, process thread, registry thread, etc.) receive a message from the GUI thread, most likely from its tab window. This causes the thread to perform some processing, whereby it then sends the results back either to the original requestor or to a related destination, all as is known in the art.

When the CleanIt program is initially launched (i.e. prior to threat assessment), a startup message is posted to the GUI thread. Each of the various tab windows is initialized. Each tab presented to the user is supported by a C++ tab window class designed to implement an initialize( ) method for allowing all tab windows to respond to the start event. Certain ones of the tab windows are initially populated based on current system settings. These include the Process tab window (FIG. 2b), the Windows tab window (FIG. 2c), the System32 tab window (FIG. 2d), the Startup Folders tab window (FIG. 2e), the Registry tab window (FIG. 2f) and the Drivers and Services tab window (FIG. 2h). Some or more of the remain tab windows, namely, Current Threats tab window (FIG. 2a), the COM Servers tab window (FIG. 2g), the Security tab window (FIG. 2i), the System Activity tab window (FIG. 2j) and the Log tab Window (FIG. 2k) may be initially unpopulated (as shown) based on the then current system settings.

For purposes of illustration, FIG. 2b shows the process tab 22 selected whereupon it displays to the user relevant information pertaining to running processes in memory. Within the process tab are several columns, generally 212, notably the column labeled “ID”. This displays a number which is uniquely assigned to each process by the OS. Under a 32-bit Microsoft OS, the unique identifier (ID) can be any number from 0 to 2³². Most operating systems have methods which allow programs to retrieve a set of current process IDs. The method can either be a single function returning a table or a set of one or more enumeration functions which are repeatedly called, each time returning a process ID.

1. Detecting Hidden Processes in Computer Memory

While populating the process tab 22 during initialization, the CleanIt application not only reveals to the user those processes which are visible from user space, but also processes which are trying to hide themselves from visibility. A hidden process can be considered as a computer program which uses certain techniques to modify the computer memory and/or disk storage devices in order to avoid detection. Fundamental to this process management is the concept of the process ID. The process identifier is typically a seemingly random number that only has meaning to the OS. Most conventional operating systems also have a set of methods to retrieve information about a particular process ID. For example, an OS might have a function that returns the filename associated with a particular process ID. Finally, most conventional operating systems have a method which allow process to “kill” another process in order to remove it from memory. Thus, given the process identifier the OS can perform many tests such as querying its status, suspending its status or removing it from memory. Computer operating systems typically use numbers for process identifiers because they're easy to create, store and manage. For purposes of the teachings herein, however, a process identifier can be any suitable string which the OS uses to identify a given process. As such, a process ID can be numeric, alphabetic, alphanumeric, or any other string. Also for purposes of the description, the term “current process identifier” or “current ProcID” refers to a program identifier that is actually in memory, versus one which was in memory at some point in time but no longer is.

The actual method to obtain the current ProcIDs in memory varies from OS to OS, and can be either a single function call or a series of function calls. For illustrative purposes, the following discussion will refer to a single Windows OS function which, when invoked, returns the set of current ProcIDs. Knowing the set of current ProcIDs is important because there is a new class of computer viruses which manipulate the set by removing their identifier from the list, effectively becoming “invisible” to other processes within the computer.

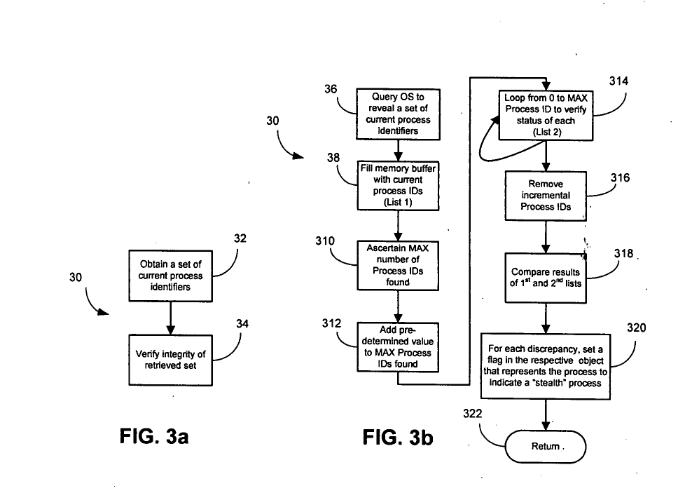

The CleanIt application preferably detects hidden processes on start-up so that, when the process window is initially populated, all processes in memory (visible and invisible) are listed. Initial reference is made to method 30 in FIG. 3a. A set corresponding current ProcIDs is generated at 32 and the integrity of this set is then verified 34. More specifically, the first set is created by querying the OS to return a set of current ProcIDs, while the second set is created by querying the OS for the status of “made up” ProcIDs. In generating the second set, the OS returns a “0” if the made up ProcID is valid (i.e. identifies to a current ProcID in memory), or some other number if it is invalid (i.e. does not identify a current ProcID in memory). Any discrepancies between the two sets is indicative of malware.

This can be illustrated to the use of a simple example in which the first set is referred to as set “A” and the second set is referred to as set “B”. Further, assume set A has 5 elements—each element representing a ProcID in memory. In set notation, and with random process IDs, assume set A is as follows:

A={5, 39, 55, 87, 109}

After retrieving set A, set B is created. However, the construction of set B is different from that of set A. Set B is created by a loop that queries the status of a “made up” ProcIDs ranging from the lowest (zero) to a user-defined value, such as some value higher than the maximum ProcID number in set A. Continuing with the example, assume the OS returns an error code indicating the “made up” ProcID 0 is invalid. In this case, it is NOT placed into set B and the loop continues with the next process ID, 1. The same OS call is issued to retrieve the status of ProcID 1, which for purposes of the example is also deemed invalid. The procedure would continue to sequentially loop through the range of made up ProcIDs. Jumping ahead to made up ProcID 5, it can be appreciated that it is in set A. In this case, the call to the OS requesting the status of ProcID 5 returns a 0, indicating that it is valid. As a result, ProcID 5 is placed into the set B. At this time, sets A and B look like this:

A={5, 39, 55, 87, 109}

B={5}

For sake of illustration, assume ProcID 10 has been assigned by the OS to a virus process. Jumping ahead in the loop, when a call to the OS is made requesting the status of ProcID 10, a 0 is returned. In this case, 10 is placed into set B, which will then looks as follows:

B={5, 10}

The process is repeated until all possible “made up” process IDs are assessed, at which time sets A and B look like this:

A={5, 39, 55, 87, 109}

B={5, 10, 39, 55, 87, 109}

As can be seen, sets A and B are not identical. Set B has one additional element—ProcID 10. Any element that is in set B but not in set A can be considered a “hidden” process and, thus, potentially malware.

A more detailed version of method 30 for detecting hidden processes in computer memory may, thus, be appreciated with reference to FIG. 3b. At 36 the OS is queried to reveal a set of current ProcIDs. In Windows, this can be accomplished using the function PSAPIDLL.EnumProcesses( ). Because the Windows OS does not have a function that returns the number of processes in memory, this loop ensures that all current ProcIDs are gathered. The results of the loop are placed in a PROCESS_LIST object. At 38 a memory buffer is filled with the set (List 1) that is returned. List 1 is then scanned 310 to ascertain the highest ProcID (MAX) returned by the OS. A predetermined value is then added to this at 312. Again, this predetermined value can be based on one's particular preferences but it is chosen in an effort to ensure that all “hidden” processes are detected. Thus, most conservatively, for a 32-bit architecture 232 IDs could be checked.

Method 30 then begins a loop in order to verify the integrity of List 1. More particularly, each ProcID from 0 to the adjusted Max which the OS indicates is valid is placed in a second set (List 2) at 314, which is also an object PROCESS_LIST. Preferably, information about the subject process is also obtained at this time. Step 314 can also produce “incremental” process identifiers, to the extent that they exist. That is, lets say we try process identifier 1024 and that its status is good. Under a Windows OS, additional incremental ProcIDs, such as 1025, 1026 and 1027 might also be good—in that they refer to the same process as ProcID 1024. Depending on OS, the incremental ProcIDs could be a contiguous or not contiguous sequence of a selected number of other ProcIDs which refer to the same process. Therefore, if needed, then, these incremental ProcIDs are removed from List 2 at 316. The results of the first and second lists are compared 318 so that, for each discrepancy, a flag can be set 320 within the respective data object that represents the process to indicate a “stealth” process. Method 30 then returns at 322. As such, when the contents of the data object are displayed on the screen, such a process can be characterized by the term “Stealth” under in the “Threat Reason” column 213 in FIG. 2b. Also, when the contents of the PROCESS_DATA object are displayed on screen, should the flag “is this a stealth virus” be set, then the string “Stealth Virus” is displayed.

B. Threat Assessment

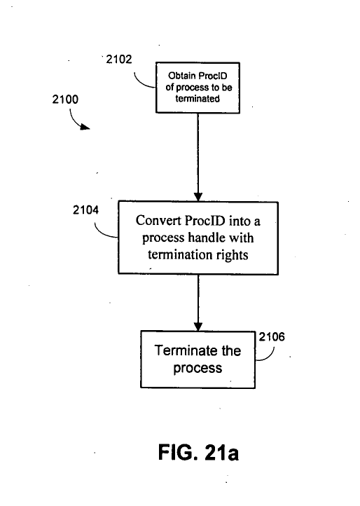

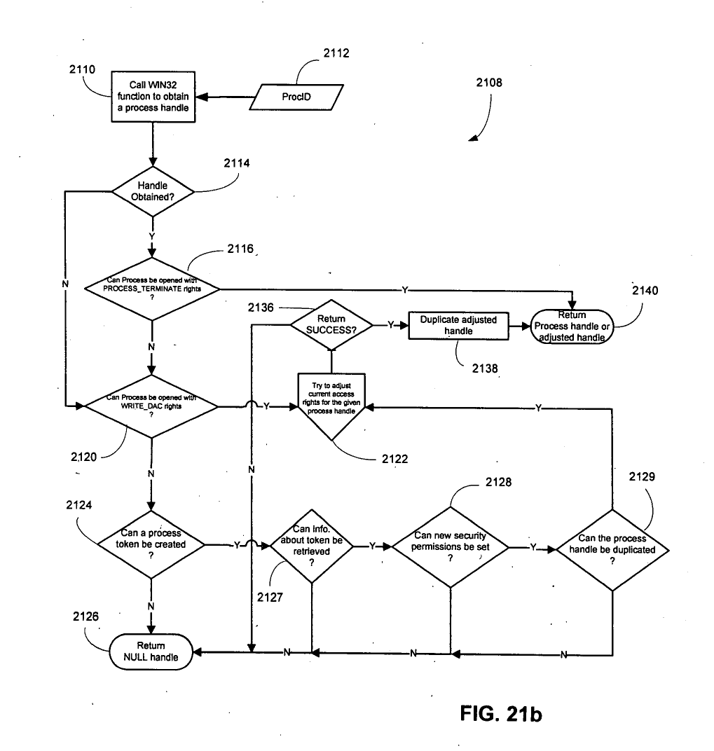

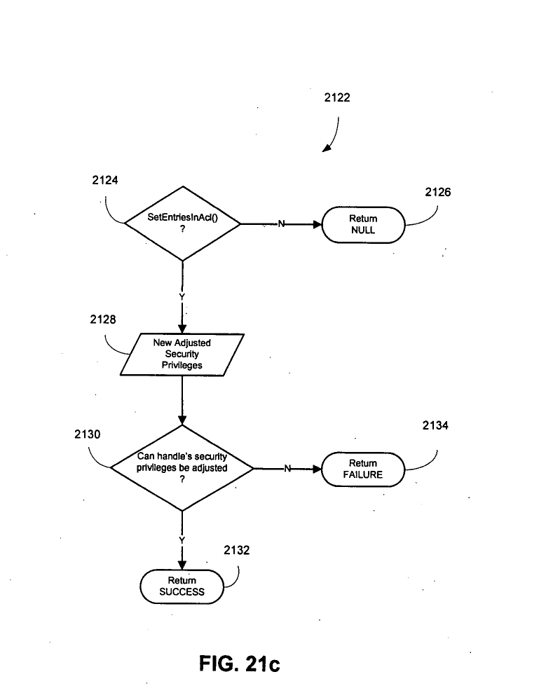

To begin a threat assessment, a user selects the “Perform Threat Assessment” option from the “Analysis” drop down menu 214 (FIG. 21). A certification date for the assessment can also be set, as shown. At this point the user has the option of performing a detailed threat assessment (discussed below) by selecting the check box option 216 in dialog box 215 which appears (FIG. 2m). Once the “Start” button 218 is activated, an appropriate message is posted to the GUI thread window, and an assessment count is set to zero for tracking purposes. When the assessment is complete each tab window will place it's associated threat ASSESSMENT object(s) within the “Current Threats” tab window 21 (see FIG. 2n). From here, the user can then select The “Clean” option from the available drop down menu 220. This causes all assessment objects (i.e. those that hold the results of the various threat assessment tests) into a single list object, referred to herein as ASSESSMENT_LIST. A suitable message is then posted to the GUI thread so that the previously detected threats can be addressed.

The assessment process takes file, process or registry information and compares the information to a set of criteria. If the item is considered a threat, it is given a threat level. The threat level allows the user to gauge a response to the threat. It is important to note that a threat level does not guarantee a file, process or registry is an actual virus. For example, some applications will mimic malware behavior by hiding their filenames from directory searches in an effort to reduce inadvertent system changes made by novice users. The threat level gives the experienced computer technician important information by which they can make the final threat assessment.

The table below describes the various preferred threat levels.

| Threat | Meaning |
|---|---|
| SEVERE | Detected a threat that is in memory and active. |
| HIGH | Detected a threat that is on disk, but not in memory. |
| ELEVATED | Detected a file or registry key that was installed into the |
| | computer after the last certification date and is in memory |
| GUARDED | Detected a file or registry key that was installed into the |
| | computer after the last certification date and is |
| | not in memory. |
| LOW | Not a threat. |

The criteria used to assess the threat level of a file or a registry key is as follows:

| Threat | Level | Description |
|---|---|---|
| One of the CleanIT files | Low | The file is part of the invention distribution set. |
| Known File Threat | In memory: SEVERE | The file name is in the database of known file threats. |
| | On disk: HIGH | |
| Is A Trusted Manufacture | Low | The file is from a known manufacturer. |
| Known CLSID Threat | In Memory: SEVERE | The CLSID is in the database of known CLSID threats. |
| | In Registry: HIGH | |
| Known PROGID Threat | In Memory: SEVERE | The PROGID is in the database of known CLSID threats. |
| A Stealth Processes | SEVERE | The process is a stealth process - i.e., the process has taken |
| | | steps to hide itself from the process list. |
| A Protector | SEVERE | The process keeps rewriting registry startup keys to ensure |
| | | data contained within the keys are not deleted. |
| A Changed Key | In Memory: SEVERE | The file associated with a changed key determined by reboot |
| | On Disk: HIGH | analysis. |
| Hidden File | In Memory: SEVERE | The file in memory is hidden on disk. |
| | On Disk: HIGH | |
| Hides from Directory | In Memory: SEVERE | A file that is restricted from a directory search. |
| Search | On Disk: HIGH | |
| | In Registry: HIGH | |
| Prevents Unload | SEVERE | A process that prevents itself or other modules from being |
| | | unloaded from memory. |
| Bad Extension | In Memory: SEVERE | A process with a bad extension. The extension implies a |
| | On Disk: HIGH | different type of file - e.g., a picture file - but is really a |
| | In Registry: HIGH | process file. |
| After Certification Date | In Memory: | A file or registry key has been installed after the certification |
| | ELEVATED | date. |
| | On Disk: GUARDED | |
| User defined virus | In Memory: SEVERE | A user defined threat. |
| | On Disk: HIGH | |

1. Initialization and Reboot Analysis

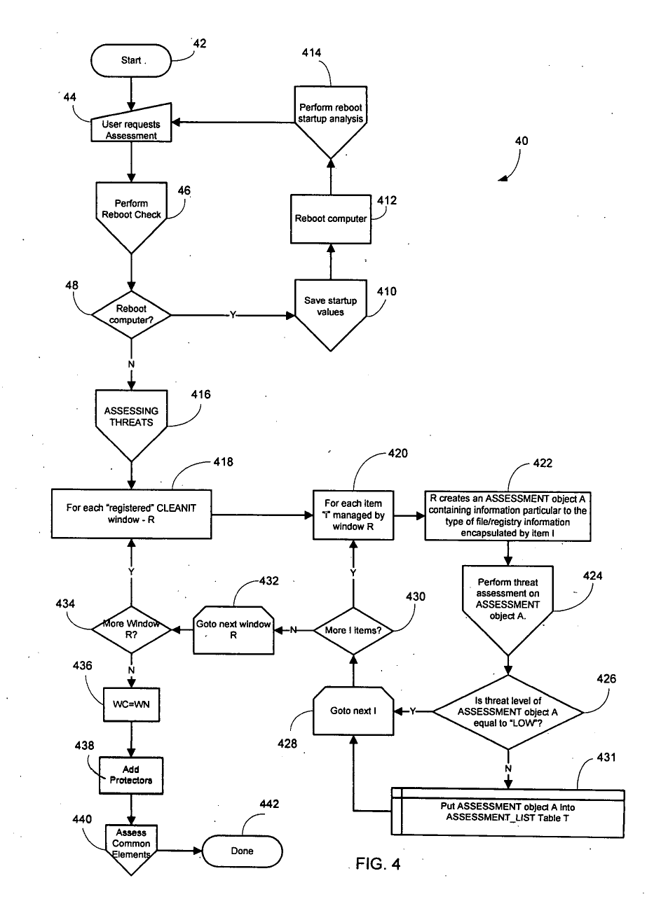

Initial reference is made to FIG. 4 which shows a high-level flow diagram for assessing threats within a computer system. Following start 42, a user may request an assessment at 44. An inspection is made of the check box 216 “perform reboot analysis” discussed above. If this box is checked then a determination is made at 48 if it is necessary to reboot the computer. If so, then an appropriate message is posted to the registry thread, startup values are saved at 410 and the computer is thereafter rebooted at 412, after which a reboot startup analysis is performed 414.

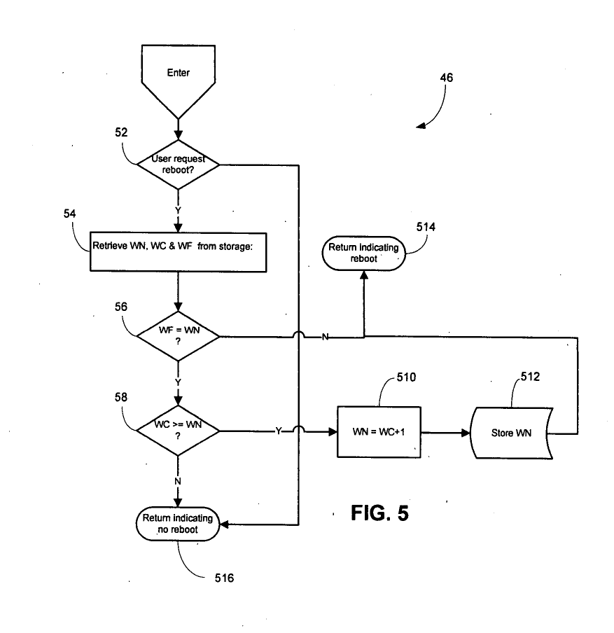

The routine 46 for performing the reboot check is shown in FIG. 5. In essence, the testing in routine 46 is required to determine if the CleanIt application needs to reboot the computer in order to perform a reboot analysis, whether it is in the “middle” of a reboot analysis (WF=WN and WC!=WF), or whether the reboot analysis is complete (WF=WN=WC). The reboot check is required to look for registry keys that are modified during the computer shutdown process. Some threats will rename registry keys and/or files during the computer shutdown process to avoid detection. To identify these threats, it is preferred to generate two lists—the first list is generated prior to reboot and the second list is generated upon startup. The two lists are then compared and any anomaly is considered a threat.

With reference to FIG. 5, presuming the user has requested a reboot analysis at 52, the following values are retrieved from the registry:

WC=a number indicating the “working set complete”,

WN=a number indicating the “current working set”; and

WF=a number indicating the “current working file”

If the computer is in the “middle” of a reboot analysis then WF=WN and WC!=WF; if the reboot analysis is complete then WF=WN=WC.

If at 56 WF=WN and WC>=WN at 58, then WN=WC+1 at 510. The revised WN is stored in memory at 512 and routine 46 returns at 514 indicating a reboot is necessary. This is also indicated if WF is not equal to WN in response to inquiry 56. Furthermore, as may be appreciated from routine 46, no reboot is performed unless requested by the user, such that a no reboot indicator is returned at 516. Moreover, no reboot is performed if WC<WN.

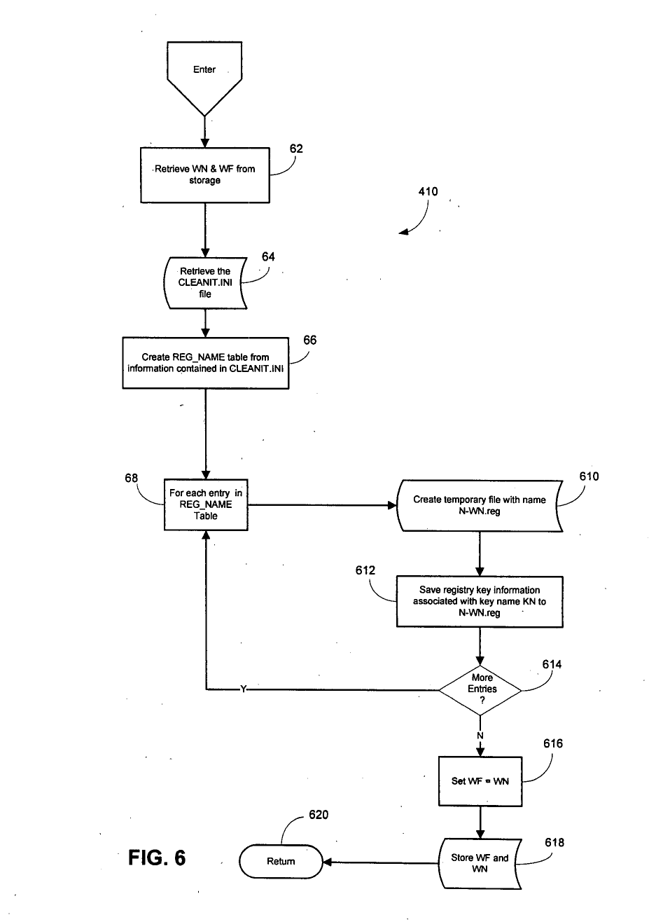

Returning briefly to FIG. 4, it is recalled that startup values are saved at 410 if the computer is rebooted. Routine 410 is shown in FIG. 6, during which WN and WF are again retrieved from storage (i.e. the registry). At 64 the CleanIt initialization (CleanIt.INI) file is retrieved, and a registry name (REG_NAME) table is created at 66 from information contained within this file. The CLEANIT.INI file contains initialization information. For example, it contains the list of registry keys that are retrieved and used to populate the registry tab. It also contains additional directory tabs that should be created on startup (the default directory tabs are hard coded as the directory name is actually derived from ENVIRONMENT variables) Each entry within the REG_NAME table contains the following information: (1) a name “N”; and a key name “KN”. For each item within the table 68 a temporary file name is created at 610 having the format “N-WN.reg”, and registry key information associated with the key name is saved to the file at 612. This is repeated until there are no more items in the registry name table 614, after which WF is set to equal WN at 616. These variables are then stored at 618 and routine 410 returns at 620. In essence the above routine for saving startup values is performed because malware may rewrite these values during the reboot process. In fact, they are actually rewritten before the computer shuts down. So, the values are saved before the malware can modify them. The computer is then rebooted, allowing the malware to rewrite the values—such that a comparison can be made of the “current” (after boot) values with the list created before reboot. If the two lists are different, a malware program has modified a startup value.

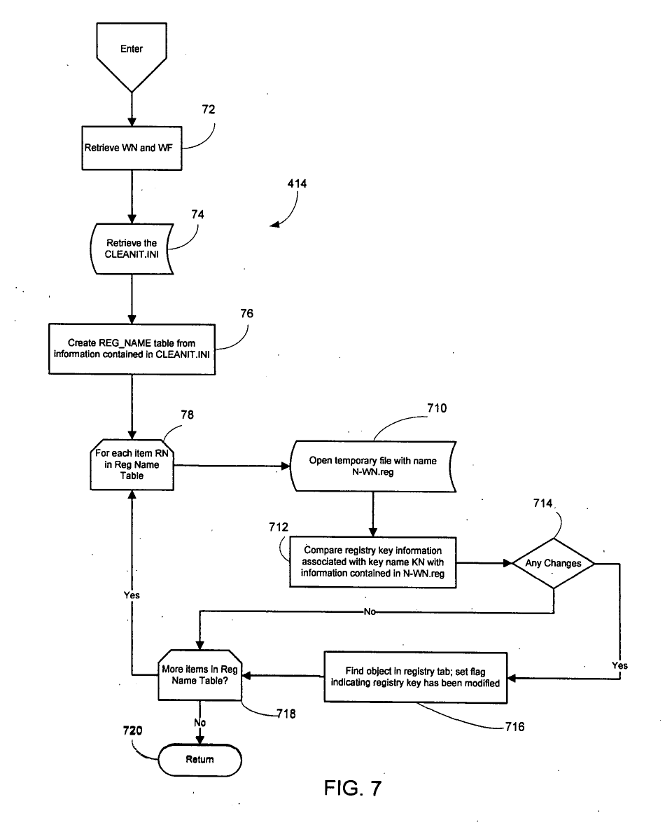

As shown in FIG. 7, reboot analysis 414 entails retrieving WN and WF at 72 and the CleanIT.INI file at 74. A registry name table (REG_NAME) is created at 76 from information contained within the CleanIt initialization file, as above. Each entry (RN) within the table contains the following: (1) a name “N”; and (2) a Key Name “KN”. For each entry in the table at 78 a temporary file is opened at 710 with a name having the format N-WN.reg.

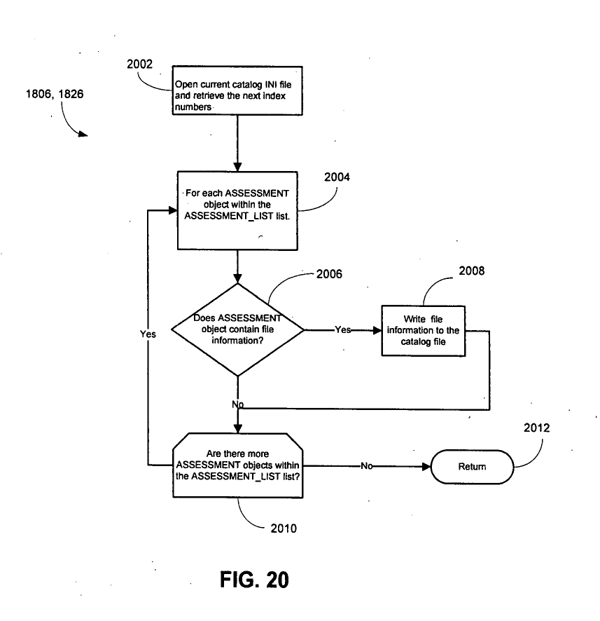

Registry key information for each key name (KN) is compared at 712 with information contained within N-WN.reg. If there are any changes at 714 a flag is set at 716 for the associated object in the registry tab 26 window (FIG. 20) to indicate that the registry key has been modified. The above is repeated until there are no more items within the registry name table at 718, at which point flow returns 720.

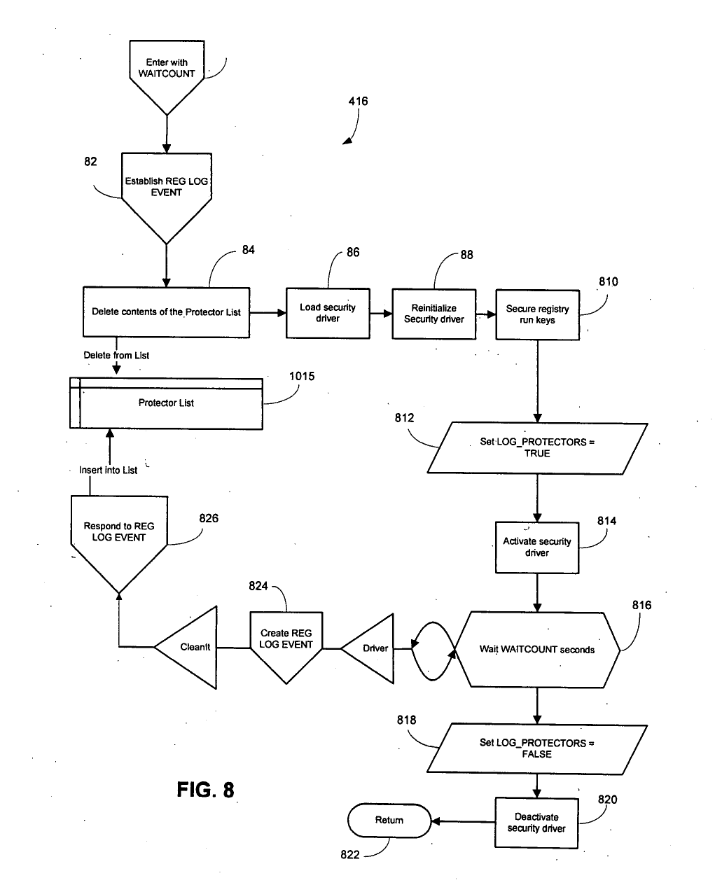

Following reboot (if necessary) flow 40 proceeds at 416 in FIG. 4 to identify startup key protectors, which includes startup keys and any other keys responsible for starting up processes (FIG. 4). Step 416 in FIG. 4 actually happens when both the security driver and CleanIt program start. The invention contemplates that a user, at his/her discretion, can determine the amount of time the system looks for startup key protectors. This referred at the WAITCOUNT 81 in FIG. 8. Identification of the startup keys is introduced in FIG. 8 wherein a registry log event is established at 82 for the driver so it can signal the CLEANIT program. The contents of any previously populated registry protector list are deleted at 84. The security driver is loaded at 86 and reinitialized at 88, after which the registry's startup keys are secured 810.

In reinitializing the security driver at 88, the operating system function DeviceIOControl( ) is called with the driver command IOCTL_PROAV_CLEAR_LISTS. When the security driver receives this command, it clears the following tables in memory:

1) Volume, Directory and File (VDF)

2) Log

3) Registry

4) Registry Log

5) DOS Filename

6) Extension

These tables are initially created during driver initialization. The step of securing the registry startup keys at 810 preferably adds eight (8) registry key access to a registry key lookup table in the security driver (referred to as “RT_REG_TABLE”). The added registry keys, each referred to as a “RT_REG_KEY”, within the RT_REG_TABLE are the startup keys used to start an application during boot-up. More particularly, the following registry access records (particular to a Windows OS environment) are added to the driver:

1) root key=HKEY_LOCAL_MACHINE

key name=Software\Microsoft\Windows\CurrentVersion\Run

value name=ANY (e.g., all value names match)

permissions=NONE

processes=ALL

2) root key=HKEY_LOCAL_MACHINE

key name=Software\Microsoft\Windows\CurrentVersion\RunOnce

value name=ANY (e.g., all value names match)

permissions=NONE

processes=ALL

3) root key=HKEY_LOCAL_MACHINE

key name=Software\Microsoft\Windows\CurrentVersion\RunOnceEx

value name=ANY (e.g., all value names match)

permissions=NONE

processes=ALL

4) root key=HKEY_LOCAL_MACHINE

key name=Software\Microsoft\Windows\CurrentVersion\RunServices

value name=ANY (e.g., all value names match)

permissions=NONE

processes=ALL

5) root key=HKEY_CURRENT_USER

key name=Software\Microsoft\Windows\CurrentVersion\Run

value name=ANY (e.g., all value names match)

permissions=NONE

processes=ALL

6) root key=HKEY_CURRENT_USER

key name=Software\Microsoft\Windows\CurrentVersion\RunOnce

value name=ANY (e.g., all value names match)

permissions=NONE

processes=ALL

7) root key=HKEY_CURRENT_USER

key name=Software\Microsoft\Windows\CurrentVersion\RunOnceEx

value name=ANY (e.g., all value names match)

permissions=NONE

processes=ALL

8) root key=HKEY_CURRENT_USER

key name=Software\Microsoft\Windows\CurrentVersion\RunServices

value name=ANY (e.g., all value names match)

permissions=NONE

processes=ALL

9) All keys under the branch HKEY_LOCAL_MACHINE\system which refer to the operating systems control set (e.g., CurrentControlSet, ControlSet001, etc)

10) Any other keys related to program startup.

As can be appreciated from the above, the driver's access records grant no rights to any of the above keys under any circumstances.

Once the system's startup registry keys are secured, a log protectors flag is set to “true” at 812. Thereafter, the security driver is activated 814 and the system waits a predetermined amount of time 816 which can be determined by the user based on inspection. During this wait time, the driver will detect any startup key protectors. A “startup key protector” is a term used to describe a threat which attempts to modify one or more of the protected registry keys during the waiting interval. The database thread will receive notifications from the security driver if a new record (i.e. a startup key protector) is available. After this waiting interval, if no modification or attempts are made to the protected registry keys, then the log protectors flag is set to “false” at 818, after which the driver is deactivated 820, and flow returns 822.

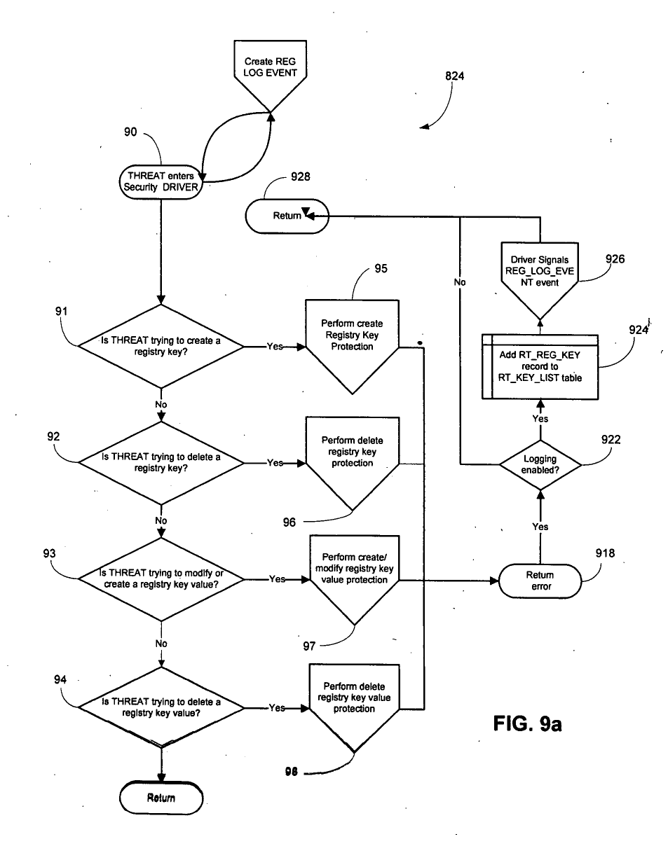

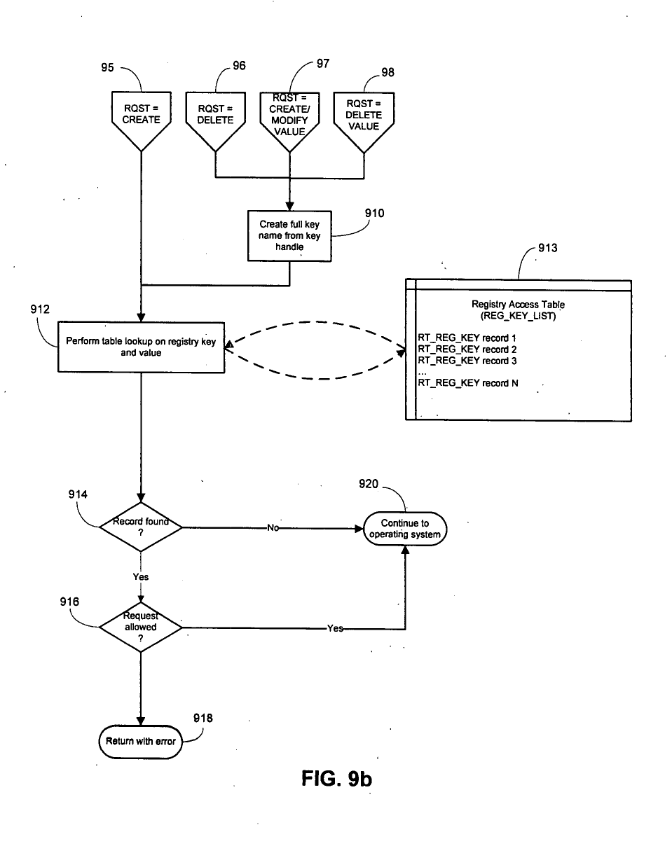

If a threat attempts to modify one or more of the protected registry keys during the waiting interval 816, this is detected by the driver which traps the modification attempt and creates a registry log event 824, as shown in FIG. 9a.

As most operating systems have a centralized point of entry for providing services, protecting a resource entails modification of the point of entry so that future requests to the OS enter a “function stub” prior to continuing on to their original destination. An entry point is essentially a pointer that redirects the calling process to the appropriate service (e.g., opening a file, closing a file, creating a file). The approach can be summarized as (1) locating the point of entry within the OS that provides a service or function; (2) modifying the entry point of entry so that a calling processing does not go to the OS, but is instead diverted to a “trap” function; and (3) controlling processing via the trap function.

Since the trap is in control, it can modify the request, allow the request to go to the OS in its original form or simply return to the caller without allowing the request to proceed. Implementing the above can be involved because OS vendors typically do not document how to modify an entry point, and because the trap function should be transparent to both the OS and the calling process. That is, the trap function is ideally designed with the same timing, environment and memory constraints as the original OS code. Further compounding the complexity is how a trap is actually coded because, in extreme cases, the computer code desiring a trap must actually modify computer instructions and/or memory in order to effect the trap.

As known, the kernel is the area within the Window OS which hosts low-level programs such as drivers, network connections, disk drives, input devices, etc. Programs running within the kernel are called device drivers or services, which are themselves commonly referred to as kernel-mode programs. Operating systems divide memory space into kernel and user space. Programs running within the kernel space have greater privileges and responsibilities as they can basically do anything they want to the memory space. Programs running within user space are limited as to their privileges and responsibilities. They are not allowed to modify program memory nor make direct modifications to the operating system.

In a Windows OS environment, a device driver or service running in kernel mode has access to a table called the KeServiceDescriptorTable. This table consists of entry points for various services exposed by the operating system. More particularly, the KeServiceDescriptorTable contains N numeric pointers. Each pointer consists of an address (a number) of a particular service. Using simple made-up values, this can be represented as: KeServiceDescriptorTable={0x100, 0x295, 0x333, 0x9988, . . . }

Therefore, in this example, KeServiceDescriptorTable element 0 has the value 0x100, which is the address of the 1^{st} service function found in the KeServiceDescriptorTable table. Thus, if one were to dump the bytes starting at address 0x100, one could see the actual code that implements the 1^{st} service function, and so on.

In terms of trapping a function, assume a the 2^{nd} function in the table is referred to as SERVICE B, and that a new service function is needed to augment the services found in SERVICE B. Assume also that the address of this new function, which can be referred to as SERVICE BB, is 0x8877. If one were to remove the 2^{nd} element within the KeServiceDescriptorTable table, i.e., the value 0x295, and replace it with the value 0x8877, we would have:

KeServiceDescriptorTable={0x100, 0x8877, 0x333, 0x9988}

The KeServiceDescriptorTable table has been essentially modified to “trap” the service call for function SERVICE B. As such, whenever a program calls through the KeServiceDescriptorTable table to enter function SERVICE B, it actually enters the trap function, SERVICE BB.

With the foregoing in mind the security driver discussed above preferably includes an associated replacement “trap” service function for each service function within the KeServiceDescriptorTable. More particularly, the address for each following entries within the KeServiceDescriptorTable is replaced with an associated trap function: ZwCreateFile, ZwOpenFile, ZwDeleteFile, ZwSetInformationFile, ZwCreateSection, ZwCreateKey, ZwSetValueKey, ZwDeleteValueKey, ZwDeleteKey. These functions are loaded when the security driver is initialized (86 in FIG. 8). Each such new function within the security driver performs the same higher level logic, namely, it inspects the calling function's parameter(s), makes a decision based on parameters as to whether the calling function may proceed, and either allows the calling function to proceed to operating system or return to caller.

The purpose of trapping functions found in the KeServiceDescriptorTable table is to be able to provide protection on either a file or registry key. Central to file and registry protection are two in memory lookup tables—rtVDFList and rtKeyList. Both lists are “double linked” lists. The security driver uses double linked lists so that elements can be deleted after the list has been initially created. The rtVDFList contains N number of RT_VDF_DATA record objects, each of which contains the following information:

Pointers to any previous or next RT_VDF_DATA object.

ACL Type Code;

The ACL Type Code is a numeric identifier specifying the type of object referred to by the filename. Values for the ACL Type Code are as follows:

| | | |
|---|---|---|
| #define | ACL_TYPE_UNKNOWN | (0) |
| #define | ACL_TYPE_VOLUME | (1) |
| #define | ACL_TYPE_DIRECTORY | (2) |
| #define | ACL_TYPE_FILE | (3) |
| #define | ACL_TYPE_REGISTRY | (4) |
| #define | ACL_TYPE_BROWSER | (5) |
| #define | ACL_TYPE_TEMP_DIRECTORY | (6) |

Access flags.

The Access Flags are bit flags that indicate a particular permission. If a flag is present (e.g., the value of 1) then the action is permitted. Access Flags are defined as follows:

| | | |
|---|---|---|
| #define | ACCESS_FLAG_NO_ACCESS | (0) |
| #define | ACCESS_FLAG_CREATE | (1) |
| #define | ACCESS_FLAG_OPEN | (2) |
| #define | ACCESS_FLAG_DELETE | (4) |
| #define | ACCESS_FLAG_EXEC | (8) |
| #define | ACCESS_FLAG_MODIFY | (0x10) |
| #define | ACCESS_FLAG_RENAME | (0x20) |
| #define | ACCESS_FLAG_DIR_CREATE | (0x40) |
| #define | ACCESS_FLAG_DIR_DELETE | (0x80) |
| #define | ACCESS_FLAG_DIR_RENAME | (0x100) |

Notify on violation flag.
This flag indicates that the user or support personnel should be notified if the resource defined in the RT_VDF_DATA record object access is denied.

Unique record identifier.
This field contains a unique 128-bit identifier for the RT_VDF_DATA record. This identifier ensures that the centralized management of the record can not collide with any localized management of the record.

Date/Time of record creation.
This field contains the date and time the RT_VDF_DATA record was created in the central database.

Filename.
This field contains the name of the resource being protected. For example, if the ACL Type Code field contains the value ACL_TYPE_FILE, then the Filename field defines a file. If the ACL Type Code field contains the value ACL_TYPE_DIRECTORY, then the Filename field contains a directory name.

Process Name
This field contains the name of the process that is associated with the access flags. For example, suppose the Access Flags field contains the value 0 (indicating NO access) and the ACL Type Code value is ACL_TYPE_FILE and the Filename is “MyPatent.doc”. Now, if the Process Name field is “Word.exe”, then, just for the process Word, the file “MyPatent.doc” may not be modified in anyway. If the Process Name is “*”, then, for any process, the file “MyPatent.doc” may not be modified in any way.
   The rtKeyList similarly contains N number of RT_REG_KEY record objects. Each RT_REG_KEY record object contains the following information:

Pointers to the any previous or next RT_REG_KEY object.

The following Access flags.

| | | |
|---|---|---|
| #define | ACCESS_FLAG_REG_CREATE | (0x200) |
| #define | ACCESS_FLAG_REG_DELETE | (0x400) |
| #define | ACCESS_FLAG_REG_OPEN | (0x800) |
| #define | ACCESS_FLAG_REG_MODIFY | (0x1000) |
| #define | ACCESS_FLAG_REGVALUE_CREATE | (0x2000) |
| #define | ACCESS_FLAG_REGVALUE_DELETE | (0x4000) |
| #define | ACCESS_FLAG_REGVALUE_MODIFY | (0x8000) |

Notify on violation flag.

Unique record identifier.
Date/Time of record creation.
Key name.
This field contains the name of the registry key associated with the access flags.
Value name.
This field contains the value name associated with the access flags. If this field is blank or ‘*’, then any value name will be associated with the access flags.

Process Name
This field contains the name of the process that is associated with the access flags. If this field is blank or ‘*’, then any process name will be associated with the access flags.

The first step in protecting resources is to populate both the file and registry lists. As well not to the ordinarily skilled artisan, this is accomplished through handshaking between the security driver kernel file and the user file CleanIt. A file or registry key can be added to the security driver through the direction of the user or automatically, such as during the cleaning process. Once a file or registry key has been added to either the file or registry list, the security driver protection mechanism is enabled.

Assuming that the security driver has been loaded and that the rtVDFList and rtKeyList lists have been populated then the driver is ready to be activated, which simply involves setting a flag to indicate the driver is active and that any request processing through the KeServiceDescriptorTable table must be inspected.

The driver's table lookup method is relatively straightforward. Each element within a list—the file or registry list—is compared with a set of data. If the set of data matches what is contained within the object record, then a match has been found. There are two table lookup searches that can be performed. The first is an exact search, meaning, the data set to be compared does not have any “*” or “any” indicators within the file or key names. The second lookup form allows for “*” or “any” indicators. Each of these types of lookup table searches can be appreciated from the example below which involves, for representative purposes, the ZwCreateFile function.

With the above in mind, an attempted modification of one or more of the protected registry keys during the waiting interval 816 is detected by the security driver at 90 which then ascertains at 91-94, respectively, whether the threat is trying to create a registry key, delete a registry key, modify or create a registry key value, or delete a registry key value. Based on the characteristic of the threat, flow proceeds to one of 95-98, respectively, to protect against the attempted action. It should be appreciated that diagram 824 in FIG. 9a is stylized representation of what transpires when registry key protector is detected, since each function-create, delete, etc., has its own entry point to the OS.

FIG. 9b illustrates what takes place depending on the type of threat request encountered. Here it may be seen that if the threat is requesting to either delete a protected registry key 96, create/modify a protected registry key value 97 or delete a protected registry key value 98, then a full key name is created of the target key from its handle and subkey name at 910. This is a complicated, but publicly available process, which is currently described at www.osronline.com. Flow then proceeds to 912 to see if the registry key which the threat is referring to, and its value are in the registry key lookup table 913. As may be seen in FIG. 9b, flow proceeds directly to this operation 912 if the threat is attempting to create a protected registry key 95. The table lookup 912 can be somewhat involved because it preferably takes into account the “wild-card” characters “*” and “?”. If the record is found in the lookup table at 914, and the request is not one which is allowed at 916, then an error is returned 918. Otherwise, the security driver allows the request to continue to the original function entry point within the operating system at 920. Returning to FIG. 9a, if an error is returned at 918 a determination is then made at 922 as to whether logging is enabled. The invention contemplates that logging of such events is an option which can be selected or de-selected by a user. If logging is enable, then the located record, referred to as return registry key or “RT_REG_KEY”, is recorded to a “RT_KEY_LIST” table at 924. A registry log event is then signaled at 926 before flow returns 928.

The signaling of the registry by the security driver causes the CleanIt application program to respond at 826 in FIG. 8. CleanIt calls the driver at 1002 (FIG. 10) with an I/O control command to obtain the registry key log. At 1004 the driver retrieves the first record from the registry access table (RT_KEY_LIST) and stores this information into a registry key data structure, referred to as GUI_REG_KEY_DATA. The first record is then deleted from the table at 1006 and the data structure is returned at 1008. If a record does not exist at 1010, then flow simply returns at 1012. Otherwise, a determination is made at 1014 if the log protectors flag is set to “1”, indicating that the log record is to go into a temporary list, versus a permanent data store. If so, then at 1016, the record is inserted into the protector list 1015. Otherwise, the record is preferably maintained in permanent storage 1018, such as on the system's hard drive 126 (FIG. 1). In either case, flow proceeds again to 1002 whereupon the driver sequentially repeats the above for each entry/record within the registry access table. At this point, flow returns to FIG. 8 with the registry key protector list 115 now being fully defined.

With reference again to FIG. 4, as well as FIG. 2a, selecting each of the various tabs 21-211 within the CleanIt application program opens up an associated registered window (FIGS. 2a-k). Each registered window has one or more items “i” managed by it. So, for example, with reference to window 22 of FIG. 2b there are various process-related items, generally 212 managed by it. When a given process item, such as 218 is selected, additional information about the particular process is populated in a child window 220 below, namely, the various dynamic link libraries (DLL) which the process utilizes. Similarly for tab window 22 of FIG. 2f, there are various registry items, generally 222, managed by it. The software creates an object, denoted at times herein as a “ASSESSMENT Object A” or “ASSESSMENT object” which contains information particular to the type of file/registry information encapsulated by each item “i”. Thus, with reference to FIG. 4, for each registered window 418 and for each item managed by the window at 420, an ASSESSMENT object is created at numeral 422. For each ASSESSMENT object, a threat assessment is performed at 424. If the threat level of the ASSESSMENT object is deemed to be “low” at 426, then flow proceeds at 428 to the next item managed by the window, presuming there are more item(s) in response to inquiry 430. If at any time the threat level of an ASSESSMENT object is something other than “low”, the particular object is placed into an ASSESSMENT_LIST Table 431. This process is repeated until there are no more items managed by a particular window at 420, at which point flow proceeds at 432 to the next registered window, if there is one at 434. Once all of the windows and their various items have been assessed, WC is set to equal WN so that the system will not reboot again. Then, at 438, protectors are added and common elements are then assessed at 440. At this point, the ASSESSMENT_LIST Table is complete and the threat assessment process 40 is done 436. Clicking on the “Current Threats” tab 21 (FIG. 2n), will then reveal to the user those items which make up the ASSESSMENT_LIST Table, as well as other information pertaining to the threat (e.g. threat level, location, date and time, etc.), as shown.

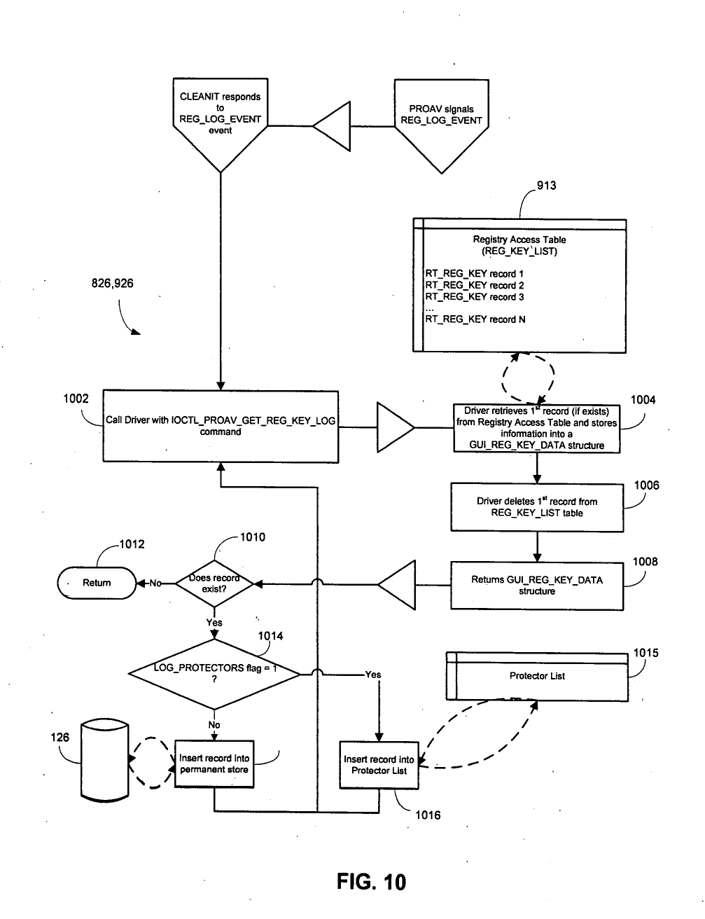

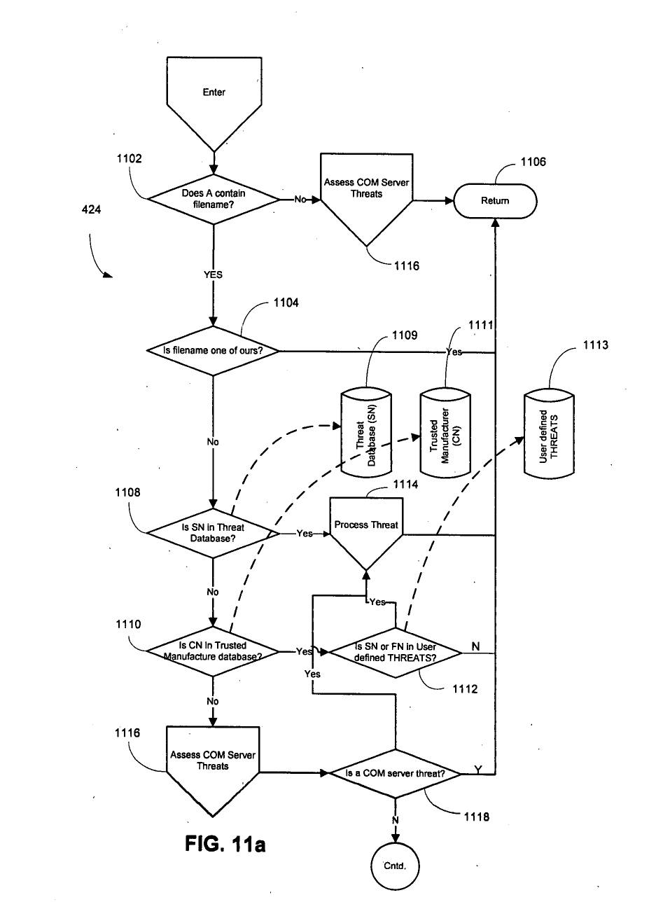

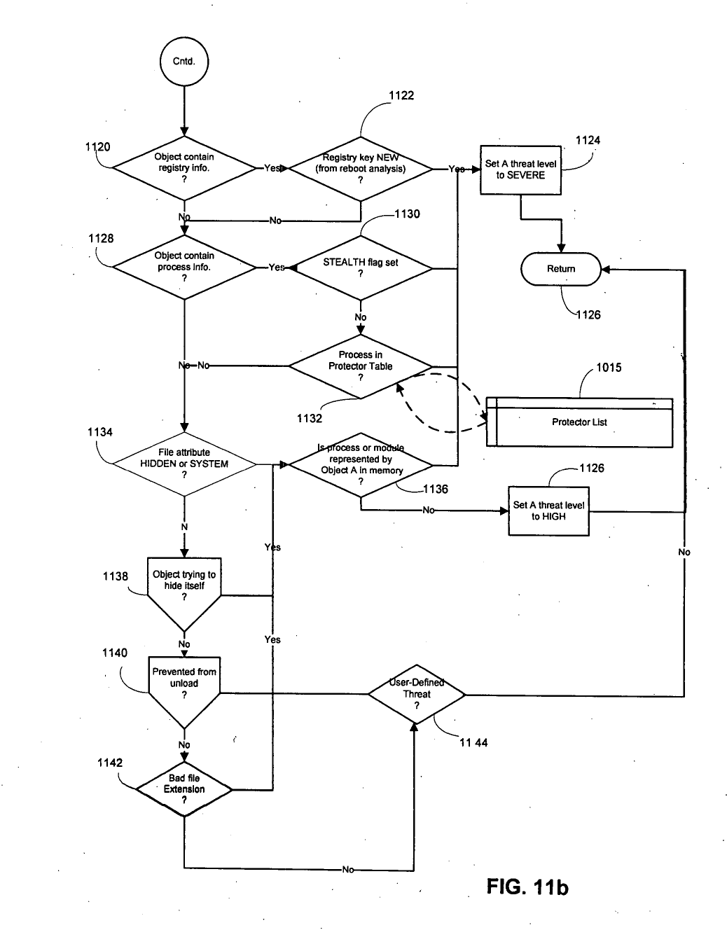

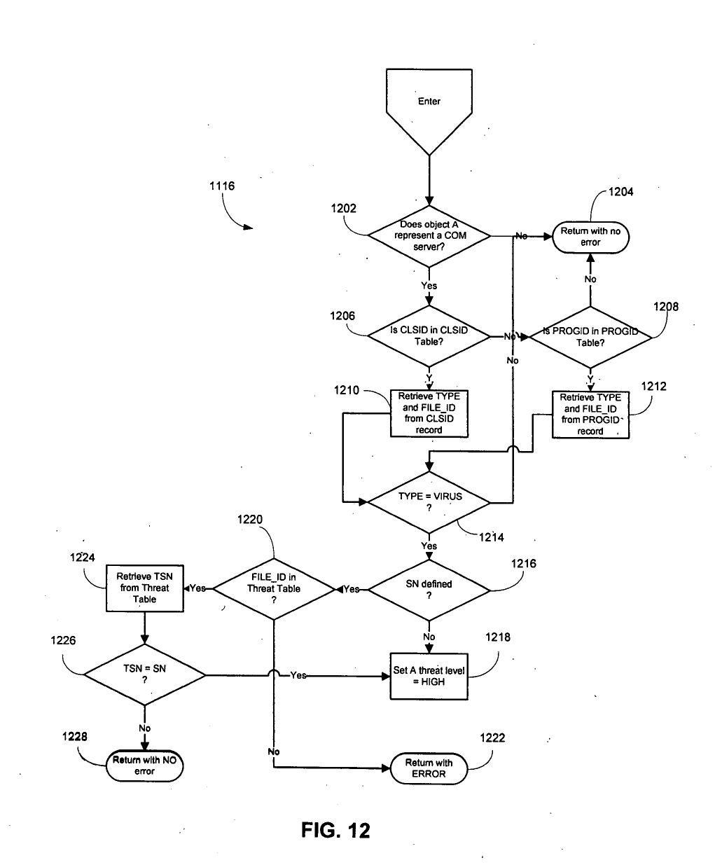

An exemplary procedure for performing a threat assessment on each ASSESSMENT Object A is described now with reference to FIGS. 11a & b, as well as FIGS. 12-14. As mentioned previously, enabling threat assessment is accomplished by the user selecting the “Perform Threat Assessment” option 214 under the “Analysis” menu (FIG. 21). With initial reference to FIG. 11a, the process begins by ascertaining at 1102 whether the particular ASSESSMENT object contains a filename. If so, the following information is retrieved from the object:

FN=full filename (including path)

SN=short filename (no path included)

CN=company name (MFG of A)

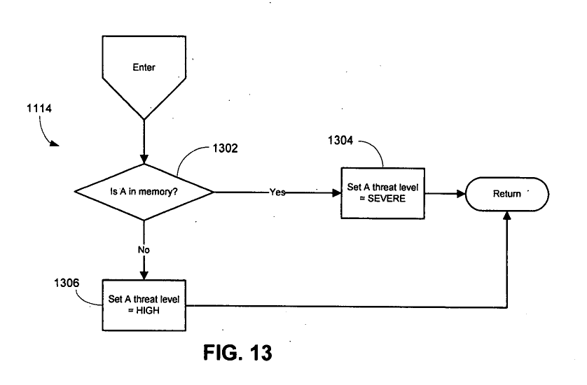

If the particular file name is deemed at 1104 to be one which belongs to the CleanIt application then the process simply returns at 1106. Otherwise, a determination is made at 1108 if the short filename is within an associated threat database 1109. The information with SN database 1109 can be derived from a variety of publicly available sources, such as an open source anti-virus database or information maintained, for example, at the URL: www.spywaredata.com. If not within database 1109, then a determination is made at 1110 if the company name associated with the object is within a trusted manufacture database 1111, which too can be derived from publicly available sources, such as those mentioned above. If so, then an additional inquiry is made at 1112 to ascertain if the short filename or full filename are within a database of the user-defined threats 1113 which can be selectively added to and modified from time-to-time as desired. As can be seen in FIG. 11a, if the particular file is listed within either the SN database 1109 or the user-defined threat database 1113, then the threat is processed at 1114. If the response to both inquiries 1108 and 1110 are negative, then flow 424 proceeds at 1116 to assess existence of COM server threats. As can be seen in FIG. 11a, this sub-routine 1116 also occurs if the ASSESSMENT object is determined not to be a filename at 1102. If the object is a COM server threat, it is processed at 1114. As shown in FIG. 13, processing a threat involves ascertaining at 1302 if the assessment object is in memory. If so, then it is classified as “severe” at 1304. Otherwise, the threat level is classified as “high” at 1306.

In determining whether the particular ASSESSMENT object is a COM server type of threat, the following information is retrieved from it:

SN=short filename

CLSID=128-bit class ID

PROGID=(N) number of user defined names for the COM server

According to subroutine 1116, and as depicted in FIG. 12, a determination is made at 1202 whether the object represents a COM server. If not, then subroutine 1116 returns without error at 1204. However, if it is a COM server, then a determination is made at 1206 whether its class ID (CLSID) is within a CLSID table. The CLSID table can also be derived from a variety of publicly available sources, such as those mentioned above. Each CLSID record within the CLSID table preferably contains the following fields:

CLSID=128-bit unique key

FILE_ID=128-bit unique key

TYPE=VIRUS or NON-THREAT

If it is not with any CLSID Table at 1206, then a determination is made at 1208 whether the object's program ID (PROGID) is in a PROGID Table. As with other tables above, the PROGID table can be derived from publicly available sources. The PROGID Table also contains a plurality of records, each of which preferably contains the following fields:

PROGID=User defined COM server name (e.g., MY.COM.SERVER)

FILE_ID=128-bit unique key

TYPE=VIRUS or NON-THREAT

If the object is also not in the PROGID Table, then flow returns without error at 1204. However, if the object is in either the CLSID Table or the PROGID Table, then its TYPE and FILE_ID fields are retrieved at either 1210 or 1212. If the TYPE field identifies it as a virus at 1216 then a determination is made at 1216 whether its short filename (SN) is defined. COM Server registry threats do not require a filename to be associated with the key. This test ensures the filename exists. This determination is also made because some viruses “steal” a COM server CLSID (that is, they don't create their own, but use a well know CLSID). This test, thus, ensures that if the CLSID is marked as bad, that the file associated with the CLSID is also bad. If not, then the threat level is set to “high” at 1218. If the object's SN is defined then a determination is made at 1220 whether the objects FILE_ID is within a standard database table of threats. The threat table can have a plurality of records each containing the following fields:

TSN=Short filename

FILE_ID=128-bit unique key

TYPE=VIRUS or NON-THREAT

If the file ID is not within the threat table then flow returns with error at 1222 to indicate that the object is a threat so that its level can be set; otherwise, the threat's short filename (TSN) is retrieved from the threat table at 1224. If TSN=SN at inquiry 1226, then the threat level is set to “high” at 1218 because this means the threat is one which is already known. Otherwise, flow returns without error at 1228.

With continued reference now to FIGS. 11a & b, if the object is not deemed a COM server threat at 1118, a determination 1120 (FIG. 11b) is made to ascertain if the object contains registry information. If it does, then a determination is made at 1122 whether the registry key is new. That is, has the reboot analysis discussed above set the object flag to “NEW”. If so, then the threat level is deemed severe at 1124, and flow returns at 1126.

If the object does not contain registry information then a determination is made at 1128 whether it contains process information. If so, a determination 1130 is made as to whether the process' STEALTH flag is set, indicating a known stealth process. As discussed above with reference to FIGS. 3a & b, a process will have its STEALTH flag set if it is trying to hide itself. If this is the case the threat is deemed severe; otherwise, a determination is made at 1132 as to whether the process is in the Protector List table 1015 discussed above with reference to FIG. 8 If it is in the Protector List table then the threat level is also set to severe since this means that there is a process in memory actively protecting the key.

If flow otherwise proceeds to 1134 in FIG. 11b, an inquiry is made as to whether the file's attribute is set as “hidden” or “system” by the operating system. This determination is desired because, whilst operating system files are usually “hidden”, normal files are not. If the file is “hidden” and not part of the OS, the file is considered a threat. If the process or module represented by the object is in memory at 1136 then the threat level is set to severe; otherwise the threat level is set to high before returning 1126. If the response to inquiry 1134 is instead negative then a routine 1138 is invoked to ascertain if the ASSESSMENT object is trying to hide itself. If not, a routine is invoked at 1140 to ascertain if the object is trying to prevent itself from being unloaded from memory. If this is also not the case, then a routine is implemented that 1142 to ascertain if the object has a bad file extension. As can be seen in FIG. 11b, if the object is either trying to hide itself, prevent itself from being unloaded, or if it has a bad file extension, its memory status is ascertained at 1136 to determine the appropriate threat level. If none of these is the case, a final routine 1144 is invoked to determine if the object represents a user defined threat.

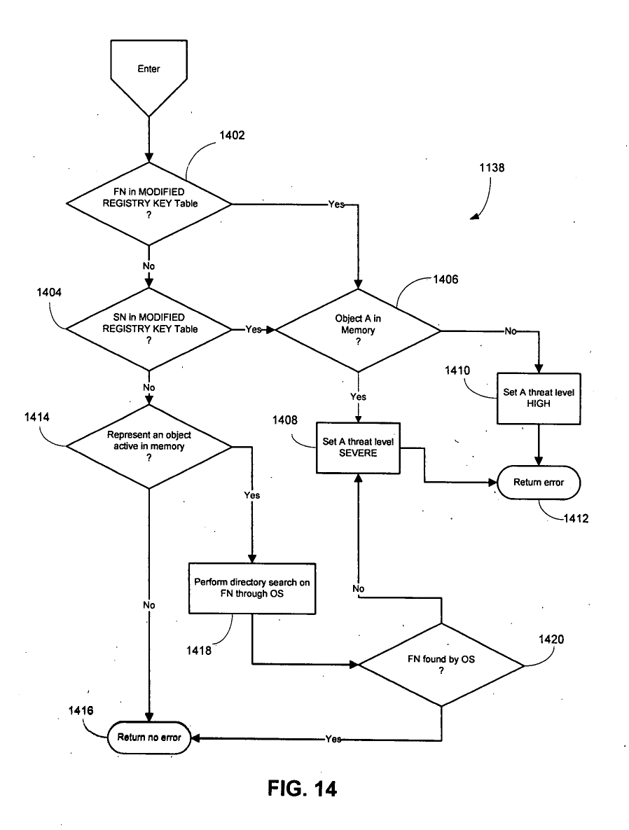

To determine whether the object is trying to hide itself at 1138, reference is made to FIG. 14, wherein it may be seen that determinations are respectively made at 1402 and 1404 whether either the object's full or short filenames are within the modified registry key table created during the reboot analysis. If so, and the object is in memory at 1406, then the threat level is set to severe at 1408. If not in memory, then the threat level is set to high at 1410 before returning with an error at 1412.

If neither of the object's filenames is in the modified key table, then a determination is made at 1414 whether this represents an object which is active in memory (e.g., a process, and module, a service or a driver). If not, then flow returns without error at 1416. However, if the object is active in memory, then a directory search is performed on the object through the OS. If the object's FN is found by the OS then flow returns without error. If not found, the threat level is set to severe.

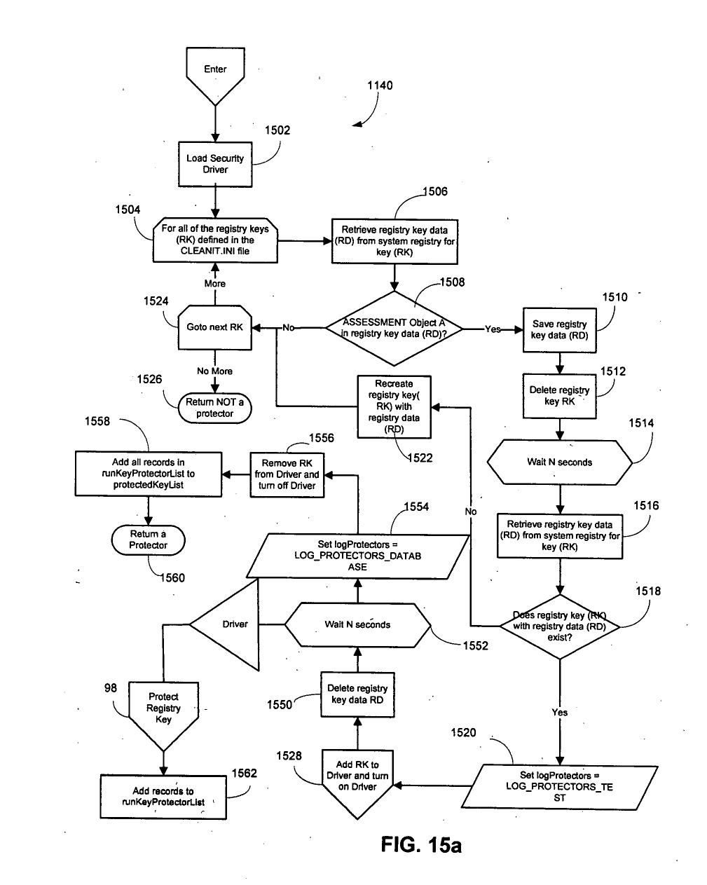

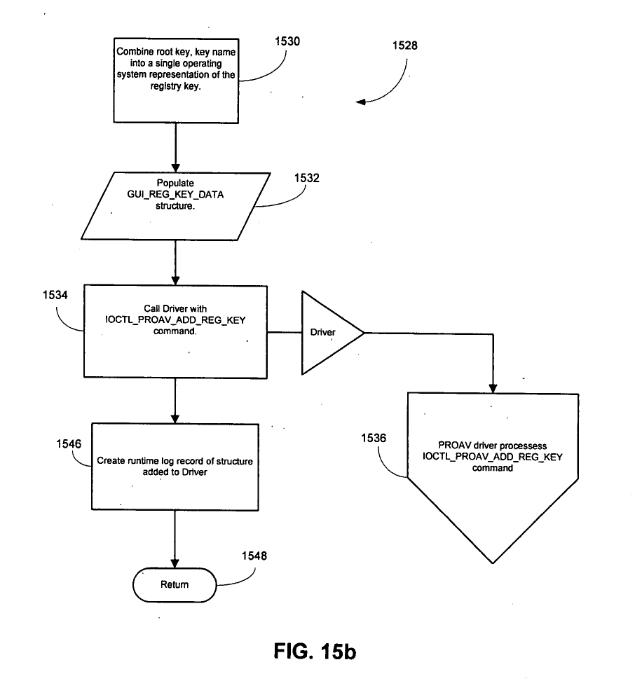

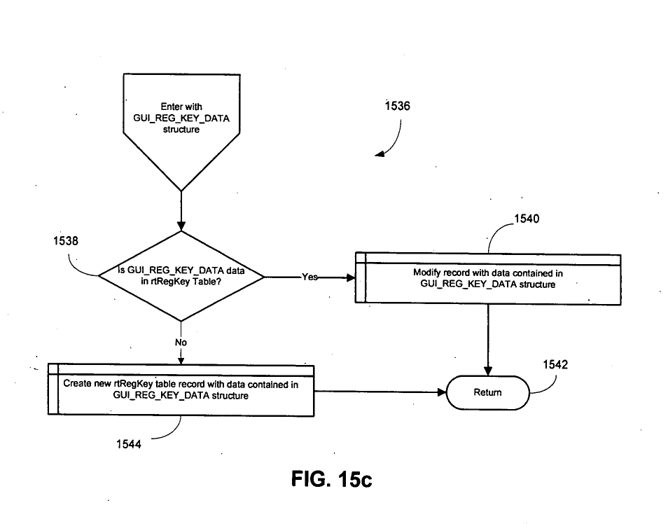

In determining whether the object is trying to prevent self from being unloaded (corresponding to step 1140 in FIG. 11b), reference is made to FIGS. 15a-c. Once the security device driver is loaded into memory at 1502 a loop begins at 1504 for all of the registry keys which are defined in the CleanIt initialization file. Preferably, these keys represent those used by the OS during boot. For each such key, registry key data is retrieved from the system registry at 1506. A determination is then made at 1508 whether the ASSESSMENT object is in the registry key data. That is, for each registry key there can be N “data” items. Accordingly determination 1508 is made to see if the filename is in the data associated with the registry key; if so, the key will be deleted to see if some malware tries to rewrite it. If so, then the data is saved at 1510, the registry key is deleted at 1512 and the system goes into a waiting mode, such as twenty (20) seconds or other suitable amount of time based on one's determination.

After the time duration has passed registry key data is again retrieved from the system registry at 1518 for each key. If a registry key with that data is found to exist at 1518 then a log protectors variable is set to a “test” value at 1520. If such a key does not exist at 1518 then the one is re-created with the registry data at 1522. Flow then proceeds to the next key, if any, at 1524. An indication is returned at 1526 that there are no startup key protectors if the determination of 1518 is in the negative with respect to each of the registry keys in the initialization file.

On the other hand, any time flow proceeds to 1520, the associated registry key is added to the security driver at 1528 and the driver is then turned on. When this happens the root key and the key name are combined into a single operating system representation of the registry key at 1530 (FIG. 15b). The appropriate data structure is then populated at 1532 so that the key is listed when the registry tab window is selected (FIG. 20). The security driver is then called at 1534 with an I/O control command to add the registry key. The security driver receives this command and then proceeds to processes it at 1536, which processing is shown in FIG. 15c. The driver determines at 1538 if the registry key data refers to a RT_REG_KEY within the driver's RT_REG_TABLE. If so, the appropriate record is modified with the data at 1540 before returning 1542. If the data is not in the RT_REG_TABLE, a record is created for it at 1544 before returning at 1542.

Returning to FIG. 15b, a runtime log record of the structure is also added to the security driver at 1546 before routine 1528 returns at 1548. After the startup key has been added to the security driver flow proceeds to 1550 in FIG. 15a to delete the registry key data and enter another waiting mode 1552. After this second waiting interval the log protectors variable is set to the “Database” at 1554, the registry key is removed from the driver and the driver is turned off at 1556, and all records in the startup key protector list are added to the protected key list at 1558 before returning to the calling process that there is a protector. Essentially, these steps are performed in an effort to ascertain who is “protecting” a registry key. The database flag ensures the log data from the driver is placed into a temporary table so that the process is protecting the key is easily identifiable. Also after the second waiting interval the security driver proceeds to protect the registry at 98. This was discussed previously with reference to FIG. 9b and, therefore, need not be repeated. After protecting the key 98, the driver then adds appropriate records to the startup key protector list at 1562.

In determining whether the ASSESSMENT object has a bad file extension (1140 in FIG. 11b), the object's filename extension is retrieved and a determination is made whether the extension is one contained in a file extension lookup table which may include user-defined permissible extensions such as: BMP, JPG, JPEG, TMP, TXT, DOC, GIF, HTM, HTML. If the object's extension is not within the lookup table, then flow proceeds to 1136 in FIG. 11b to determine if the object is in memory. Otherwise, a determination is made at 1144 whether the ASSESSMENT object corresponds to a user-defined threat. This analysis is similar in that a user lookup table can be created to contain threats previously identified by a user. Naturally, if the filename from the ASSESSMENT object corresponds to one within the user's table of threats, then flow proceeds to ascertain whether the object is in memory. Otherwise, flow returns at 1126.

At this point, a complete assessment threat 424 has been performed on an object and program flow will proceed accordingly in FIG. 4. Eventually (i.e. when all ASSESSMENT objects for each of the various registered tab windows have been processed) the variable WC is set to equal WN at 436 so that no more rebooting is performed, protectors are added at 438 and common elements are assessed at 440.

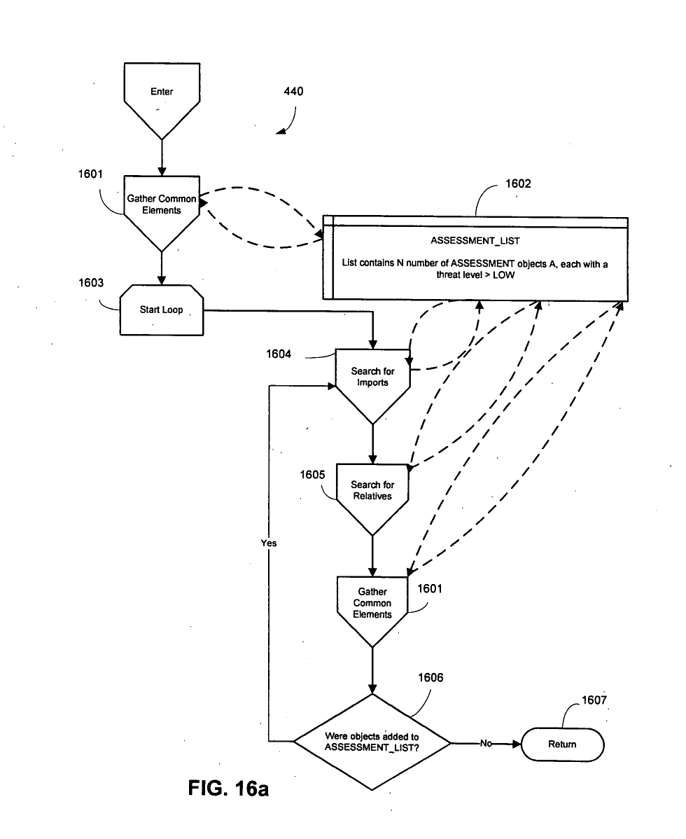

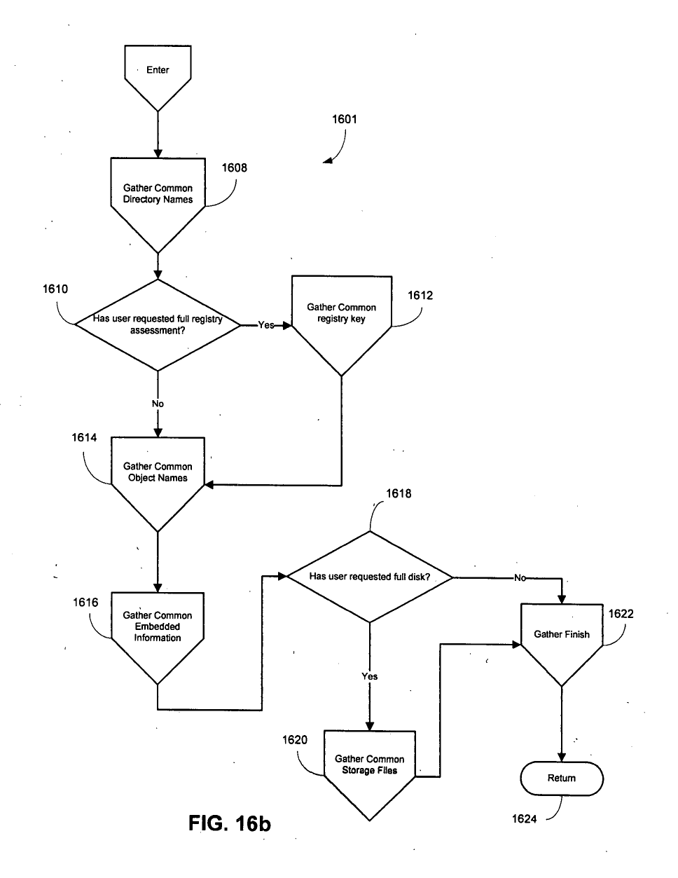

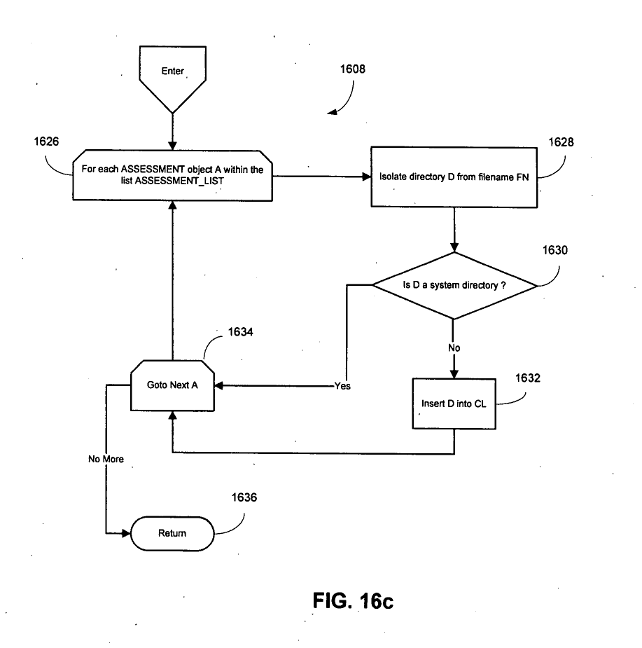

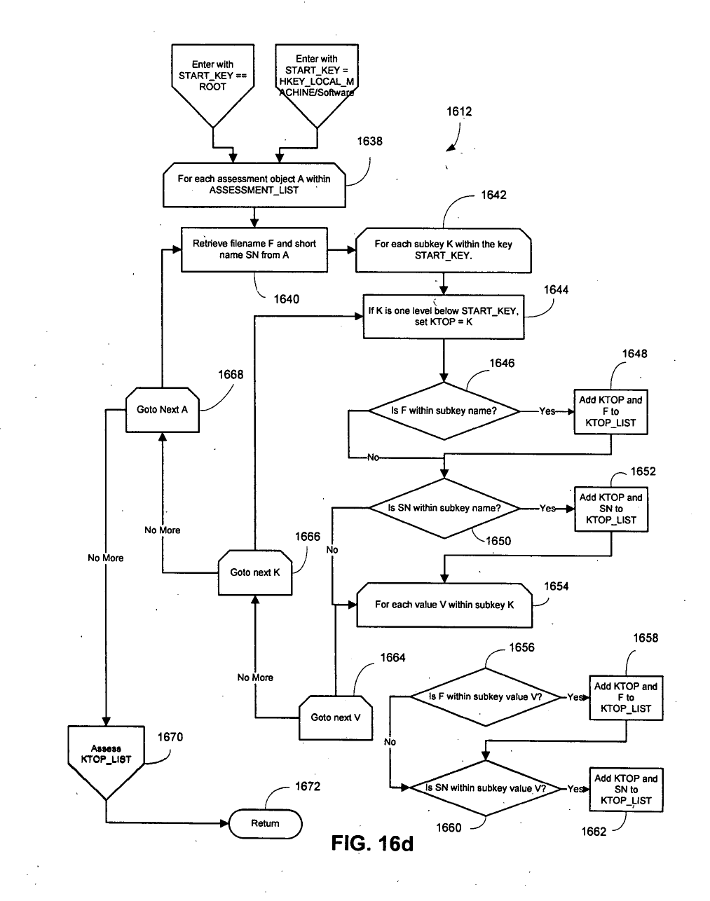

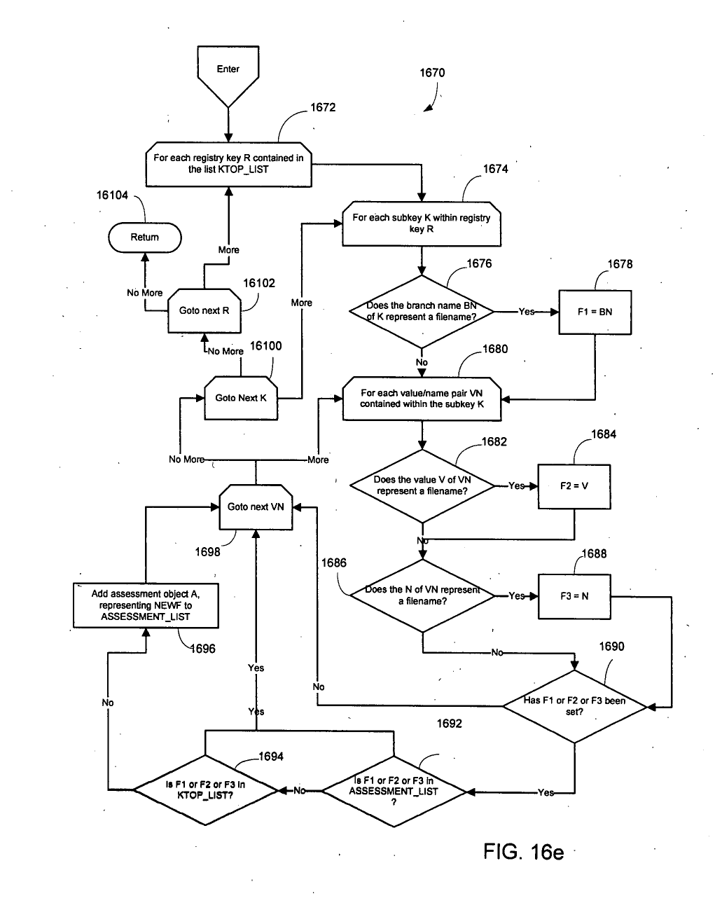

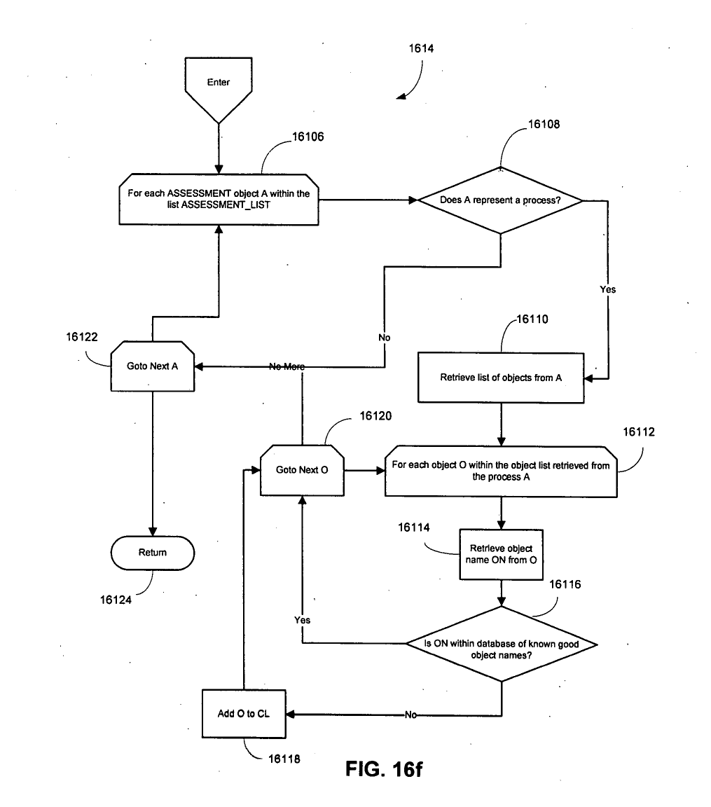

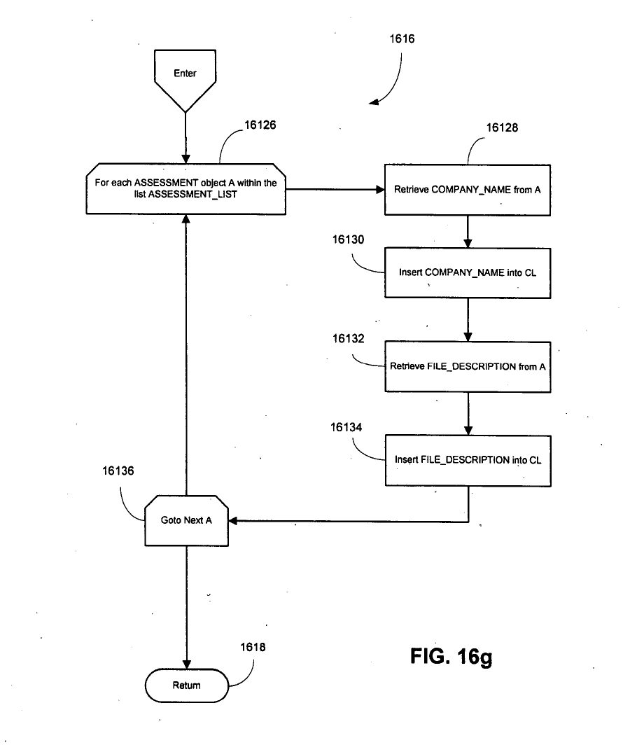

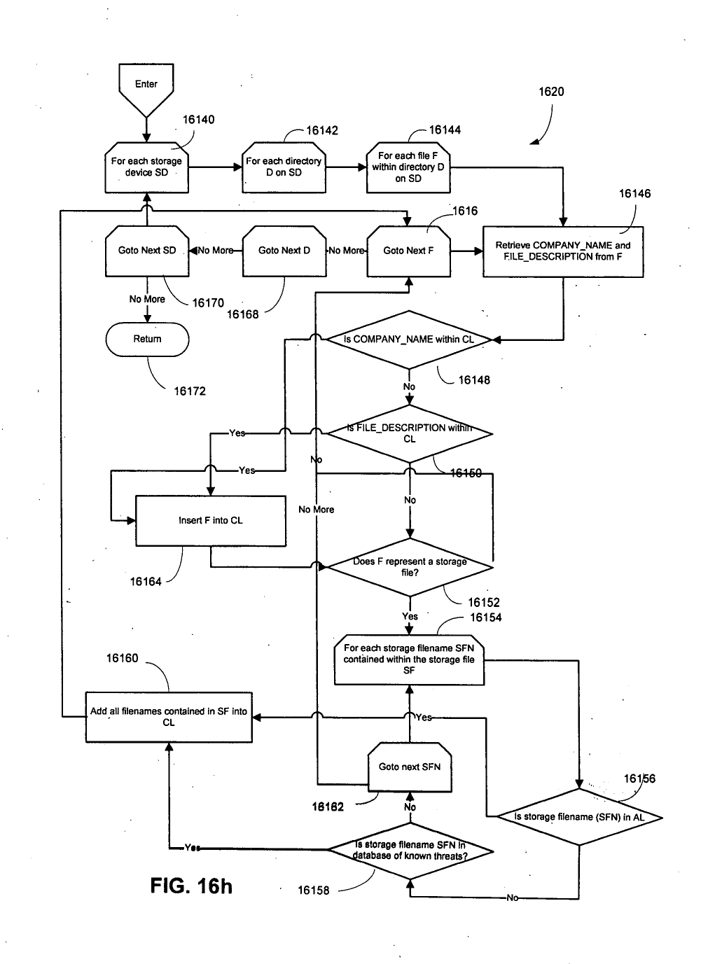

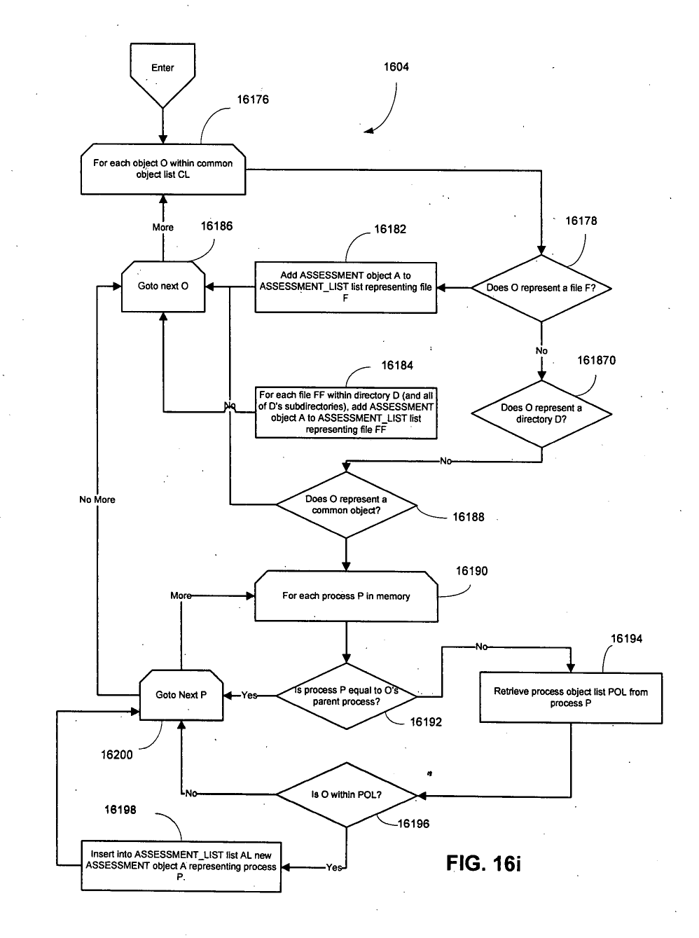

An exemplary procedure for assessing common elements is described now with reference to FIGS. 16a-i, 17a & b. The purpose of this procedure is to retrieve elements from each ASSESSMENT object and then gather other objects within the computer that have the same elements. Each “similar” element is placed into a common list (CL), such that the common list contains information that is “common” to an ASSESSMENT object and another object. A high-level diagram for procedure 440 is introduced in FIG. 16a. Initially, at 1601, common elements are gathered from the ASSESSMENT_LIST 1602. Preferably, the ASSESSMENT_LIST 1602 is a listing of those ASSESSMENT objects which have a threat level >“low”. A loop is started at 1603 whereupon the ASSESSMENT_LIST is searched for imports at 1604 and for relatives at 1605. Thereafter, common elements are again gathered from the list at 1601 and a determination is made at 1606 whether any objects were added to it. If so, the loop repeats until no more objects have been added, at which point the process 440 returns 1607.

In identifying common elements 1601 (FIG. 16b), various “gathering” functions are implemented. Common directory names are gathered at 1608 and, if it is determined at 1610 that the user requested a full registry assessment at upon starting the assessment process, then common registry keys are gathered at 1612. In either case, common object names are gathered at 1614, followed by common embedded information at 1660. If it is determined at 1618 that the user has requested a full disk scan upon starting the assessment process then the common storage files are gathered at 1620. Otherwise, flow proceeds at 1622 to do a final gathering before returning at 1624

Gathering of the common directory names 1608 is shown in FIG. 16c. For each ASSESSMENT object within the ASSESSMENT_LIST at 1626 the directory name is isolated from the filename at 1628, and a determination is made at 1630 whether the retrieved directory is a system directory. If not, the directory is inserted into the comment list at 1632. In either case flow continues to the next object within the ASSESSMENT_LIST, if any, at 1634 before eventually returning at the 1636.

If the user has requested a full of registry assessment then, common registry keys are gathered at 1612, and this is shown in FIG. 16b. The flowchart shows the method to determine whether an assessment object is named in the registry and, if it is, to collect all other filenames, devices, handle names, etc, associated with the filename. For example, suppose we have the registry key RK with the following data:

KEY NAME: RK

DATA1: A-FILE-NAME

DATA2: ANOTHER-FILE-NAME

Now, suppose we know A-FILE-NAME is malware. What we're interested in is finding other filenames associated with A-FILE-NAME in the registry. So, the key RK is read and the value of DATA1 (A-FILE-NAME) is also read. Since A-FILE-NAME is known malware, a match has been found, and other data items in key RK (e.g., DATA2, or ANOTHER-FILE-NAME) are therefore assessed. Continuing with the above example, the filename ANOTHER-FILE-NAME is also added to a registry key list, which is referred to herein as the KTOP_LIST, since it is an associated object.

For each assessment object within the ASSESSMENT_LIST at 1638 the full filename (“FN”) and short filename (“SN”) are retrieved at 1640. A loop then begins at 1642 for each subkey within the start key (START_KEY). If the subkey is one level below HKEY_SOFTWARE, then a variable KTOP is set to equal the subkey K at 1644. If the object file name is within the subkey name at 1646 both KTOP and the filename F are added to a KTOP_LIST at 1648. The registry key list, KTOP_LIST, contains n number of KTOP objects, each representing the filename (F), short filename (SN) and root key of a branch of keys that contain a related registry threat.

If the short filename is within the subkey name at 1650 the KTOP and SN are added to the KTOP_LIST at 1652. For each value within the subkey at 1654 a determination is made at 1656 whether the filename is within the subkey value. If so, then KTOP and the filename are added to the KTOP_LIST at 1658. In either case, flow then proceeds to 1660 to determine if the short filename is within the subkey value. If so then it and KTOP are added to the KTOP_LIST at 1662. When there are no more values at 1664, no more KEYS at 1666 and no more objects at 1668 then flow proceeds at 1670 to assess the KTOP_LIST before returning at 1672.

Assessing the KTOP_LIST is shown in FIG. 16e. For each registry key contained in the list at 1672, and for each subkey within each registry key at 1674, a determination is made at 1676 whether the branch name of the key represents a filename. If so, then a variable F1 is set to equal the branch name at 1678. Then, for each value/name pair contained within the subkey at 1680 a determination is made at 1682 whether the value of the value/name pair represents a filename. If so, then another variable F2 is set to equal the value at 1684. At 1686 a determination is made whether the actual value name itself (N) represents a filename. If so, then another variable F3 is set to equal N at 1688.

Flow eventually proceeds to 1690 where a determination is made whether F1, F2 or F3 have been set. If so, then another determination is made at 1692 whether any of them are in the ASSESSMENT_LIST. If not, then a determination is made at 1694 as to whether any of them are in the KTOP_LIST. As can be seen in FIG. 16e flow may proceed directly to another value/name pair, if any, at 1698 in response to any of inquiries 690, 1692 or 1694. Otherwise, if flow proceeds to 1694 and it is determined that none of F1-F3 is in the KTOP_LIST, then the ASSESSMENT object A represents a new file and is added to the ASSESSMENT_LIST at 1696. Once there are no more value/name pairs at 1698, no more subkeys at 16100 and no more registry keys and 16102, flow returns at 16104.

Gathering of common object names 1614 is described now with reference to FIG. 16f. For each ASSESSMENT object within the ASSESSMENT_LIST at 16106 a determination is made at 16108 whether the object is a process. If so, then the list of objects are retrieved from the process at 16110. The method of doing so is well-known and relates to retrieving all “objects” that the process has created—handles, mutexes, semaphores, waits, etc. A complete listing is shown below

Object Names

Window Station

Desktop

Process

Threads

File

Section

Access Token

Directory

Symbolic Link

Registry Key

Port

Event

Event Pair

Mutant

Semaphore

Timer

Waitable Port

IoCompletion

Keyed Event

Profile

Wmi Guid

Job

Controller

Device

Driver

Debug Object

Adapter

Callback

Name Pipe

Anonymous Pipe

Printer

Service

Share

For each retrieved object at 16112 the object name is retrieved at 16114. If the object name is within a database of known good object names at 16116 then flow proceeds to the next object that has been retrieved, if any, at 16120. If not within the database then the object is added to the Common List (mentioned above) at 16118 before proceeding to the next object. Once there are no more objects retrieved from a process, and no more ASSESSMENT objects within the ASSESSMENT_LIST at 16122, flow returns 16124.

Gathering of common embedded information 1616 is shown in FIG. 16g. For each ASSESSMENT object within the ASSESSMENT_LIST at 16126 a company name is retrieved at 16128 and inserted into the Common List at 16130. A file description is also retrieved at 16132 and inserted into the common list at 16134. The company name and the filename are retrieved through known Windows OS functions. Their insertions into the Common List ensure that one and only one Common List element has the same value—that is, there are no duplicates within the Common List. The above is repeated until there are no more objects within the ASSESSMENT_LIST at 16126, at which point flow returns 16138.

Gathering of common storage files 1620 is shown in FIG. 16h. For each storage device at 16140, and each directory at 16142, and each file within the associated directory at 16144 a company name and file description are retrieved from the file at 16146. Determinations are then made at 16148 whether the company name is within the Common List, at 16158 whether the file description is within the Common List, and at 16152 whether the file represents a storage file. Storage files are archived files—i.e., files that contain other files, usually compressed for space efficiency. Typical extensions for such files included ZIP, CAB, RAR, TAR, etc. If either the company name or the file description is within the Common List then the file is inserted into the common list at 16164 for precautionary purposes. If not, but the file represents a storage file at 16152, then for each storage file name contained within the storage file at 16154 a determination is made at 16156 whether the storage file name is in the ASSESSMENT_LIST. If not, a determination 16158 is made whether the storage file name is within a database of known threats. If the response to either of inquiries 16156 or 16158 is in the affirmative then all filenames within the storage file are added to the Common List at 16160. If both responses, however, are negative then flow proceeds to the next storage file name, if any, at 16162. Once there are no more storage file names at 16162, no more files at 16166, no more directories at 16168 and no more storage devices at 16170, flow returns at 16172.

Final gathering of information 1622 is shown in FIG. 16h. For each object within the Common List at 16176 determinations are made at 16178 and 16180, respectively, whether it represents a file or a directory. If a file, then an ASSESSMENT object is added to the ASSESSMENT_LIST representing the file at 16182; if a directory, then an ASSESSMENT object is added to the ASSESSMENT_LIST for each file and subdirectories within the directory at 16184. Thereafter, flow proceeds to the next object at 16186, if any.

If the object is neither a file nor a directory then a determination is made at 16188 whether it is a common object, that is, whether it represents the name of a handle, a mutex, a semaphore, etc—basically, a runtime system object. If so, then for each process in memory at 16190 a determination is made at 16192 whether the particular process is the object's parent process. If not, then each process object list (POL) is retrieved for the particular process at 16194. Then, a determination is made and 16196 whether the object is within the retrieved POL. If so, a new ASSESSMENT object representing the process is inserted into the ASSESSMENT_LIST at 16198. Otherwise, flow proceeds to the next process, if any, at 16200. When there are no more processes and no more objects, flow returns 16202.

Reference is now made to FIG. 17a to describe the operation of searching the ASSESSMENT_LIST for imports (1604 in FIG. 16a). For each ASSESSMENT object in the ASSESSMENT_LIST at 1702 a list of import libraries is retrieved from the object at 1704. For each library within the import list at 1706 a determination is made at 1708 whether the library is within a permissible library list. The permissible library list (referred to as the OK Library List) contains n library filenames such that, if a given library filename is within the list, it is not considered a threat.

If not within the library list at 1708 a determination is made at 1710 whether the library filename is within the database of known threats. If so, it is added to the ASSESSMENT_LIST at 1712. A determination is then made at 1714 whether the library filename is within the ASSESSMENT_LIST. If not then it is added. This basically ensures that there are no duplicates in the library list. Otherwise, a determination is made at 1714 whether the library manufacture is within a list of known good manufactures. If not, then the library is added to the ASSESSMENT_LIST; otherwise, it is added to the OK Library List at 1718. Eventually, flow will proceed to the next library at 1720, and if not at the end of the library at 1722, then the above is repeated. Once the entire library has been assessed flow proceeds to the next object at 1724. The above is also repeated until there are no more objects at 1726, at which point flow returns 1728.

Finally, the procedure for searching the ASSESSMENT_LIST for relatives (1605 in FIG. 16a) corresponds to procedure 1612 discussed above with reference to FIG. 16d and, thus, need not be repeated. The same holds true for the step 1601 (2^{nd} occurrence) for gathering common elements from the ASSESSMENT_LIST, which was described previously in FIGS. 16b-16i.

C. Threat Management

1. Introduction

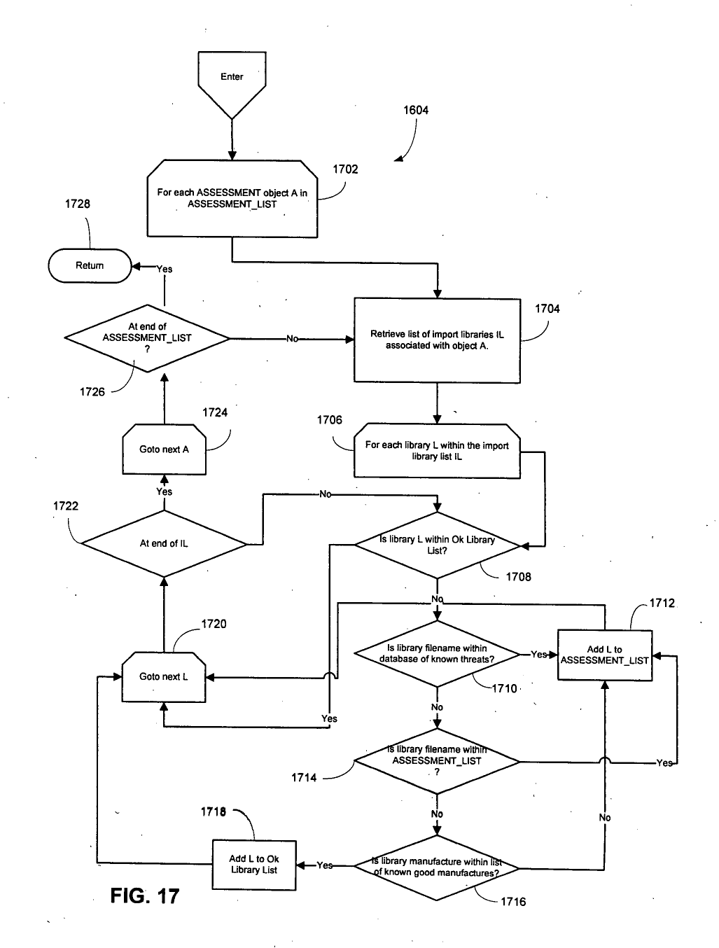

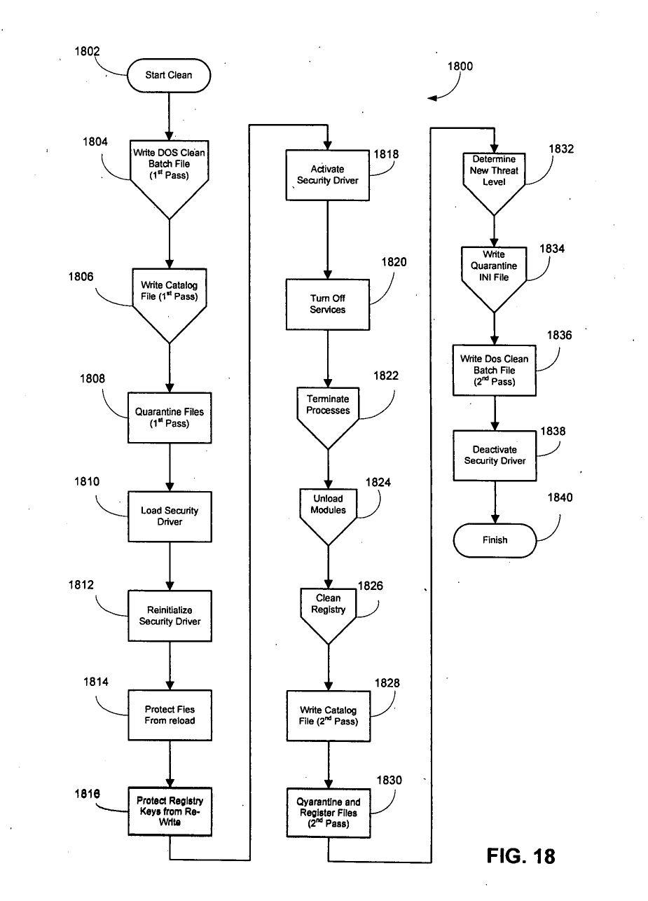

Once threats have been assessed, managing the threats through a thorough cleaning process can begin, as will now be described. A high-level a diagram 1800 for the cleaning process is shown in FIG. 18. When cleaning starts 1802, a clean batch file is initially written in DOS at 1804. A first pass is made to write to a catalog file at 1806 and to quarantine files at 1808. The security driver is loaded 1810 and reinitialized at 1812. Files are protected from being reloaded at 1814 and registry keys are protected from being rewritten at 1816. The security driver is then activated 1818.

At this point, services are turned off 1820, processes are terminated 1822, modules are unloaded 1824 and the registry is cleaned 1826. During a second pass, a catalog file is again written 1828, and files are quarantined and registered at 1830. A new threat level is then calculated 1832. A quarantined initialization file is written 1834 and a clean DOS batch file is again written at 1836. Thereafter, the security driver is deactivated 1838 and cleaning process 1800 finishes at 1840.

2. Removing Processes and Modules Through DOS

Although DOS has been eclipsed by more powerful upgraded systems, it is a distant cousin to Windows and is useful in helping removing processes and modules from a computer running a Windows OS. A majority of computers that support the Windows OS have a BIOS (Basic Input/Output System) that is typically contained within a piece of firmware and executed when the computer is powered on. The BIOS code's main purpose is to perform preliminary system tests and then to start the boot process. This basic boot process is the same for both computers with DOS or computers with Windows, which means a user could boot his computer into Windows, shut down the computer and then restart running DOS. It is the BIOS code that allows this transition to happen. Furthermore, both DOS and Windows are designed so that the OS arbitrates resources, one of which is the hard disk. There are many ways by which an OS can physically lay out a hard disk, but all forms have several elements in common—a root directory, an allocation table and files. The OS entity which understands the hard disk layout is an associated device driver. Both DOS and Windows have hard disk device drivers. By exploiting this commonality, and the commonality of the BIOS code, processes and modules can be identified through a Windows program yet removed by a DOS program. This capability is beneficial because viruses installed within Windows often try to avoid being removed. This usually means a process or module program within Windows may not have the power to actually delete or remove any virus files.

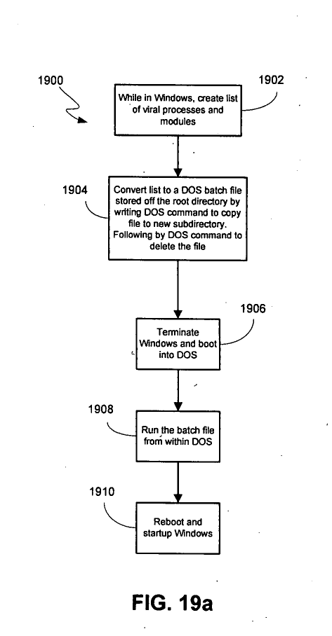

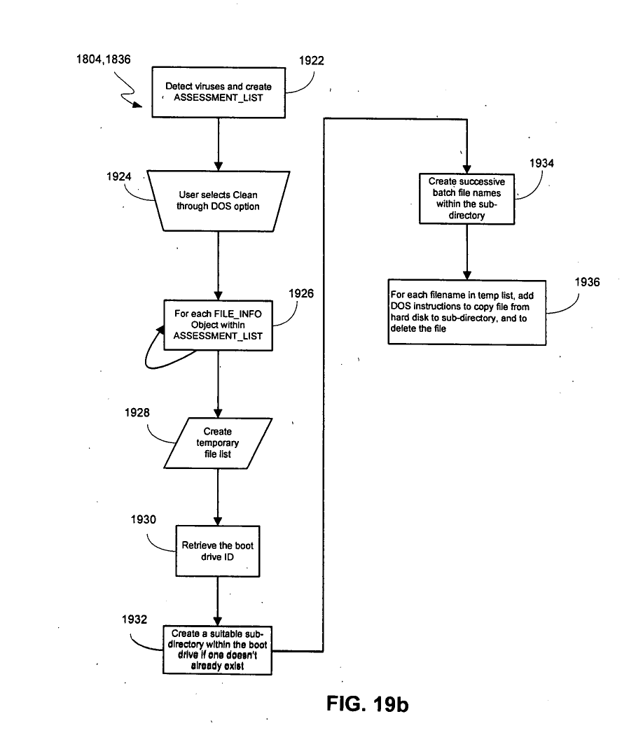

With the above in mind, a general method 1900 for removing processes and modules through DOS is shown in FIG. 19a While in Windows, a list of viral processes and modules is created 1902. This step corresponds the creation of the ASSESSMENT_LIST described above. At 1904 this list is converted to a DOS batch file and stored off the root directory by (1) writing the DOS command to copy the file to a new subdirectory; and (2) writing the DOS command to delete the file. For example,

COPY C:\DIR\VIRUS.EXE C:\SUBDIR

DEL C:\DIR\VIRUS.EXE

Windows is then terminated and the computer is booted into DOS at 1906. The batch file is then run from within DOS at 1908 so that the malware is deleted, and the computer system is thereafter rebooted into Windows at 1910.

FIG. 19b more particularly illustrates the writing of a DOS clean batch file during the first and second passes, 1804 and 1836 respectively, in FIG. 18. This function writes a DOS batch file in a CleanIt directory off of the root directory of the boot drive. The DOS batch file has above two commands within it.

This method presumes at 1922 the prior detection of viruses and creation of the ASSESSMENT_LIST, all as described above. At 1924 the user selects the “cleaning through DOS” option which can be an available option from the drop down sub-menu 224 (see FIG. 2P) For each associated object within the ASSESSMENT_LIST at 1926 a temporary file list is created 1928. The boot drive's ID is then retrieved at 1930 and a suitable subdirectory, such as “CleanIt”, is created therein at 1932 if one does not already exist. Successive batch file names are created within the subdirectory at 1934. In doing so, the DOS “short name” form of the ASSESSMENT object's filename is created. For each filename in the list, the DOS instructions are added at 1936 to the batch file to copy the file from hard disk to the subdirectory and then delete the file, as discussed above. The computer can then be subsequently shut down and booted to DOS at which time the batch file would be run.

A preferred procedure for writing catalog files, corresponding to operations 1806 (1st pass) and 1826 (2nd pass) in FIG. 18, may now be appreciated with reference to FIG. 20. The catalog file keeps information about each threat in a form that can be easily uploaded to our server. This helps to maintain a database of threats. At 2002, the current catalog INI file is opened. The format for the catalog file is a standard operating system INI file. At 2002 the next index numbers for the following information headers are retrieved:

1) file

2) registry

3) CLSID

4) PROGID

For each ASSESSMENT object within the ASSESSMENT_LIST at 2004, a determination is made at 2006 whether the object contains file information. If so, the following information is written to the catalog file at 2008:

1) Filename

2) MD5 signature

3) Company Name

4) File attributes

5) File Description

6) File size

7) File date/time

8) Version

9) Linker version

Once this is completed, or if the ASSESSMENT object does not contain file information at 2006, flow proceeds to determine whether there are any additional ASSESSMENT objects at 2010 before returning at 2012.

Returning to FIG. 18, the steps of quarantining and registering files during the first and second passes, 1808 and 1830 respectively, are employed to place a virus file into a compressed quarantined file so that it may be deleted. Accordingly, with respect to each ASSESSMENT object within the ASSESSMENT_LIST, a determination is made as to whether the ASSESSMENT object contains file information and, if so, it is quarantined.

In protecting files from reload, step 1814 in FIG. 18, each ASSESSMENT object within the ASSESSMENT_LIST is again examined to ascertain if it contains file information. If so, then the long the filename (FN) from the object is retrieved, from which a short filename (SN) is created. As known, the Windows OS has two valid names associated with each file—a long filename and a short filename. The long filename may contain spaces, while short filename may not contain spaces, nor may any segment be more than 11 characters. Because both forms are valid, the security driver preferably needs both within its tables in order to provide protection. Once the long and short names are known then the long filename is added to the driver with no access permissions for all processes, with the exception of the CleanIt application. The same holds true for the short filename. This prevents any processes and other than those associated with the CleanIt application from reloading the files.

In order to protect registry keys from being rewritten, step 1816 in FIG. 18, the root key, key name and value name are added to the security driver with NO permissions being set for all processes. The security driver, however, has ALL permissions for the CleanIt process and it's associated root key, key name and value name. In order to turn off services, corresponding to step 1820 in FIG. 18, each ASSESSMENT object within the ASSESSMENT_LIST is inspected to ascertain if it contains control set data. If the ASSESSMENT object does not refer to a control set object (i.e., an object that describes a driver or service) then it can't be used to turn off the server. If, however, the object does contain control set data, the device driver is unloaded before termination of processes, unloading of modules or cleaning of the registry.

3. Terminating Computer Processes and Modules

To manage memory effectively, operating systems divide sets of working code into different areas of memory. Each set of codes responsible for doing useful work is termed a “program” or a “process”, and each different area of memory that contains a program is termed a “process space”. For the most part there is not a simple one-to-one correspondence between a computer “program”, i.e., an executable file on a disk, and a “process”. While this may have been true for simpler, older computers, newer operating systems have numerous processes, each of which might include dozens of separate computer programs. Currently, there is one single “program” that gets the process going, but it is adjoined with other programs to make a complete “process”. These other programs typically are called “modules” which, in the Windows OS, usually have the file extension “.DLL”.

To simplify the management of processes, computer operating systems use a “number” to identify and separate processes. This number is known as a handle. With a process handle available, another process can perform an operating system call and gather information about the process or terminate or suspend the process. The Window OS provides a function, TerminateProcess( ), that can be used by other processes to terminate a process given a process handle. TerminateProcess( ) takes a process handle as a parameter. However, the function TerminateProcess( ) ascertains the rights and privileges associated with the process handle before actually terminating it. If the handle does not have sufficient rights, such as when the user running the computer at the time of the function call does not have administrator privileges, then TerminateProcess( ) does not work.

Obtaining a valid process handle can be quite complex. Windows divides processes into two basic camps: user-mode and kernel-mode. Kernel-mode processes (typically called “drivers”) run within the context of the operating system and, therefore, have privileges equal to the operating system itself. User-mode programs, on the other hand, are placed into confined memory areas and have limited privileges. Thus, the difficulty with terminating a process from user-mode is that the program wishing to perform the termination must have a process handle with sufficient rights. This is important because many viruses try to ensure they cannot be easily terminated.

a. Terminating a Process

A general method 2100 for terminating a computer process, as shown in FIG. 21a, involves obtaining the process ID (“ProcID”) for the process to be terminated 2102, converting the ProcID into a process handle with termination rights 2104 and then terminating the process at 2106. A more detailed method 2108 of terminating a process can be appreciated with reference to FIGS. 21b & c At 2110 a Win32 function is called which, given a particular ProcID 2112, attempts to obtain the process handle. A respective ProcID would, of course, be associated each of those processes in the ASSESSMENT_LIST that is generated as part of the detection component described above.

If a handle can be obtained at 2114 a determination is made 2116 whether there are sufficient process termination rights to open the process. If so, the process handle is returned at 2118. However, if the handle cannot be obtained at 2114 or if there are insufficient rights to open the process, flow proceeds to 2120 to ascertain whether the process can be opened with discretionary access rights through WRITE_DAC. If so, then a subroutine 2122 (FIG. 21c) is called to adjust the current access rights. Otherwise, a determination 2124 is made as to whether a process token can be created. If not, then method 2108 returns NULL at 2126 to indicate the handle cannot be obtained for the process corresponding to the given ProcID. If, on the other hand, a process token can be created then determinations, 2127-2129 respectively, are made whether information about the token can be retrieved, whether security permissions can be set, and whether the process handle can be duplicated. If the response to any of these inquiries is negative, then the NULL handle is returned. However, if the response to each inquiry is in the affirmative, then flow proceeds to subroutine 2122 which is shown in FIG. 21c.

According to subroutine 2122, a determination is made 2124 whether entries in the access control can be set. If not, then the NULL handle is returned at 2126. If so, then new adjusted security privileges are provided at 2128 to enhance access rights to the handle, and a determination is then made at 2130 whether the handle's security privileges can be adjusted. If so, then the function returns a SUCCESS at 2132; otherwise it returns a FAILURE at 2134. Returning to FIG. 21b, if it is found at 2136 that the handle's access control can be set (i.e. Return SUCCESS), the adjusted handle is duplicated 2138 and then returned at 2140. Otherwise, the calling function returns the NULL handle.

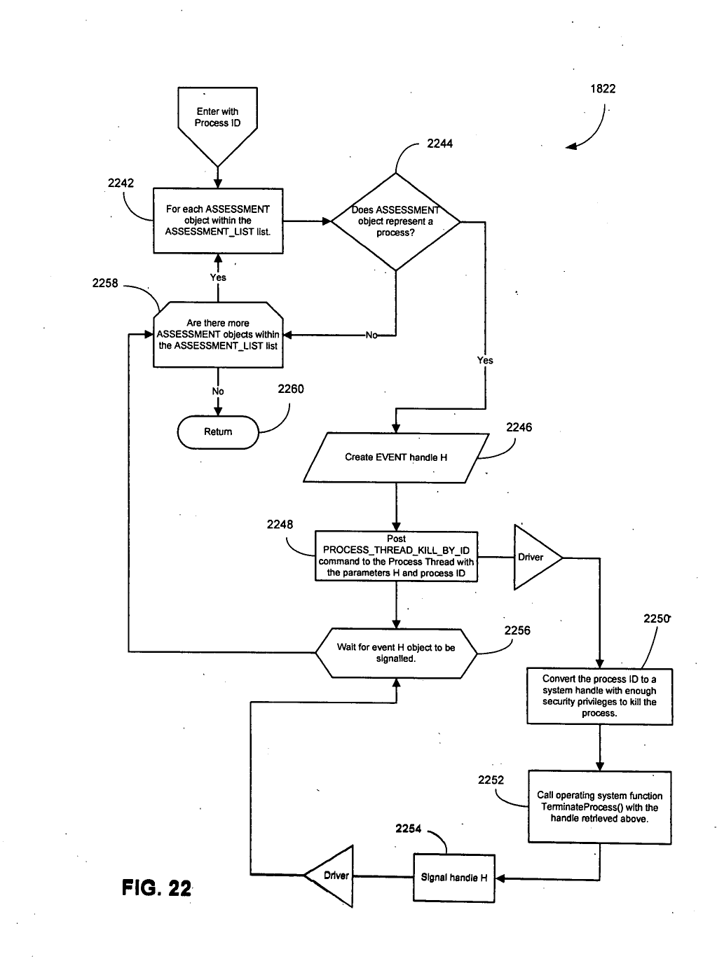

With an appreciation the above, reference is now made to FIG. 22 the to describe the operation of terminating processes (1822 in FIG. 18) during the cleaning phase. Given a ProcID, for each ASSESSMENT object within the ASSESSMENT_LIST at 2242 a determination is made at 2244 whether the object represents a process. If it does, an event handle is created at 2246 and a message is posted to the security driver at 2248 to kill the process. Key parameters passed to the security driver include the ProcID and the event handle which is then created. In processing this handle, the security driver converts the ProcID to a system handle at 2250 with sufficient security privileges to kill the process. This is a complicated, yet publicly available conversion process described at the website www.osronline.com, referred to above. Thus, it too is not detailed here. At 2252 the operating system function TerminateProcess( ) is called with the handle, and the driver generates a signal handle at 2254. The process then waits at 2256 for the event handle to be signaled. Once the process has been terminated, flow proceeds to 2258 to ascertain if there are more ASSESSMENT objects which represent a process. If so, then the above logic is repeated until flow eventually returns 2260.

b. Terminating a Module

The method for unloading a module is more involved. Modules are essentially helper programs that are run within the same “sandbox” confines as a process. There is a Windows function to remove a module from memory, FreeLibrary( ), but, there is a problem because the FreeLibrary( ) function must be called within the context of the owning process. The following example illustrates this. Suppose there are two processes in memory, process “A” and process “B”. Assume further that each process has two modules attached, modules m1 & m2 associated with process A and modules m3 & m4 associated with process B. Now, suppose that process B wants to unload module m2 from Process A's memory space. If Process B tries to use the FreeLibrary( ) function, it could only free modules m3 and m4, not m1 and m2, even if it has the handle to either m1 or m2. This is because the FreeLibrary( ) only looks at modules within the calling process, in this case process B.

Thus, and continuing with the example, the following explains a preferred approach for process B to unload module m2 from process A's memory space. Process B initially retrieves the address of the function FreeLibrary( ) within memory. This can be obtained because the FreeLibrary( ) function is contained within the Kernel32.DLL library and because the Kernel32.DLL library maps to the same address in all processes. It is important to appreciate that the Windows function that returns the address of a function does so within the context of the calling process. Therefore, if process B calls to retrieve the address of FreeMemory( ), the operating system returns the address of FreeMemory( ) function within process B's memory space. However, it is necessary to obtain the address of FreeMemory( ) in process A's memory space. But, because Kernel32.DLL is loaded at the same address for all processes, process B can conveniently use the address of FreeMemory( ) within its process space because it is the same address as in A's address space.

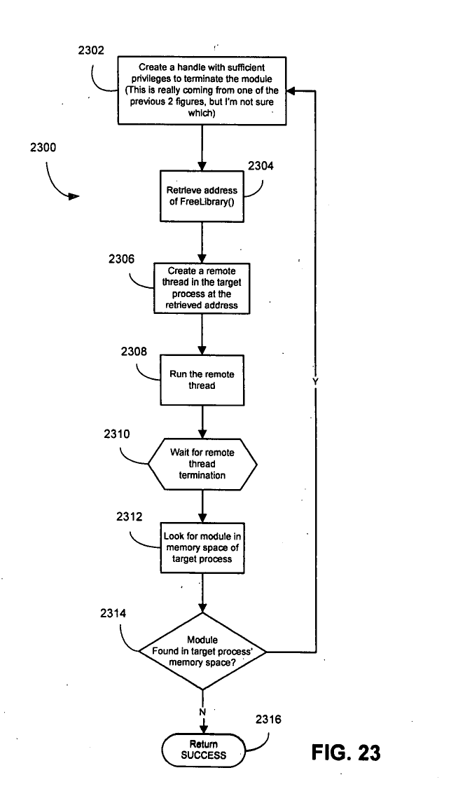

With the above in mind, a preferred approach 2300 for module termination is now discussed with reference to FIG. 23. A handle is initially created 2302 with sufficient privileges to terminate the module. The address of the FreeLibrary( ) function is retrieved 2304 and a remote thread is created 2306 in the target process at the retrieved address. The remote thread is then run 2308 before waiting 2310 a selected duration for the remote thread to terminate. The method waits for the remote FreeLibrary( ) function to return by processing a Wait function. This is because there is no way for the method to know how long the remote FreeLibrary( ) function will take to actually free the module.

The FreeLibrary( ) function is not guaranteed to actually remove the requested module from memory. This is because each module in memory has a “reference” count associated with it to indicate how many functions require the module to be in memory. The FreeLibrary( ) function first decrements the reference count. Should the count go to zero, the module is actually removed from memory. Therefore, to guarantee a module is removed from memory, additional logic is performed. Namely, the target process' memory space is analyzed at 2314 to ascertain if the target module exists. If it is found (i.e. the reference count is not zero) then flow proceeds again to step 2302. Otherwise (i.e. the reference count equals zero), a SUCCESS indication is returned to the calling function at 2316.

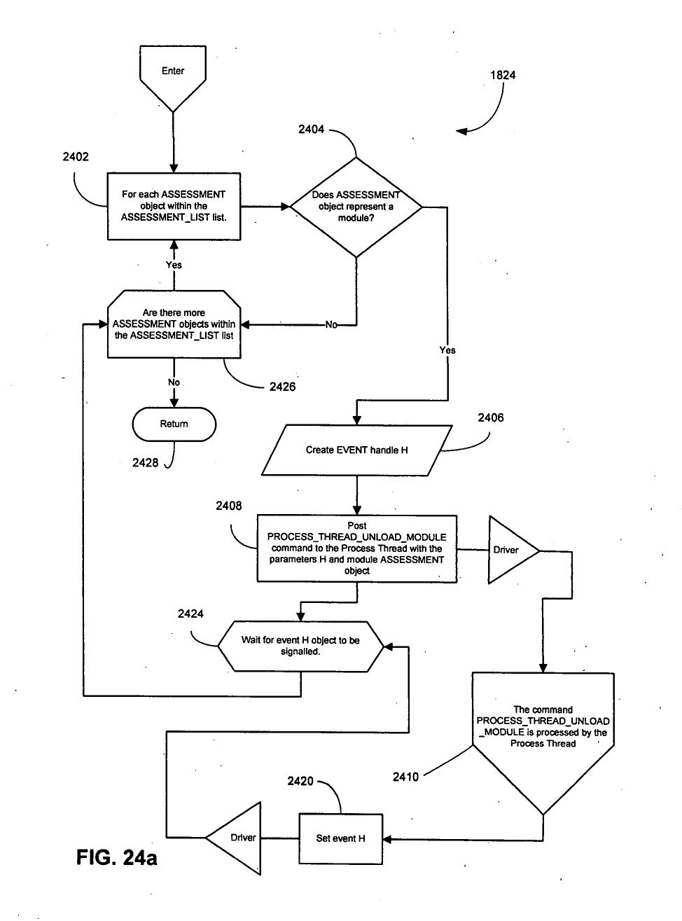

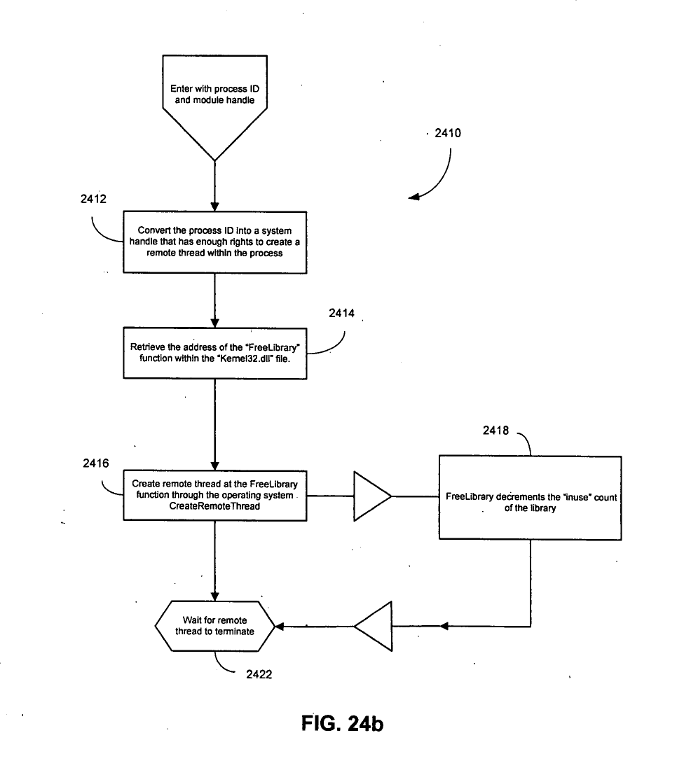

With an appreciation the above, reference is now made to FIGS. 24a & b to describe the operation of unloading modules (1824 in FIG. 18) during the cleaning phase. For each ASSESSMENT object at 2402 a determination is made at 2404 whether it represents a module. If so, an event handle is created at 2406 and a message is posted to the process thread at 2408, with the handle and the module ASSESSMENT object being passed as parameters. This message is processed by the security driver at 2410, which processing is shown in FIG. 24b. At 2412 the ProcID is converted into a system handle with enough rights to create a remote thread within the process. At 2414, the address of the FreeLibrary( ) function within the Kernel32.dll file is retrieved, and at 2416 a remote thread is created at the FreeLibrary( ) function through the operating system function CreateRemoteThread( ). The FreeLibrary( ) function decrements the reference, or “in use”, count of the library at 2418. When the count eventually goes to zero, the module has been removed from memory.

At this point the event handle has been sent at 2420 (FIG. 24a) and the CleanIt application waits at 2422 (FIG. 24b) for the remote thread to terminate. The application waits for the event handle object to be signaled at 2424, after which it is determined at 2426 if there are more ASSESSMENT objects to interrogate. The above logic is repeated until all modules have been assessed, at which point flow returns 2428.

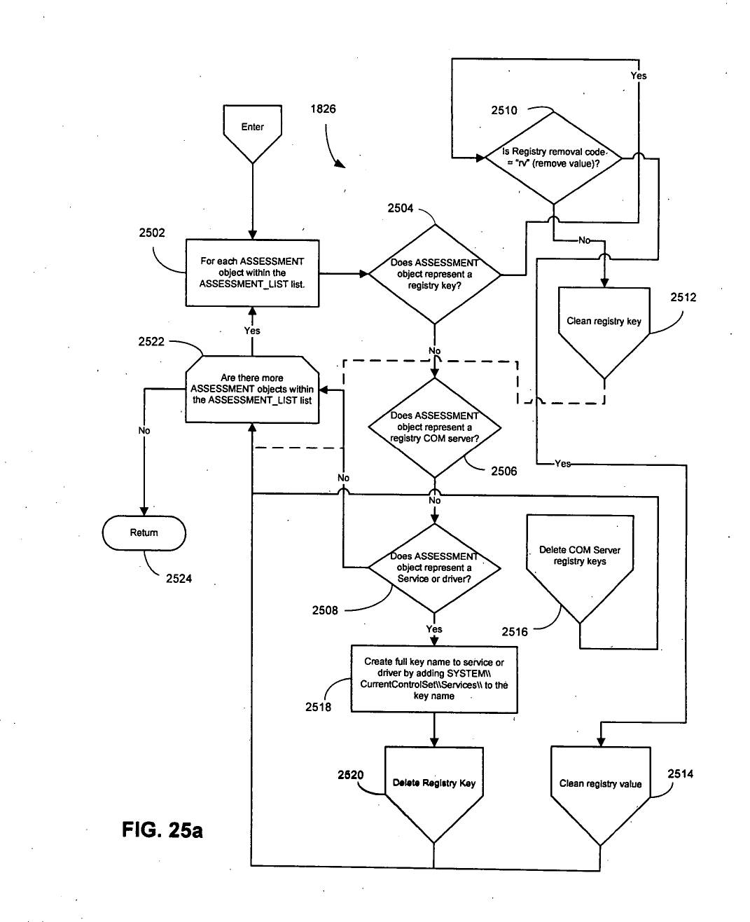

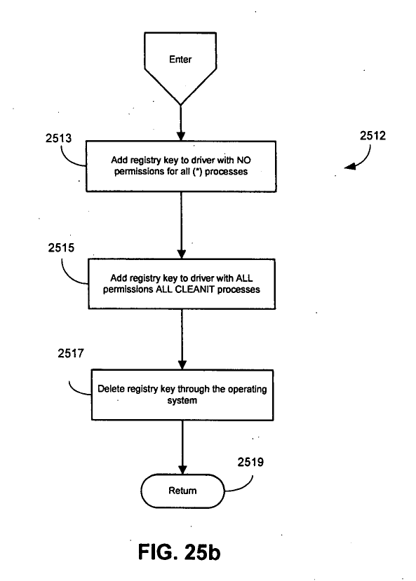

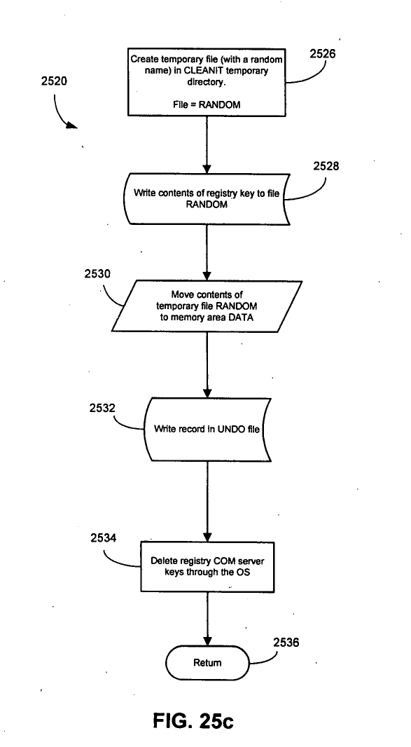

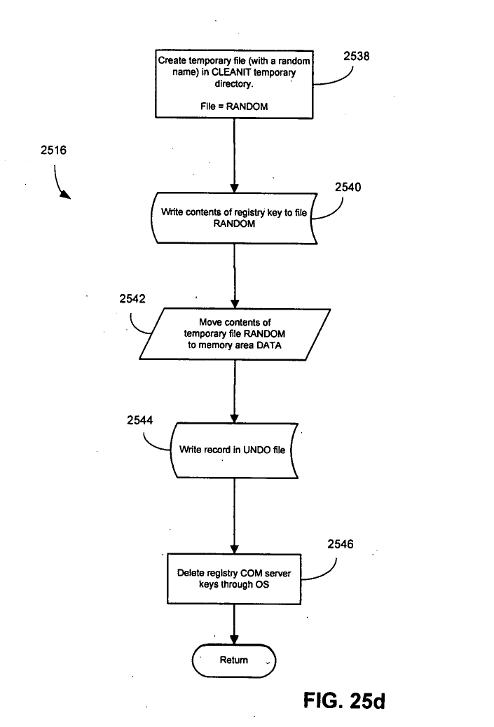

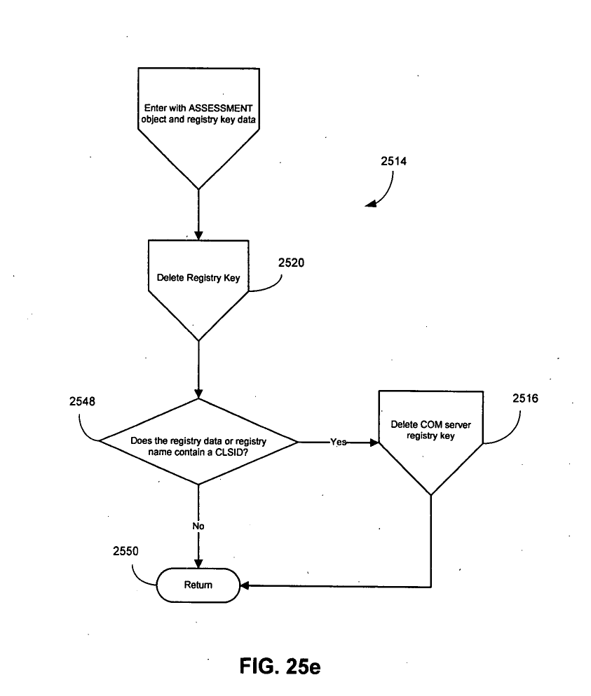

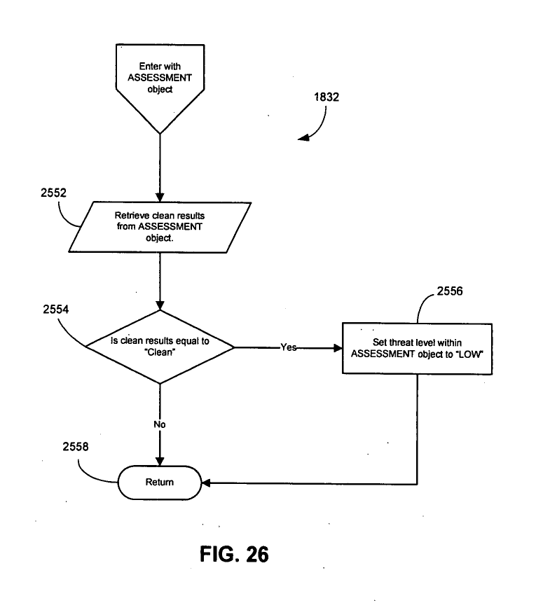

Reference is now made to FIGS. 25a-e to describe the operation of cleaning the registry (1826 in FIG. 18) during the cleaning phase. For each ASSESSMENT object at 2505, determinations are made at 2504, 2506 and 2508, respectively, whether the object represents a registry key, a registry COM server, or a service or driver. If a registry key, a determination is made at 2510 whether the registry removal code equals a remove value (“rv”). If not, then the registry key is cleaned at 2512. If so, the registry value is cleaned at 2514. If the object represents a registry COM server, then COM server registry keys are deleted at 2516. If the object represents a service or driver at 2518, a full key name is created to the service or driver by adding “SYSTEM\\CurrentControlSet\\Services\\” to the key name, after which the registry key is deleted at 2520. Depending on the nature of the ASSESSMENT object, flow will eventually proceed to 2522 to ascertain if there are more objects within the list to assess. Once all objects have been assessed, the registry cleaning procedure returns at 2524.

A procedure for cleaning a registry key 2512 is shown in FIG. 25b. At 2513 the registry key is added to the security driver with no permissions for all processes. It is then added to the driver with all permission for all CleanIt process at 2515. The key is then deleted via the operating system at 2517 before flow returns 2519.

In order to delete a registry key 2520 (FIG. 25c) a temporary file with a random name is created at 2526 in the CleanIt temporary directory. Contents of the registry key are written to this file at 2528 and then moved to an area in memory at 2530. At 2532 a record is written in an UNDO file which preferably contains the following information:

1) Date/Time

2) Registry Key Name

3) Contents of DATA memory area

4) Undo identifier

The UNDO identifier is a sequential number that is stored in the system registry. Each time the number is retrieved, it is automatically incremented. The UNDO ID ensures that undo information can be uniquely tagged. The registry key is then deleted through the operating system at 2534, at which point process 2520 returns 2536. In a similar manner, and with reference to FIG. 25d, deletion of COM server registry keys 2516 involves temporary file creation at 2538, writing of the registry key contents to the temporary file at 2540, moving the file contents to memory area 2542, writing a record in an UNDO file at 2544, and then the deleting the registry COM server keys through the OS 2546. In cleaning a registry value 2514 (FIG. 25e), a registry key is initially deleted 2520 (as discussed above), after which a determination is made and 2548 whether the registry data indicates the registry data or the registry name contain a class ID (CLSID). If so, then flow proceeds to delete the COM server registry key 2516 (as discussed above).

In determining a new threat level (1832 in FIG. 18), clean results are retrieved from the ASSESSMENT object at 2552. Preferably, there is a “list” of results maintained within the ASSESSMENT object, each item in the list representing the results of a different technique used to remove the threat. If each item in the list is marked as “successful” then a “CLEAN” result is obtained for the ASSESSMENT object. Accordingly, an inquiry is made at 2554 to ascertain if the results are clean. If so, the threat level within the ASSESSMENT object is set to “low” at 2556 before returning 2558.

III. Network Implementation

A. Introduction

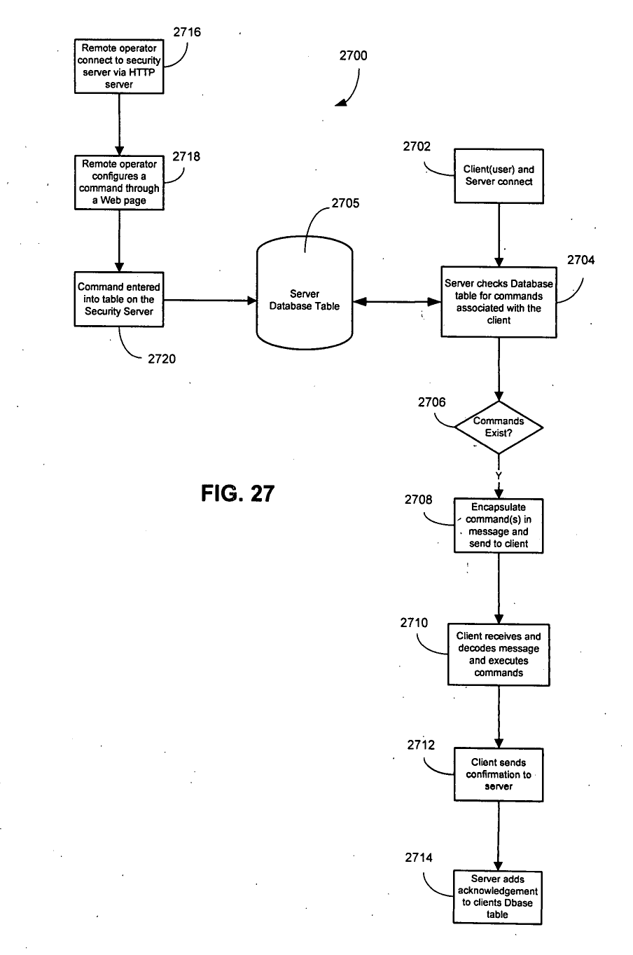

This section details the methods used to remotely control virus (or more broadly, malware) protection, detection and removal. Currently known approaches for managing and enforcing virus protection are exclusively within the domain of a user's local computer. The basic method 2700 according to the present approach is introduced in FIG. 27 as follows. Two computers, a client (at times also referred to herein as a user) computer and a server, connect at 2702. The connection is both physical (i.e., an TCP/IP handshake) and logical (i.e., the user's computer must “sign-in”). The program that is on the client computer is referred to as the “link” program, while the program that is on the server is referred to as the “security server” program. The link program and the security server program communication via TCP/IP. After connection, the security server at 2704 checks a database table 2705 for commands. Commands are verbs that request some action to be performed within the client computer. Commands are sent via messages over the TCP/IP link. If any commands are found within the table at 2706, they are encapsulated into a message and sent to the client computer at 2708. At 2710 the client's link program receives the message and decodes the command. The link program performs whatever action is required by the command after which, at 2712, it minimally sends the equivalent of an “I did it” confirmation response to the security server command. At the security server, the user's link program response is placed within a table at 2714 for future analysis.

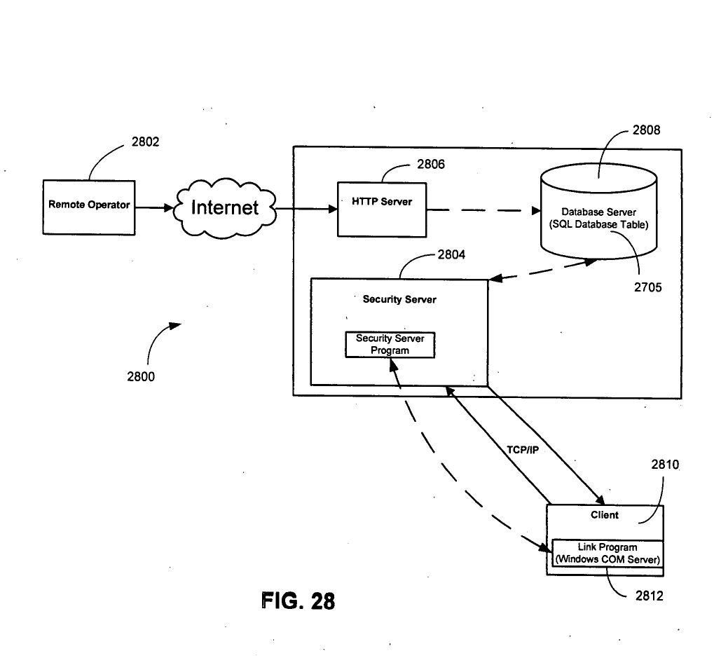

A manager (sometimes referred to as a remote manager, administrator or operator) can configure virus protection, request an action on a client's computer and obtain result data, which enables the remote control. With continued reference to FIG. 27, as well as the representative deployment diagram 2800 of FIG. 28, to configure an instruction within the security server, a remote operator 2802 connects at 2716 to the security server 2804 through an HTTP server 2806. The remote operator at 2718 configures a command through a Web page and then has the command entered into a database table at 2720. The remote operator may connect to the HTTP web server 2806 through a conventional Internet browser. By standard HTML navigation, the operator can access web pages, which allows him/her to do the following: (1) install security software on a client's remote computer; (2) create, modify or delete security profiles or security policies; and (3) perform a security assessment and clean a client computer.

The database table is preferably stored on a database server 2808 that is controlled by security server 2806. Each of the HTTP Web server, the security server and the database server could reside the same physical entity at a common location, or they could reside on different entities at different locations from one another. When a remote client 2810 connects to the security server 2804, the security server checks the table for new commands and, if found, sends the commands to the client's link program 2812, which is preferably a Windows COM server.

Remote control is primarily and preferably accomplished through access to a server database table. This table contains records that specify certain actions to occur for each remote client. In this context, the term “remote” when used to qualify either the client, the operator or the security server, or the HTTP server means that the two components in the system do not reside on the same physical system, regardless of the physical separation between them. Thus, a remote operator or a remote client can be two systems which are located side-by-side, for example on a desk, or in different parts of the world.

Within the server database table is a remote computer (i.e. client) unique identifier (ID). The unique ID is a 128-bit key, and there is one associated with each client computer one the network which communicates with the security server. The method the security server can use to acquire a unique ID for each client computer is through an operating system function call.

Central to the security server's ability to remotely manage are two configuration concepts—policies and profiles. A Security Profile is a short hand method to control many similar computers through a single modification. For example, a Security Profile could be named “Executives” and within the “Executives” profile is all of the security settings appropriate for a company's executives. A Security Policy enforces non-object (i.e., file or directory) security. For example, a security policy defines whether a user may modify the access control (ACL) permissions locally. Thus, a policy is a set of non-object related security rules grouped under the same name, while a profile is a set of object permissions grouped under the same name. Preferably, there are three profiles supported by the security server—ACL, Registry and Port. Each is introduced in the following table. More preferably, the profiles are managed by name and stored within an SQL database table.

| Profile | Description |
|---|---|
| ACL | Contains permissions for volumes, directories and files. |
| Registry | Contains permissions for registry keys and registry key |
| | values. |
| Port | Contains permissions for ports |

The security server keeps track of the last time a profile is modified. Remote clients use this information to calculate whether their local profile is current.

The ACL profile stores permission information relating to volumes, directories and files. The Registry profile stores permission information relating to registry keys and registry values. The Port profile stores permission information relating to ports. Preferably, each remote computer installed within the security server is assigned a single ACL, Registry and Port profile. For example, suppose a manager wishes to protect two files: A.TXT and B.TXT. The manager can place the permissions for A.TXT and B.TXT within the same Profile, say “TEXT FILES”. By grouping the permissions for both A.TXT and B.TXT within the same profile, the manager makes his/her work more efficient.

When a remote client connects to the security server, it checks a local time stamp for each of its profiles. If the time stamp is not the same as reported by the security server, the remote computer enters a process to update its local profiles from the security server.

With the above in mind, information covered under a policy is as follows:

| Type | Name | Description |
|---|---|---|
| CHAR | PolicyName | Name of the Policy. |
| INT | AllowClientACLConfig | A flag indicating whether a user may or may not edit permissions |
| | | stored locally on their computer. |
| CHAR | UpdateClientRule | A rule indicating when a remote computer should be updated. |
| | | A string value indicating when the use's computer is to update its |
| | | security information. This field can have one of these possible |
| | | values: |
| | | “IMMEDIATE” - Indicates the user's computer must be updated |
| | | immediately after a profile has been modified. In order to support |
| | | immediate updates, the user's computer must have established a |
| | | “listen” TCP/IP connection after it performed its initial connection. |
| | | “BOOT” - Indicates the user's computer to update its security |
| | | settings after the computer boots up. |
| | | “DAILY” - Indicates the users computer is update once per day. |
| | | The time it is to update is defined in the “updateClientTime” field |
| | | below. |
| | | “NEVER” - Indicates the user's computer is to never update. |
| TIME | UpdateClientTime | An SQL time structure indicating the time of day a user's computer |
| | | is to perform an update. Used only if “updateClientRule” above is |
| | | set to “DAILY” |
| CHAR | UploadClientLogRule | Defines when local log records are to be moved to the security |
| | | server. See “updateClientRule” above. |
| TIME | UploadClientLogTime | Defines the time when local log records are uploaded to the |
| | | security server. Used only if “updateClientLogRule” is equal to |
| | | “IMMEDIATE”. |
| INT | updateFlag | A boolean value indicating the profile named herein has been |
| | | modified. |

It should be understood that, since in the exemplary embodiment the above structure is contained within an SQL database table, the data types and names adhere to (and are all controlled by) SQL naming conventions. This, however, should not be construed as limiting the disclosure.

Information covered under an ACL profile is preferably as follows:

| Type | Name | Description |
|---|---|---|
| CHAR | UniqueID | A unique 128-bit key identifying this record. The unique key is used |
| | | to identify this record for updating or deletion. |
| CHAR | ProfileName | The Profile name associated with this record. |
| CHAR | FileName | The name of the object - either volume, directory or file. See |
| | | discussion of names below. |
| CHAR | ACLType | Specifies the exact type of object named in the FileName field |
| | | above. |
| CHAR | Access | A string representation of the Access rights associated with the |
| | | FileName. See discussion of the access rights string below. |
| CHAR | ProcessName | The name of the process associated with FileName. See discussion |
| | | of process below. |

Information covered under a Registry profile is preferably as follows:

| Type | Name | Description |
|---|---|---|
| CHAR | UniqueID | A unique 128-bit key identifying this record. The unique key is used |
| | | to identify this record for updating or deletion. |
| CHAR | ProfileName | The Profile name associated with this record. |
| CHAR | KeyName | The name of the registry key associated with the access rights. See |
| | | discussion of names below. |
| CHAR | ValueName | The name of the value key associated with the access rights. See |
| | | discussion of names below. |
| CHAR | Access | A string representation of the Access rights associated with the key |
| | | name. See discussion of the access rights string below. |
| CHAR | ProcessName | The name of the process associated with the key name. See |
| | | discussion of names below. |

Information covered under a Port profile is preferably as follows:

| Type | Name | Description |
|---|---|---|
| CHAR | UniqueID | A unique 128-bit key identifying this record. The unique key is used |
| | | to identify this record for updating or deletion. |
| CHAR | ProfileName | The Profile name associated with this record. |
| CHAR | PortName | The name of the port. |
| CHAR | Access | A string representation of the Access rights associated with the port |
| | | name. See discussion of access rights string below. |
| CHAR | ProcessName | The name of the process associated with the key name. See |
| | | discussion of names below. |

The various names contained within the SQL database (e.g. volume, directory, file, key, value, port and process) can be either fully qualified or unqualified. As known, a fully qualified name specifies the object exactly (e.g., A.TXT), while an unqualified name specifies the object by using the template characters ? or *. As is also known, the ? character matches any single character and the * character matches any set of characters leading up to the next fully qualified character.

The security drivers' lookup tables—VDF (volume, directory, file) and registry—contain filenames that may or may not have template characters ? and *. It is important to note that when a lookup is performed, the most “qualified” name is found first. That is, a name without * or ? that matches exactly will be selected prior to a name with * or ? contained within the lookup. For example, suppose the lookup table contains the two entries with names A.TXT and ?.TXT. A “lookup” for the filename “A.TXT” will return the table entry related to the entry string A.TXT because they match exactly without any * or ? characters within the lookup table entry string. However, a lookup on the name Z.TXT will return the lookup table record related to the lookup string ?.TXT.

The access permissions associated with each name may be encoded as follows: Each access permission flag takes a static character position within the access rights string. For example, the ‘create’ permission, controlling whether the named object can be created, occupies the 1^{st} character position within the string. If the character position within the string contains the character ‘-’, then the permission is denied. If the character position is any other character but ‘-’, the permission is allowed.

The composition of the access right string for files, directories or volume names may be as follows. For files and directories:

| Position | Character Used | Permission |
|---|---|---|
| 1 | C | Create file permission. |
| 2 | O | Open file permission. |
| 3 | D | Delete file permission. |
| 4 | E | Execute file permission. |
| 5 | M | Modify file permission. |
| 6 | R | Rename file permission. |
| 7 | C | Create directory permission. |
| 8 | D | Delete directory permission. |
| 9 | R | Rename directory permission. |

For key names and values:

| Position | Character Used | Permission |
|---|---|---|
| 1 | C | Create registry key permission. |
| 2 | D | Delete registry key permission. |
| 3 | O | Open registry key permission. |
| 4 | M | Modify registry key permission |
| 5 | C | Create registry key value permission. |
| 6 | D | Delete registry key value permission. |
| 7 | M | Modify registry key value permission. |

B. Detail of Remote Control of Virus Protection, Detection and Removal

The remote control of virus protection, detection and removal will now be described. The following explanation of the remote control capabilities is divided into two sections. The first section discusses the actual link between the security server and the link program and how a session is created, while the second section discusses how commands are converted into action within the user's remote computer.

1. Connection

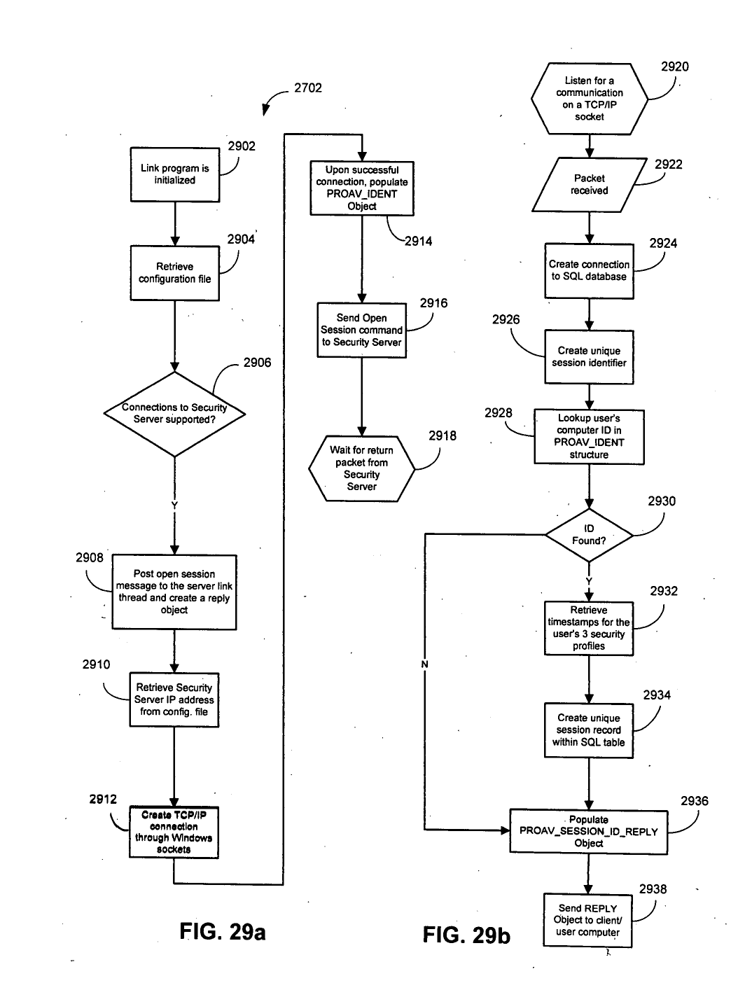

Both the security server and the user's remote computer preferably use TCP/IP to connect. More specifically, under the Windows OS, they use Windows Sockets to connect. It is preferred that the user's remote computer initiate connections with the security server. The user's remote computer uses a saved IP address of the security server to initiate the connection. Once started, the link program interrogates its configuration flags. The flags specify whether to immediately connect with the security server or to connect “only on demand” or to connect at a specific time. The connection process 2702 is more particularly described with reference to FIGS. 29a & b,

a. Client Initialization Process

Turning first to FIG. 29a, the client's link program is initialized at 2902. Since the link program is a Windows COM server program, part of its initialization/boot process is to create a “communication” window. During the create phase of the communication window a function is called to the configuration file 2904 and the “standalone” flag is checked. If this is NOT a standalone product (meaning that connections to the security server are supported at 2906) then an open session message is posted to the server's link thread at 2908 which creates a reply object to store information relating to the connection attempt. Within the reply object is the following data:

| Type | Name | Description |
|---|---|---|
| HRESULT | hResult | Result code from the connection. If this result code is 0, then |
| | | the connection has been established at the security server and |
| | | the remaining values within this structure - logMsg, sessionID, |
| | | installed and clientSecurityInfo - are also valid. |
| CPTR | logMsg | Contains user readable error code indicating why, if there was |
| | | an error at the server, the connection has been denied. |
| TRUSTED_ID | sessionID | Contains the unique 128-bit session key. This key must be |
| | | used for all further communication attempts. |
| BOOL | installed | Indicates whether the user's security information has been |
| | | installed at the security server. If this is FALSE and if the |
| | | product is not a standalone product, then the user's link |
| | | software will request a “Security” installation. |
| CLIENT_SECURITY_INFO | ClientSecurityInfo | See below for details |

At 2910, the IP address of the security server is retrieved from the client's configuration file and a TCP/IP connection is created through Windows sockets at 2912. Assuming a successful connection at 2914, a security server identification object (sometimes referred to as “PROAV_IDENT”) is populated. The data fields contained within the security server identification structure are as follows:

| Type | Name | Description |
|---|---|---|
| TRUSTED_ID | computerID | 128-bit unique ID assigned to |
| | | this installed instance of the |
| | | software. The key is |
| | | generated at the same |
| | | time as the installation |
| | | file for the software is |
| | | generated. |
| DWORD | publicKey | Optional |
| PROAV_LOGIN_INFO | loginInfo | See below |
| CLIENT_IDENT | clientIdent | See below |

The data fields contained within the security server login information structure (PROAV_LOGIN_INFO) are as follows:

| Type | Name | Description |
|---|---|---|
| char | loginID | User's login ID. Optional. (If the manager of the |
| | | security server has configured password |
| | | security, then this field is populated and the |
| | | remote computers' loginID is verified |
| | | during the processing of the CMD_OPEN_SESSION |
| | | command. (note: not detailed in drawings) |
| char | password | User's password. Optional. See loginID above. |

The data fields contained within the client's identification structure (referred to as “CLIENT_IDENT”) are as follows:

| Type | Name | Description |
|---|---|---|
| PROAV_VERSION | version | Product version information. |
| char | computerName | Computer name. The user's network computer name is |
| | | copied to this field. The user's network computer name is |
| | | created when the user 1^{st} installed Windows or 1^{st} |
| | | installed networking support. |
| DWORD | osVersionMajor | Major version of the operating system installed on the |
| | | user's computer. |
| DWORD | osVersionMinor | Minor version of the operating system installed on the |
| | | user's computer. |
| DWORD | OsVersionBuild | Build number of the operating system installed on the |
| | | user's computer. |
| DWORD | osServicePack | Most recent operating system service pack installed on |
| | | the user's computer. |
| char | osName | User readable name of the operating system installed on |
| | | the user's computer (e.g., Windows XP Version |
| | | 5.1.2600) |
| char | OsServicePackStr | User readable name of the most recent service pack |
| | | upgrade. |

At 2916 an open session command is sent to the security server. The function which sends this performs the following tasks: (1) allocates memory for a “packet” that will be sent over the TCP/IP connection; (2) initializes the packet header—and importantly, the command field which contains command instructions; and (3) calls a function which sends the packet through Windows sockets. After the command is sent, the link process waits at 2918 for a return value from the security server. The security server returns the structure PROAV_SESSION_ID_REPLY. Once received, the server link thread on the remote client inspects the return packet from the security server. Specifically, it performs integrity checks on the packet (proper size, header, etc). If the reply code in the packet is 0, then the security server reports no error and the session with the server is established.

The PROAV_SESSION_ID_REPLY structure (below) contains information that pertains specifically to the configuration and management of the anti-virus link source.

| Type | Name | Description |
|---|---|---|
| PROAV_SERVER_REPLY | Reply | Contains reply code from security server. If reply code |
| | | is 0, then no error occurred |
| TRUSTED_ID | SessionID | Contains the 128-bit session key. All further |
| | | transmissions to the security server contains this |
| | | session key |
| DWORD | ClientInstalled | Boolean indicating whether the client is installed. If this |
| | | is FALSE and the user's code is not a standalone |
| | | product, then the user's link process will make a |
| | | request to the security server to be installed. |
| CLIENT_SECURITY_INFO | ClientSecurityInfo | Contains information about the user's security |
| | | configuration. See below for more details. |

The fields within the PROAV_SERVER_REPLY structure as defined as follows:

| Type | Name | Description |
|---|---|---|
| DWORD | errorCode | A numeric error code. If the value of 0 |
| | | represents no error. Any other value |
| | | represents a specific error code. |
| | | Each error code has a unique meaning. |
| char | replyMsg[ ] | A character string representing the error code |
| | | in human readable form. |

The fields within the CLIENT_SECURITY_INFO structure are defined as follows:

| Type | Name | Description |
|---|---|---|
| DWORD | sizeOfStruct | Size of the CLIENT_SECURITY_INFO object in bytes. |
| | | This field allows the program to verify the version of the |
| | | CLIENT_SECURITY_INFO object. |
| char | securityServerURL | TCP/IP (internet) address of the security server. This |
| | | address is in network dotted format (e.g., |
| | | 111.222.333.444) |
| DWORD | securityServerPort | The port address of the security server. The |
| | | securityServerURL address combined with the |
| | | securityServerPort give the complete internet address |
| | | to the security server. |
| char | listenURL | TCP/IP (internet) address of the remote computer. |
| DWORD | listenPort | The port address of the remote computer link software. |
| TRUSTED_ID | computerID | 128-bit unique identifier of the remote computer. |
| CLIENT_INSTALL_INFO | ClientInstallInfo | Optional. (This field is populated if the remote computer |
| | | is not installed). |
| CLIENT_PROFILE_INFO | clientProfileInfo | Information about each security profile - ACL, Registry |
| | | and Port. See below for description. |
| POLICY_INFO | policyInfo | Contains policy data controlling the remote computer. |
| | | See below for description. |

The fields within the CLIENT_PROFILE_INFO structure are defined as follows:

| Type | Name | Description |
|---|---|---|
| PROFILE_INFO | aclProfile | Contains information about the |
| | | ACL profile. |
| PROFILE_INFO | registryProfile | Contains information about |
| | | the Registry profile. |
| PROFILE_INFO | portProfile | Contains information about the |
| | | Port profile. |

The fields within the PROFILE_INFO structure are defined as follows:

| Type | Name | Description |
|---|---|---|
| DWORD | allowClientToModifyACL | Boolean value. If TRUE, the user may modify policy |
| | | permissions locally for their own computer. |
| char | updateClientRule | A string value indicating when the use's computer is to update |
| | | its security information. This field can have one of these |
| | | possible values: |
| | | “IMMEDIATE” - Indicates the user's computer must be |
| | | updated immediately after a profile has been modified. In |
| | | order to support immediate updates, the user's computer must |
| | | have established a “listen” TCP/IP connection after it |
| | | performed its initial connection. |
| | | “BOOT” - Indicates the user's computer to update its security |
| | | settings after the computer boots up. |
| | | “DAILY” - Indicates the users computer is update once per |
| | | day. The time it is to update is defined in the |
| | | “updateClientTime” field below. |
| | | “NEVER” - Indicates the user's computer is to never update. |
| char | updateClientTime | An SQL time structure indicating the time of day a user's |
| | | computer is to perform an update. Used only if |
| | | “updateClientRule” above is set to “DAILY” |
| Char | uploadClientLogRule | Defines when local log records are to be moved to the security |
| | | server. See “updateClientRule” above. |
| char | uploadClientLogTime | See “updateClientTime” above. |
| DWORD | defaultMode | Defines the default security mode flags for a user's computer. |
| | | The default security mode flags are used if a connection to the |
| | | security server cannot be established. See discussion of Mode |
| | | flags below. |
| DWORD | defaultActiveFlags | Defines the default active flags for a user's computer. The |
| | | default active flags are used if a connection to the security |
| | | server cannot be established. (Not Used) |
| char | lastUpdate | An SQL date time value indicating the last time the security |
| | | policy has been modified. |

The mode flag s within the PROFILE_INFO structure indicate security settings for the security driver, which was detailed above in discussing the standalone embodiment. Possible mode flags values are detailed in the table below:

| Flag | Value | Description |
|---|---|---|
| ACL_MODE_NO_CREATE_EXECUTABLES | 0x20 | If ON, no executables are allow to be created |
| ACL_MODE_PROTECT_STD_REGISTRY_KEYS | 0x40 | If ON, standard registry keys are protected from |
| | | modification. |
| ACL_MODE_INTERNET_CREATE_EXECUTABLES | 0x80 | If ON, and if connected to the internet, executable files are |
| | | not allowed to be created. |
| ACL_MODE_INTERNET_FOLDERS | 0x100 | If ON, and if connected to the internet, then no directories |
| | | are allowed to be created. |
| ACL_MODE_INTERNET_ONLY_TEMP_FILES | 0x200 | If ON, and if connected to the internet, then no files may be |
| | | created outside of the internet temporary directory. |
| ACL_MODE_INTERNET_NO_EXEC | 0x400 | If ON, and if connected to the internet, then no programs |
| | | may be executed. |
| ACL_MODE_USE_EXTENSION_LIST | 0x800 | If ON then only files with extensions listed in the extension |
| | | list can be executed. For example, if the file A.BAD is |
| | | executed and if this flag is ON, the A.BAD is only executed |
| | | if the extension “BAD” is contained within the extension list. |

b. Security Server Initialization Process

In FIG. 29b, the security server establishes the ability at 2920 to “listen” to a TCP/IP socket. Should a communication arrive 2922 at the security server, processing proceeds to verify the packet and execute the proper function related to the command contained within the packet. At 2924 a connection is created to the SQL database, as well as a new unique session identifier at 2926. The unique session ID is preferably a 128-bit unique key that is sent back to the client. All further communication between the security server and the client requires this unique session identifier. At 2928 a table lookup is performed on the computer ID contained in the PROAV_IDENT structure (described above). Again, when the software is first installed on a user's computer, the “Setup” program and its associated data files were uniquely stamped with this “computer ID” key. This key is essentially a license key. The computer id can be NULL (all zeros), in which case a unique computer ID has not been assigned for the computer, and the remote computer will be compelled to perform a “security installation”.

If the unique “computer ID” exists within the table at 2930, then the configuration of the three security profiles—ACL, Registry and Ports—is retrieved from the SQL database at 2932. These profiles specify what resources, specific to the user's computer (because of the unique computer ID) are protected. This step 2932 retrieves the last date and time the ACL, Registry and Port profiles were modified. The user's link process will use this modification date to determine whether the security information contained within its computer is up to date.

A unique session record is then created 2934 within the associated SQL data table. At 2936 the PROAV_SESSION_ID_REPLY object is then populated. If the user's computer connected with a NULL computer ID (all zeros), then the response to 2930 will be negative. In such case, the error code contained within the PROAV_SESSION_ID_REPLY object is set to indicate that the client is not installed. This error code indicates that the remote user's computer had a proper packet but there is no computer ID for it. Thus, the only command the remote user's computer is allowed to perform is a “security installation”. In either case, the connection information contained within the PROAV_SESSION_ID_REPLY object is sent to the client at 2938.

2. Commands

This section discusses the different commands that a remote operator (e.g. network administrator or manager) can implement. The following table lists the various commands supported by the security server and implemented by the link process. As will be appreciated from the discussion to follow, most commands are sent from the remote computer to the server. However, there is a group of commands that are sent from the server to the remote computer. For distinction purposes, these commands are referred to as “events” and have the word “EVENT” in the command name (e.g., CMD_EVENT_CLIENT_NOTIFY). In order for events to be active, the remote computer posts a listen request.

| Command | Structures | Description |
|---|---|---|
| CMD_OPEN_SESSION | Sent by Remote: | Opens a session with the security server. The |
| | PROAV_IDENT | security server returns a unique session |
| | Sent by Server: | identifier, which is used to identify the remote |
| | PROAV_SESSION_ID_REPLY | computer in all subsequent communications. |
| CMD_CLOSE_SESSION | Sent by Remote: | Closes a session. |
| | No data | |
| | Sent by Server: | |
| | PROAV_SERVER_REPLY | |
| CMD_INSTALL_CLIENT | Sent by Remote: | Installs a remote computer. This is a logical |
| | PROAV_CLIENT_DATA | installation versus a physical installation. |
| | Sent by Server: | Essentially, a unique computer identifier is |
| | PROAV_CLIENT_DATA_REPLY | created within the security server SQL data |
| | | tables and the security server configures any |
| | | pertinent information required by the remote |
| | | computer. |
| | | After installation, a remote computer can be |
| | | configured for security or cleaned. |
| CMD_DELETE_CLIENT | Sent by Remote: | Removes a remote computer from the security |
| | PROAV_UNIQUE_ID | server SQL data tables. |
| | Sent by Server: | |
| | PROAV_SERVER_REPLY | |
| CMD_GET_FIRST_ACL | Sent by Remote: | Starts the transmission of the ACL list named in |
| | PROFILE_INFO | the PROFILE_INFO object. |
| | Sent by Server: | The ACL list is transferred in “blocks”, with each |
| | PROAV_ACL_DATA_LIST | block containing N number of ACL records. |
| | | If there are more ACL records than can be |
| | | transferred in one block, the remote computer |
| | | sends the CMD_GET_NEXT_ACL command. |
| CMD_GET_NEXT_ACL | Sent by Remote: | Continues the transmission of the ACL list. |
| | PROFILE_ITERATE_NEXT | |
| | Sent by Server: | |
| | PROAV_ACL_DATA_LIST | |
| CMD_GET_FIRST_REGISTRY | Sent by Remote: | Starts the transmission of the Registry |
| | PROFILE_INFO | Permission List named in the PROFILE_INFO |
| | Sent by Server: | object. |
| | PROAV_REGISTRY_DATA_LIST | See related discussion for the command |
| | | CMD_GET_FIRST_ACL. |
| CMD_GET_NEXT_REGISTRY | Sent by Remote: | Continues the transmission of the Registry |
| | PROFILE_ITERATE_NEXT | Permission List |
| | Sent by Server: | See related discussion for the command |
| | PROAV_REGISTRY_DATA_LIST | CMD_GET_NEXT_ACL. |
| CMD_GET_FIRST_PORT | Sent by Remote: | Optional |
| | PROFILE_INFO | |
| | Sent by Server: | |
| | PROAV_PORT_DATA_LIST | |
| CMD_GET_NEXT_PORT | Sent by Remote: | Optional |
| | PROFILE_ITERATE_NEXT | |
| | Sent by Server: | |
| | PROAV_PORT_DATA_LIST | |
| CMD_POST_LOG_RECORDS | Sent by Remote: | Transmits 1 . . . N log records to the security |
| | PROAV_LOG_LIST | server. |
| | Sent by Server: | |
| | PROAV_ITERATE_REPLY | |
| CMD_LISTEN_RQST | Sent by Remote: | Completes the two-way communication channel |
| | PROAV_LISTEN_RQST | between the security server and the remote |
| | Sent by Server: | computer. |
| | PROAV_LISTEN_REPLY | The first channel is created when the remote |
| | | computer establishes a communication channel |
| | | with the security server through TCP/IP. |
| | | This secondary channel allows the security |
| | | server to send commands (EVENTS) to the |
| | | remote computer. |
| CMD_EVENT_CLIENT_NOTIFY | Sent by Remote: | Optional |
| | N/A | |
| | Sent by Server: | |
| | PROAV_CLIENT_NOTIFY | |
| CMD_EVENT_ACL_NOTIFY | Sent by Remote: | Optional |
| | N/A | |
| | Sent by Server: | |
| | PROAV_ACL_NOTIFY | |
| CMD_EVENT_SERVER_SHUTDOWN | Sent by Remote: | Optional |
| | N/A | |
| | Sent by Server: | |
| | PROAV_SERVER_IDENT | |
| CMD_EVENT_SVR_UPDATE_PROFILE | Sent by Remote: | Sent by the security server to a remote computer |
| | N/A | to indicate the profile named in the |
| | Sent by Server: | SVR_UPDATE_PROFILE object has been |
| | SVR_UPDATE_PROFILE | updated. |
| | | The remote computer responds by sending |
| | | either the CMD_GET_FIRST_ACL or |
| | | CMD_GET_FIRST_REGISTRY command. |
| CMD_GET_SECURITY_INFO | Sent by Remote: | Sent by the remote computer to the security |
| | CLIENT_INSTALL | server to retrieve the current date/time stamp for |
| | Sent by Server: | the profiles associated with the remote |
| | PROAV_SESSION_ID_REPLY | computer. |
| CMD_EVENT_ASSESS_THREATS | Sent by Remote: | Sent by the security server to a remote |
| | N/A | computer. The command starts the assessment |
| | Sent by Server: | process (looking for viruses). |
| | PROAV_ASSESS_THREATS_EVENT | |
| CMD_ASSESS_THREATS | Sent by Remote: | Sent by the remote computer to the security |
| | PROAV_ASSESS_THREATS | server to verify the remote computer is to start |
| | Sent by Server: | the virus assessment process. |
| | PROAV_SERVER_REPLY | This command is sent after the command |
| | | CMD_OPEN_SESSION has been processed or |
| | | in response to the security server event |
| | | CMD_EVENT_ASSESS_THREATS. |
| | | The command creates a new SQL record set. |
| | | The new record set will contain the results of the |
| | | assessment. |
| CMD_POST_ASSESSMENT_RESULTS | Sent by Remote: | Sent by the remote computer. Contains the |
| | PROAV_ASSESSMENT_RESULTS | results of the assessment. |
| | Sent by Server: | The results are stored into the new SQL record |
| | PROAV_ASSESSMENT_RESULTS_REPLY | set created during the processing of the |
| | | CMD_ASSESS_THREATS command. |
| CMD_EVENT_CLEAN | Sent by Remote: | Sent by the security server to a remote computer |
| | N/A | to indicate the remote computer is to start the |
| | Sent by Server: | cleaning process. |
| | PROAV_RQST_CLEAN_REPLY | |
| CMD_RQST_CLEAN | Sent by Remote: | Sent by the remote computer to start a cleaning |
| | PROAV_RQST_CLEAN | process. |
| | Sent by Server: | |
| | PROAV_RQST_CLEAN_REPLY | |
| CMD_POST_CLEAN_RESULTS | Sent by Remote: | Sent by the remote computer. Contains the |
| | PROAV_CLEAN_RESULTS | results of the cleaning process. |
| | Sent by Server: | |
| | PROAV_SERVER_REPLY | |

Certain ones of the above commands are described below for explanatory purposes. The implementation of other commands which are not discussed at all (or not in detail) should be readily apparent to the ordinarily skilled artisan. For each command described both the remote user's client side and the security server side are explained.
CMD_INSTALL_CLIENT—Remote Computer
The remote computer sends this command to the security server. It basically starts the formal association between the security server and the remote computer. Along with the CMD_INSTALL_CLIENT command, the remote computer sends the structure CLIENT_INSTALL.

The data fields contained within the CLIENT_INSTALL structure are as follows:

| Type | Name | Description |
|---|---|---|
| CLIENT_IDENT | clientIdent | Defines the human readable name to associate with the |
| | | remote computer. See above for further details |
| TRUSTED_ID | computerID | Contains a 128-bit unique id that identifies the remote |
| | | computer to the security server. |
| | | If the remote computer connects with the security server (i.e., |
| | | starts a valid session through the CMD_OPEN_SESSION |
| | | command) and if trusted_ID is NULL, then the security server |
| | | only allows the remote computer to submit either a |
| | | CMD_END_SESSION command or the |
| | | CMD_INSTALL_CLIENT command. |

The remote computer initiates a session with the security server by sending the CMD_OPEN_SESSION command. The security server replies to the CMD_OPEN_SESSION command by sending back a PROAV_SESSION_ID_REPLY object, which is converted into an OPEN_SESSION_REPLY object. Within the PROAV_SESSION_REPLY object, which is translated to the OPEN_SESSION_REPLY object, is a Boolean value indicating whether the remote computer is installed within the security server. If this value is false, then the remote computer initiates the installation procedure.

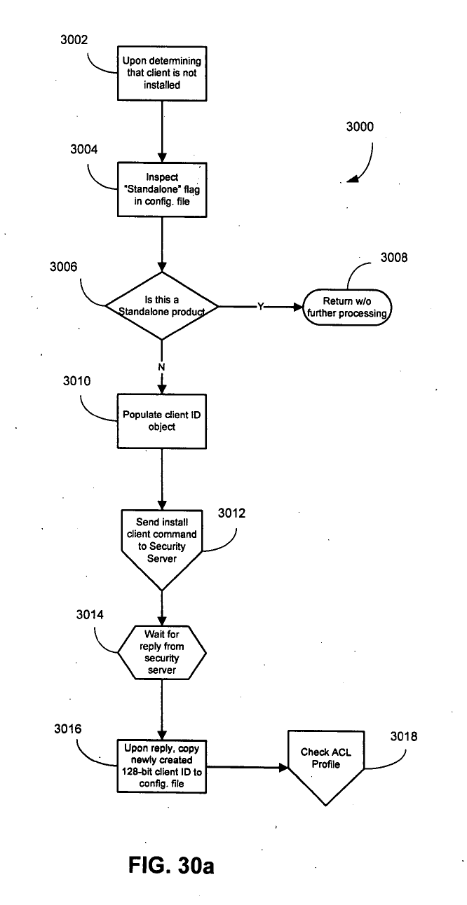

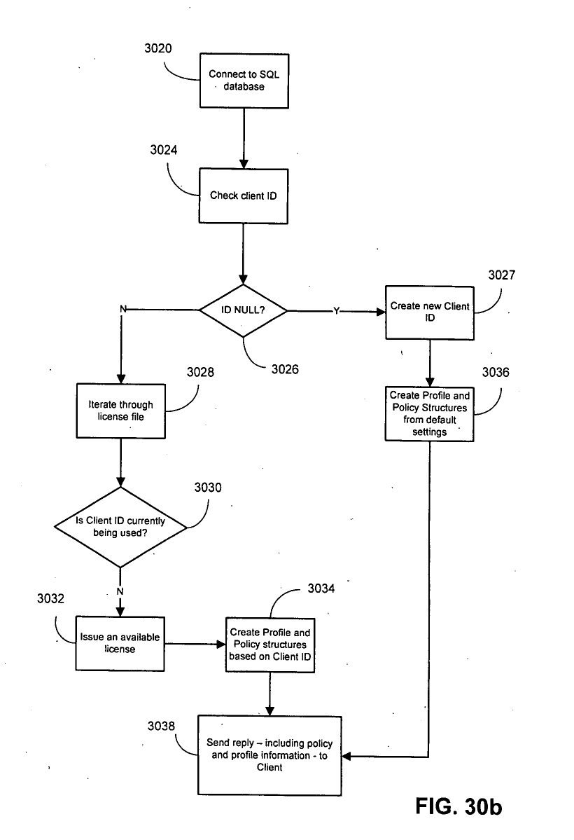

With reference to FIG. 30a, the discussion will begin with the CMD_INSTALL_CLIENT command 3000 at the point 3002 at which a determination has been made that the client is not installed. An inspection is made 3004 of the standalone flag contained in the configuration data file. If the flag indicates at 3006 the product is a standalone product, the function returns 3008 without further processing.

Otherwise, at 3010 a CLIENT_IDENT object is populated and the command CMD_INSTALL_CLIENT is then sent to the security server 3012. At this point processing continues at the security server so the client waits for a reply at 3014 and, upon receipt, it copies the newly created 128-bit computer ID (discussed above) to the configuration file 3016. It then checks the access control (ACL) profile at 3018.

CMD_INSTALL_CLIENT—Security Server

In response to the CMD_INSTALL_CLIENT (3012) command, the security server performs the following actions (FIG. 30b). It connects to the SQL database 3020. It then checks the computer ID contained within the CLIENT_INSTALL object (the “computerID field) at 3024. If this value is NULL (all zeros) 3026, then the function InstallWithoutPreInstall( ) (discussed below) is called to create a new client ID at 3027. Otherwise, a function is called to issue a license, which performs the following tasks. Initially 3028, the security server iterates its license file. Within the license file are N numbers of licenses (128-bit keys), where N is the number of remote computer licenses specified within the security server. Within the license table is a flag indicating whether the license is in use. Assuming it is not used at 3030, the license is flagged as in use and the following information may be returned to the caller once the license is issued at 3032:

| Returned Information | Description |
|---|---|
| Issued to Name | Name of the individual responsible for product |
| | license. |
| Issued to Company | Name of the company holding product license. |
| License Type | A user readable representation of the license. |
| Activation Date | Date licenses created. |
| Expiration Date | License expiration date. |
| License Flags | Flags indicating further refinements to the |
| | license. See below for details. |
| Expiration Value | A numerical value. Use depends on the |
| | presence of individual license flags. |

At this point, 3034, the server creates a client profile by retrieving the ACL, Registry, Port and Policy names associated with the computer ID from the SQL database. If one doesn't exist, then one is create from default settings at 3036, which default setting can be determined by the remote operator had his/her discretion. The server then populates the CLIENT_INSTALL_REPLY object with this information and sends it back to the remote computer at 3038.

The CLIENT_INSTALL_REPLY structure has the following format:

| Type | Name | Description |
|---|---|---|
| PROAV_SERVER_REPLY | reply | Contains any error information if present. If the member errorCode |
| | | value is 0, then no error occurred at the security server. |
| CLIENT_SECURITY_INFO | clientSecurityInfo | Contains current profile information and time stamps. The |
| | | CLIENT_SECURITY_INFO structure is document above. |
| TRUSTED_ID | licenseID | Optional. (For licensed products, this field contains the license ID, |
| | | retrieved from the license file, for the remote computer.) |

CMD_GET_FIRST_ACL—Remote Computer
(also covers CMD_GET_NEXT_ACL, CMD_GET_FIRST_REGISTRY and
CMD_GET_NEXT_REGISTRY)

Because the processing of the CMD_GET_FIRST_ACL command is intertwined with the processing of the CMD_GET_FIRST_REGISTRY and CMD_GET_FIRST_PORT commands, all are now described. These commands comprise a suite of commands that ensure the remote client's local configuration reflects the same configuration as defined in the security server. There are three scenarios that cause the remote computer to issue the CMD_GET_FIRST_ACL command to the security server. The first scenario happens after the remote computer establishes a connection with the security server through the CMD_OPEN_SESSION. The remote checks information returned from the security server to see if the local ACL is out of date. If the local ACL is out of date, then the remote computer requests the current ACL list. The second scenario occurs when the security server sends the event CMD_EVENT_SVR_UPDATE_PROFILE to the remote computer. The third scenario occurs after the CMD_INSTALL_CLIENT command is processed.

### 1st Scenario—CMD_OPEN_SESSION

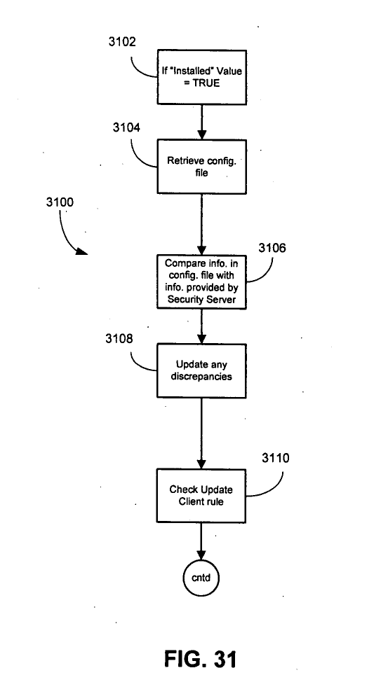

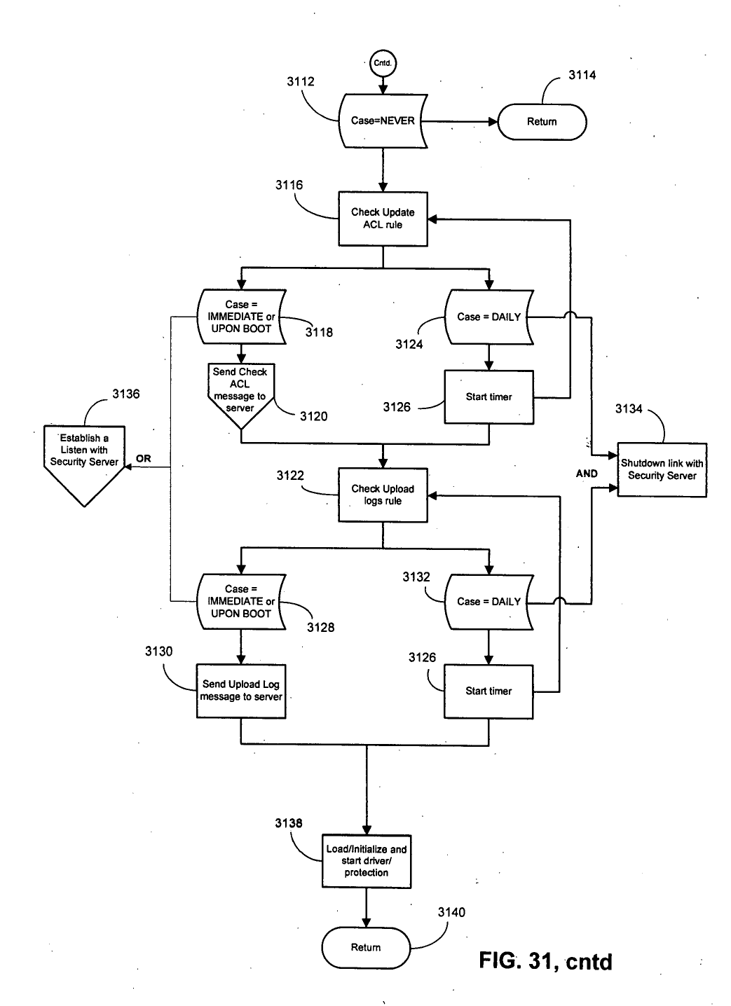

Details of the first scenario 3100 are shown in FIG. 31. If the “installed” value is TRUE at 3102, then the configuration file is updated with data provided by the security server. More particularly, at 3104, the client's local configuration file is retrieved and then compared at 3106 with the following information contained within the configuration file provided by the security server. If any of the following information is different, the new values are saved to the local configuration file 3108.

| Type | Value | Description |
|---|---|---|
| SQL DATETIME | lastUpdate | Last update of the Policy controlling the remote computer. |
| DWORD | listenPort | The listen port is the TCP/IP port that the remote computer uses to |
| | | listen to communications from the security server. |
| DWORD | securityServerPort | The security server port is the TCP/IP port used by the security server |
| | | to communicate with remote computers. |
| char | securityServerURL | The security server URL is the internet address used by the security |
| | | server to communicate with remote computers. |

A check is then made 3110 of the “when to update the client” rule defined in the policy controlling the remote computer. (see POLICY_INFO structure above). If the rule is “NEVER” 3112, then the function returns 3114. Otherwise a comparison is made at 3116 of the “update ACL” rule with either IMMEDIATE or UPON BOOT. If TRUE (3118), then the function posts the message 3120 to the server to check the ACL and then proceeds to the next step 3122. Comparison 3118 also compares the “update ACL” rule with DAILY. If TRUE (3124), it then starts a Windows timer at 3126 to notify the server's HandleMessage( ) function once every 60 seconds. This interval is preferably hard coded and is used to ensure minimal use of system resources.

At 3122 the “upload logs” rule is compared with either IMMEDIATE or UPON BOOT. If TRUE (3128), then a message is posted to the server link thread at 3130 to upload the log. Comparison 3122 also checks the “upload logs” rule with DAILY. If TRUE (3132), it then starts a Windows timer at 3126 as discussed above. If the “update ACL” rule is DAILY and the “upload logs” rule is DAILY, then the link established between the security server and the remote computer is shutdown at 3134. This is because the link will be reestablished at the time the remote computer is configured to perform an update.

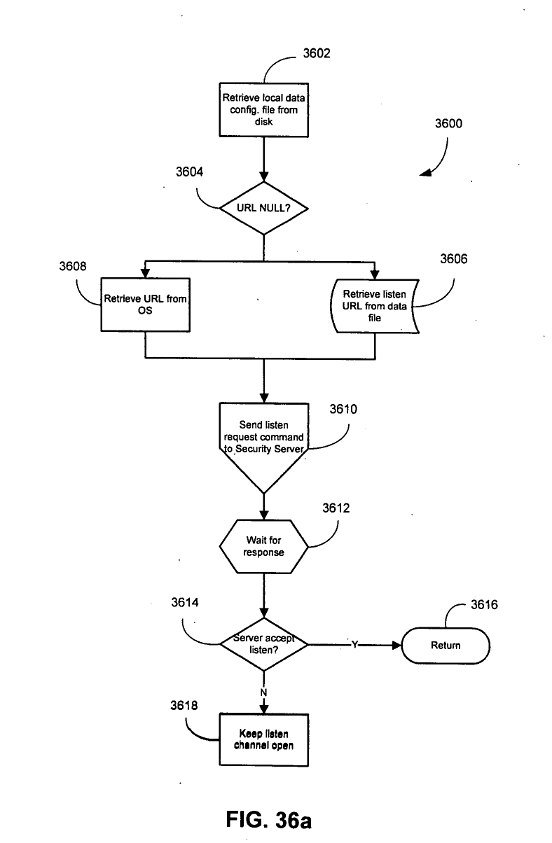

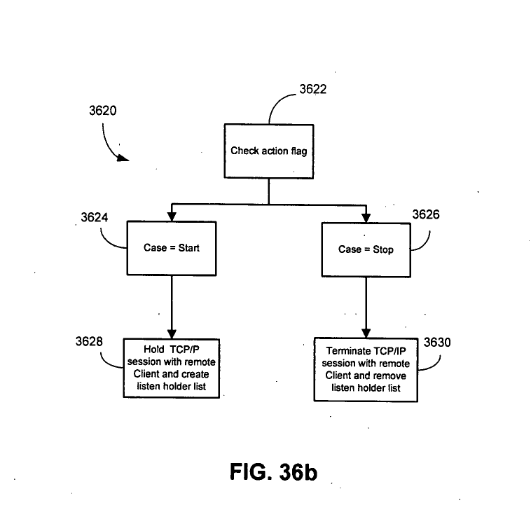

If the “update ACL” rule is IMMEDIATE or the “upload logs” rule is IMMEDIATE, a listen is established between the remote computer and the security server at 3136. (See discussion of the CMD_LISTEN_RQST in FIG. 36 below). Finally, at 3138 driver protection is loaded, initialized and started before returning 3140.

When the timer message discussed above is received by the server, the operating system's current data and time is retrieved. A comparison is then made of the cached values of the profile update time or the log upload time with NULL. If TRUE, the timer is deleted from the OS and flow returns. A comparison is also made of the local time with the client update time as defined in the configuration file (and updated during the CMD_OPEN_SESSION command). If the local time is beyond the profile update time, a message (SLMSG_CHECK_ALL_PROFILES) is posted to the server link thread to check all profiles. A comparison is also made of the local time with the log upload time as defined in the configuration file. If the local time is beyond the upload time, a message (SLMSG_UPLOAD_LOG) is posted to the server link thread to upload the log.

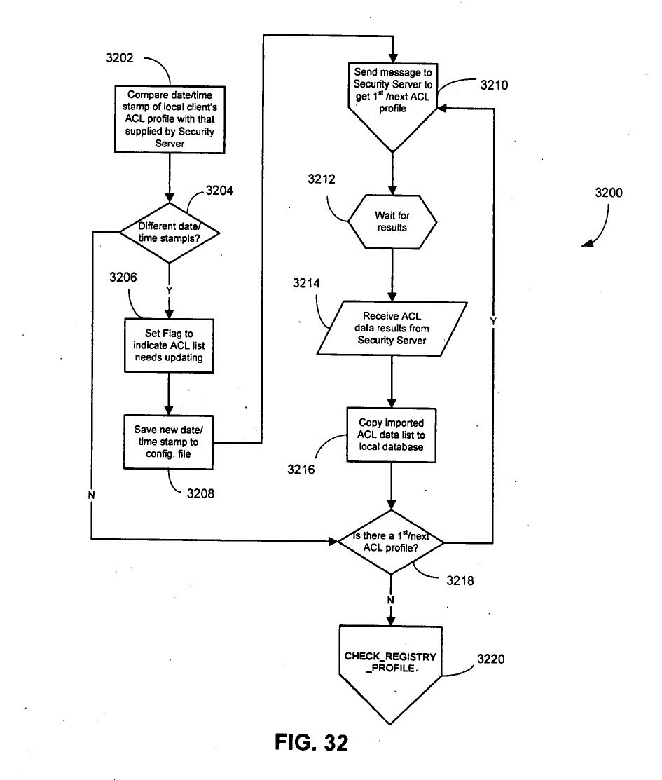

Upon receipt of the message to check all profiles (SLMSG_CHECK_ALL_PROFILES) message, the following logic is performed. A command is sent to the security server to get security information, which is then processed by the security server. The security server sends information back in the form of the PROAV_ID_SESSION_REPLY structure (described above). Then, a message is posted to the server link thread to check the ACL profiles (SLMSG_CHECK_ACL) (see FIG. 32 below).

When the SLMSG_UPLOAD_LOG message is received, a request is made to upload log records, and the message (SLMSG_FEED_LOG_RECORDS) is posted to the security server's window thread. This thread's associated HandleMessage( ) function receives the SLMSG_FEED_LOG_RECORDS message. It then looks at the LPARAM parameter of the message. If this message is not zero, it represents a FeedLogRecords object. If the FeedLogRecords contains a previous FeedLogRecords object, then records that have already been copied to the security server are deleted from the local data store. Log records from the local data store are then copied to a FeedLogData object.

A reply (SLMSG_UPLOAD_LOG_REPLY) is then posted to the server link thread which causes a PROAV_LOG_LIST structure (described below) to be populated so that the log records can then be sent to the server through the CMD_POST_LOG_RECORDS command.

This is repeated until there are no more log records to send, at which point a message (SLMSG_UPLOAD_LOG_COMPLETE) is sent to the server window which processes the message by deleting the last log records and closing any database cursors opened during the upload process.

The data fields contained in the PROAV_LOG_LIST structure are as follows:

| Type | Name | Description |
|---|---|---|
| DWORD | numInThisList | Number of PROAV_LOG_DATA items in the logoata[ ] array |
| | | below. |
| DWORD | reference | A reference number used by the remote computer. This |
| | | number represents the next record number to start the next |
| | | subsequent query for log records. |
| TRUSTED_ID | computerID | The 128-bit unique identifier for the remote computer. |
| PROAV_LOG_DATA | logData[ ] | Array of PROAV_LOG_DATA items. Described below. |

The data fields contained in the PROAV_LOG_DATA structure are as follows:

| Type | Name | Description |
|---|---|---|
| LOG_DATA_DB | logDataDB | Structure containing log data. |
| | | Described below. |
| LOG_KEY_DB | logKeyDB | Structure containing log key data. |
| | | Described below. |

The data fields contained in the LOG_DATA_DB structure are as follows:

| Type | Name | Description |
|---|---|---|
| DWORD | logDataType | Specifies the type of information contained in this log data. |
| DWORD | logAction | Defines the action being logged. |
| DWORD | failurePoint | A source code failure point within the security device driver. |
| | | This allows technicians to pinpoint the actual source code that |
| | | generated the log record. |
| char | username[ ] | The remote computer user. |
| char | fileOrKeyName[ ] | The file or key name corresponding to the log action. |
| char | processName[ ] | The process name corresponding to the log action. |
| DWORD | processeID | The process identifier corresponding to the process name. |
| char | valueName[ ] | The registry value name corresponding to the log action. |
| char | additionalInfo[ ] | Additional debugging information. |
| char | windowTitle[ ] | The window title of the process that created the log action. |
| LOG_UNION | data | Further log details. Described below. |

The data fields contained in the LOG_UNION structure are as follows:

| Type | Name | Description |
|---|---|---|
| VDF_BOTH_DB | vdf | File, directory or volume information. |
| REG_BOTH_DB | reg | Registry information. |

The data fields contained in the VDF_BOTH_DB structure are as follows:

| Type | Name | Description |
|---|---|---|
| VDF_DATA_DB | vdfDataDB | File, directory or volume information |
| VDF_KEY_DB | vdfKeyDB | Structure containing a unique 128-bit |
| | | key for the log record. |

The data fields contained in the VDF_DATA_DB structure are as follows:

| Type | Name | Description |
|---|---|---|
| DWORD | access | Bit field containing the access permissions |
| | | for the file, directory or volume name |
| DWORD | notifyOnViolation | A flag indicating the user/manager is to be |
| | | notified if any access permissions defined |
| | | above are violated. |
| char | uniqueRecordID | A string representation of the 128-bit |
| | | unique record key. |
| char | sqlDateTime | Date/Time of record creation in SQL |
| | | format. |

The data fields contained in the VDF_KEY_DB structure are as follows:

| Type | Name | Description |
|---|---|---|
| DWORD | aclType | Type of data named in field below. |
| char | filename[ ] | File, directory or volume name. |
| char | processName[ ] | Process name. |

The data fields contained in the REG_BOTH_DB structure are as follows:

| Type | Name | Description |
|---|---|---|
| REG_DATA_DB | regDataDB | Contents of the REG_DATA_DB |
| | | structure, described below |
| REG_KEY_DB | regKeyDB | Contents of the REG_KEY_DB |
| | | structure, described below |

The data fields contained in the REG_DATA_DB structure are as follows:

| Type | Name | Description |
|---|---|---|
| DWORD | access | Bit field containing the access permissions |
| | | for the registry key or registry value. |
| DWORD | notifyOnViolation | A flag indicating the user/manager is to |
| | | be notified if any access permissions |
| | | defined above are violated. |
| char | uniqueRecordID | A string representation of the 128-bit |
| | | unique record key. |
| char | sqlDateTime | Date/Time of record creation in SQL |
| | | format. |

The data fields contained in the REG_KEY_DB structure are as follows:

| Type | Name | Description |
|---|---|---|
| Char | keyName[ ] | Name of registry key. |
| Char | valueName[ ] | Name of registry key value. |
| Char | processName[ ] | Name of process. |

The possible values for logAction field within the LOG_DATA_DB structure are as follows:

| Value | Meaning |
|---|---|
| LOG_CREATE_FILE | Process attempted to create a file |
| LOG_OPEN_FILE | Process attempted to open a file. |
| LOG_DELETE_FILE | Process attempted to delete a file. |
| LOG_MODIFY_FILE | Process attempted to change the contents of a file. |
| LOG_EXEC_FILE | Process attempted to execute another process. |
| LOG_RENAME_FILE | Process attempted to rename a file. |
| LOG_CREATE_DIRECTORY | Process attempted to create a directory. |
| LOG_DELETE_DIRECTORY | Process attempted to delete a directory. |
| LOG_RENAME_DIRECTORY | Process attempted to rename a directory. |
| LOG_CREATE_REGISTRY | Process attempted to create a registry key. |
| LOG_DELETE_REGISTRY | Process attempted to delete a registry key. |
| LOG_OPEN_REGISTRY | Process attempted to open a registry key. |
| LOG_CREATE_REGISTRY_VALUE | Process attempted to create a registry key value. |
| LOG_DELETE_REGISTRY_VALUE | Process attempted to delete a registry key value. |
| LOG_MODIFY_REGISTRY_VALUE | Process attempted to modify a registry key value. |

Details 3200 of the check ACL function, which is called in response to the message (SLMSG_CHECK_ACL) are now discussed with reference to FIG. 32. Initially, the status of the ACL profile is checked by comparing at 3202 the date/time stamp of the local profile information with the date/time stamp of the profile information supplied by the security server. If the date/time stamps are different at 3204 then a flag is set at 3206 to indicate that the ACL list requires updating, and a new date/time stamp is saved to the local configuration file at 3208. A command (CMD_GET_FIRST_ACL) is then sent to the security server at 3210 to obtain first ACL profile. At this point in time, processing continues at the security server as it handles the CMD_GET_FIRST_ACL command and, thus, the client waits for results at 3212.

Upon receipt of results from the security server at 3214, whereby the information is returned in the structure PROAV_ACL_DATA_LIST (detailed below), the client copies data from the PROAV_ACL_DATA_LIST structure to the local database (such as the open source Berkeley db product) at 3216. Preferably, it does this by creating a VDF_DATA object and then posting the command PROAV_MSG_ADD_VDF and the object to its server window thread. The processing of the PROAV_MSG_ADD_VDF message is described below.

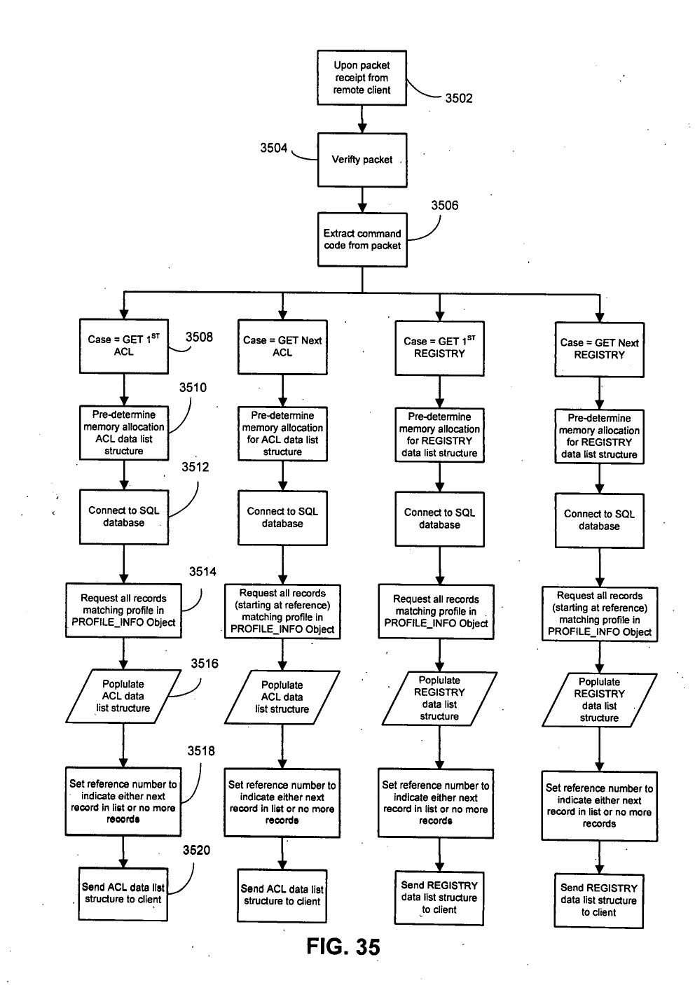

A loop is then entered at 3218 to get the next ACL profile until either an error occurs or the security server indicates there are no more records to send. If there are more records, then when client enters a function to obtain the next ACL profile, it sets the current reference value into the structure PROFILE_ITERATE_NEXT (detailed below). It then sends the command (CMD_GET_NEXT_ACL) and the PROFILE_ITERATE_NEXT object to the security server at 3210. At this point 3212 processing continues at the security server as it handles the command CMD_GET_NEXT_ACL (FIG. 35), and so the client enters waiting mode. When the results of the CMD_GET_NEXT_ACL are received from the security server at 3214, information is returned in the structure PROAV_ACL_DATA_LIST. It can be seen in FIG. 32 that the loop starting at 3218 can also be accessed directly if the date/time stamps are not empty in response to inquiry 3204 above.

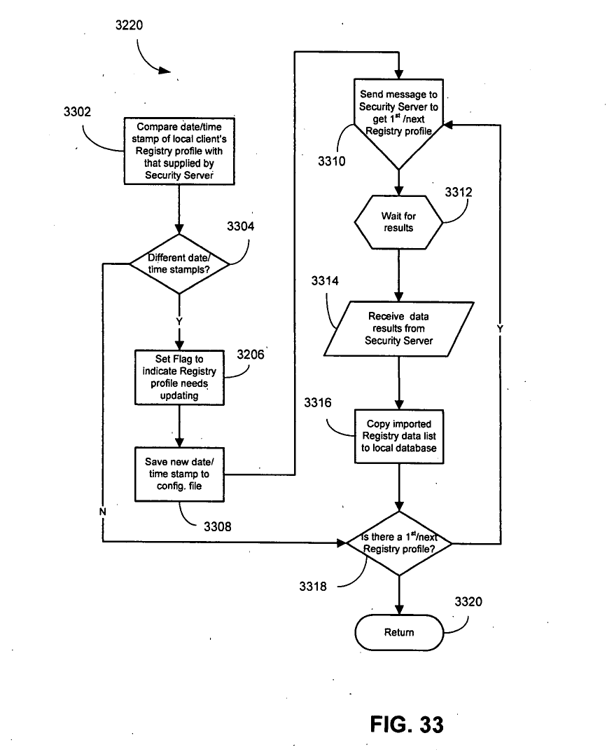

At 3220 the registry profile is then checked. With reference to FIG. 33, this involves initially comparing at 3302 date/time stamp of the client's registry profile with that supplied by the security server. If different at 3304, a flag is set 3306 indicating the registry profile requires updating, and a new date/time stamp is saved to the local configuration file at 3308.

A function is then called to retrieve the registry profile, which function sends the command CMD_GET_FIRST_REGISTRY to the security server at 3310. At this point processing continues at the security server as it handles the CMD_GET_FIRST_REGISTRY command, so the client waits 3312. Upon receipt 3314 of resultant data from the security server data contained in the object PROAV_REGISTRY_DATA_LIST (detailed below) the received data is imported at 3316 from the PROAV_REGISTRY_DATA_LIST to a REGISTRY_DATA object. The REGISTRY_DATA object is posted to the server window thread with the message PROAV_MSG_ADD_REGISTRY. When the server window thread receives the PROAV_MSG_ADD_REGISTRY message, it adds the contents of the REGISTRY_DATA object to the local database.

The loop terminates if there is an error or when all records contained in the PROAV_REGISTRY_DATA_LIST object are copied and sent to the server window thread. Loop 3318 is again entered at whereby a function is called to get the next registry profile. This loop 3318 eventually terminates 3320 if there is an error or when the reference flag indicates there are no more records.

The fields contained in the PROAV_ACL_DATA_LIST structure are defined as follows:

| Type | Name | Description |
|---|---|---|
| PROAV_ITERATE_REPLY | iterateReply | Contains reply information. See below for details. |
| DWORD | sizeOfProAVACLData | Contains the size of the PROAV_ACL_DATA object |
| | | in bytes. This field is used as an integrity check. This |
| | | ensures future versions of the remote and security |
| | | server programs agree on the size of the |
| | | PROAV_ACL_DATA object. |
| PROAV_ACL_DATA | aclData | Array of ACL_PROAV_DATA objects. The size of |
| | | the array is stored in the PROAV_ITERATE_REPLY |
| | | object. The structure of the ACL_PROAV_DATA |
| | | object is described below. |

The fields contained in the PROAV_ITERATE_REPLY structure are as follows:

| Type | Name | Description |
|---|---|---|
| PROAV_SERVER_REPLY | reply | Contains security server reply code. The reply code |
| | | is a number. If the number is 0, then the reply code |
| | | indicates no error exists. If the number is anything |
| | | other than 0 it represents an error. The number itself |
| | | defines the exact type of error. Error values are |
| | | listed in WindDWs operating system code header |
| | | winerror.h. |
| | | The reply structure also contains user readable error |
| | | information. |
| DWORD | numInThisList | Contains the number of items in the associated |
| | | array. |
| DWORD | reference | A status value set and managed by the security |
| | | server. The security server places the next record |
| | | number to be retrieved in the reference value. |
| | | The remote computer must not modify this value. It |
| | | just passes the value back to the security server |
| | | upon the next iterate call (e.g., |
| | | CMD_GET_NEXT_ACL or |
| | | CMD_GET_NEXT_REGISTRY) |
| | | If the reference value is equal to −1, then there are |
| | | no more records to retrieve. |

The fields contained in the PROAV_ACL_DATA structure are as follows:

| Type | Name | Description |
|---|---|---|
| DWORD | aclType | Specifies the type of object defined within this |
| | | structure. |
| DWORD | access | Access flags. Each bit within the access flag |
| | | specifies a specific permission. |
| char | name | Name of object. How the name is formatted |
| | | and interpreted depends on the ACL |
| | | type value. |
| char | processName | Name of process associated with the |
| | | permissions. If the process name is defined |
| | | as ‘*’, then all processes acquire said |
| | | permissions. |

The fields contained in the PROAV_REGISTRY_DATA_LIST structure are as follows:

| Type | Name | Description |
|---|---|---|
| PROAV_ITERATE_REPLY | iterateReply | Contains reply information. See above for details. |
| DWORD | sizeOfRegistryData | Contains the size of the PROAV_REGISTRY_DATA |
| | | object in bytes. This field is used as an integrity |
| | | check. This ensures future versions of the remote |
| | | and security server programs agree on the size of |
| | | the PROAV_REGISTRY_DATA object. |
| PROAV_REGISTRY_DATA | registryData | Array of PROAV_REGISTRY_DATA objects. The |
| | | number of items in the array is contained in the |
| | | PROAV_ITERATE_REPLY object, which is defined |
| | | above. |

The fields contained in the PROFILE_ITERATE_NEXT structure are as follows:

| Type | Name | Description |
|---|---|---|
| PROFILE_INFO | ProfileInfo | Contents of the |
| | | PROFILE_INFO |
| | | structure, described |
| | | above. |
| PROAV_ITERATE_NEXT | Iterate | Contents of the |
| | | PROAV_ITERATE_NEXT |
| | | structure, described below. |

The fields contained in the PROAV_ITERATE_NEXT structure are as follows:

| Type | Name | Description |
|---|---|---|
| DWORD | reference | A number indicating the next record number to |
| | | retrieve from the database. If the value is −1, |
| | | then no more records are available or are |
| | | to be retrieved. |

### 2nd Scenario—CMD_EVENT_SVR_UPDATE_PROFILE

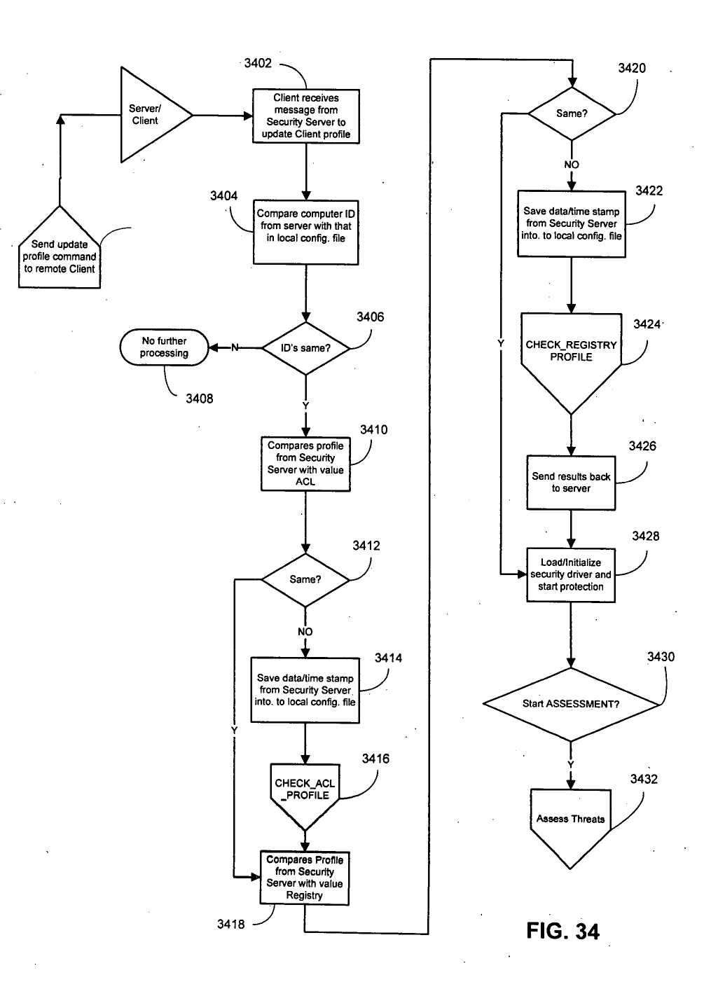

The generation of the CMD_EVENT_SVR_UPDATE_PROFILE command by the security server will now be described with reference to FIG. 34. This second scenario 3400 begins at 3402 when the server link thread's packet handler receives the CMD_EVENT_SVR_UPDATE_PROFILE command. That is, a profile can be updated when the remote computer starts a session, or whenever a “timer” goes off (the remote then calls the server), or when the server has an updated profile for the client. Regardless of the case, the same base code is invoked, which iterates the “GET FIRST”, “GET NEXT” messages to receive the profile data. The profile data is then stored in a local database and then used to configure the security driver.

As shown, this command can be received from either the server or the client in response an update profile command sent to the client. The SVR_UPDATE_PROFILE object (described below) is copied and a message (SLMSG_UPDATE_PROFILE) is posted to the server link thread. Upon receipt of this message, a comparison is made at 3404 of the computer ID found in the SVR_UPDATE_PROFILE structure with that found in the local configuration file. If the IDs are not the same at 3406, no further processing occurs 3408. If they are the same a comparison is made at 3410 of the profile defined in the SVR_UPDATE_PROFILE structure with the value “ACL”. If the values are not the same at 3412, then the date/time stamp value within the SVR_UPDATE_PROFILE structure is saved to the configuration file at 3414 and a function is called at 3416 to obtain the ACL profile. This function was discussed above in FIG. 32.

After this, or in the event that the response to inquiry 3412 is in the affirmative, a comparison 3418 is made of the profile defined in the SVR_UPDATE_PROFILE structure with the value “Registry”. If the values are not equal at 3420, then the date/time stamp value within the SVR_UPDATE_PROFILE structure is saved to the configuration file at 3422 and a function is called at 3424 to check the registry profile. This function was discussed with reference to FIGS. 32 & 33. Thereafter, results are sent back to the security server at 3426 and the security driver is loaded and initialized at 3428 to start protection. If it is desired then an assessment is performed 3430, as discussed above in the standalone implementation. It can be seen in FIG. 34 that flow also proceeds directly to 3428 if the profile defined in the SVR_UPDATE_PROFILE structure is the same as that with the value “Registry”.

The fields contained in the SVR_UPDATE_PROFILE structure are as follows:

| Type | Name | Description |
|---|---|---|
| TRUSTED_ID | trustedID | 128-bit unique identifier for the |
| | | remote computer. |
| CHAR[8] | profileType | A string name for the profile |
| | | type - e.g., “VDF”, |
| | | “REGISTRY” or “PORT” |
| PROFILE_INFO | profileInfo | Contents of the |
| | | PROFILE_INFO structure, |
| | | described above. |

### 3rd Scenario—CMD_INSTALL_CLIENT

The third scenario begins at the conclusion of the step 3018 discuss above in FIG. 30. After the function returns, the message SLMSG_INSTALL_CLIENT_REPLY is posted to the server window thread which in turn checks the return value contained within the INSTALL_CLIENT_REPLY object. The INSTALL_CLIENT_REPLY (described above) is an object that holds the CLIENT_INSTALL_REPLY object as produced by the security server and an internal log message so the install process can be logged to a text file. If the return value is not 0 (meaning there is an error), the connection to the security server is terminated and permissions are configured based on locally stored values. If the security server successfully installed the client processing continues at step 3108.

CMD_GET_FIRST_ACL—Security Server

As shown in FIG. 35, the security server processes the CMD_GET_FIRST_ACL command (referred to above in FIG. 32) by receiving a packet from the remote computer at 3502. The packet is first verified 3504 and then deconstructed at 3506 to isolate the command code. The data structure PROFILE_INFO, described above, is isolated from the packet and then, based on the command code contained in the packet, a suitable function is called, in this case (3508), one for obtaining the first ACL. At this point, memory is allocated 3510 for the PROAV_ACL_DATA_LIST object. The amount of memory allocated is predetermined—which happens to be the largest TCP/IP block size allowed by the security server minus the size of a packet header. This value is a constant and can be determined by testing.

Given the maximum size of data that can be transferred in one block, a calculation is performed to determine the number of PROAV_ACL_DATA records that can be stored in the ACL data list. At 3512 a connection is made to the SQL database and all records from the database are requested 3514 (starting with the 1^{st}) with the security profile name found in the PROFILE_INFO object. The PROAV_ACL_DATA_LIST structure is populated at 3516 with information gathered from the SQL database. The ACL profile used in the SQL SELECT statement comes from the remote PROFILE_INFO data sent to the security server. Then, at 3518, the reference indicator in the return PROAV_ACL_DATA_LIST object is set to either indicate the reference for the next record in the list or a −1 to indicate there are no more records. This decision is based on whether a maximum number of records have been placed into the PROAV_ACL_DATA_LIST object (the maximum value described above). Thus, if the maximum number of records is X and if the PROAV_ACL_DATA_LIST contains X records, then the reference indicator is set to X+1. Finally, at 3520, the PROAV_ACL_DATA_LIST data is sent back to the client.

CMD_GET_NEXT_ACL; CMD_GET_FIRST_REGISTRY; CMD_GET_NEXT_REGISTRY

As can be appreciated in FIG. 35, similar logic is implemented by the security server in response to the commands, CMD_GET_NEXT_ACL, CMD_GET_FIRST_REGISTRY and CMD_GET_NEXT_REGISTRY such that they need not be discussed any further for an adequate understanding of them.

CMD_LISTEN_RQST—Remote Client

The CMD_LISTEN_RQST supports the ability of a manager to ensure any changes made to a security profile get immediately reflected to the remote computers. Because there is a two-way channel open, the security server can post an event to the remote computers after changes to a profile have been saved. The CMD_LISTEN_RQST starts the process of creating the two-way channel. The command is initiated from the remote computer and sent to the security server.

The basic process of issuing the CMD_LISTEN_RQST is now described. Once a connection is made to security server through the CMD_OPEN_SESSION command, if necessary, local profile information is updated with data acquired from the security server. An inspection is then made of the local profile information for the “update” rules. If any rule is “IMMEDATE”, then a two-way communication channel is created. After the remote computer has connected to the security server, a comparison is made of the local profile information with the profile information sent by the security server in response to the a CMD_OPEN_SESSION command or a CMD_EVENT_CLIENT_NOTIFY command.

The detail of the CMD_LISTEN_RQST (3600 in FIG. 36a) starts by comparing the update rule for the ACL lists (ACL, Registry and Port) and the update rule for uploading log files to the server with the value “IMMEDIATE”. If the comparison is TRUE, then the command SLMSG_START_LISTEN is posted to the server link thread which retrieves at 3602 the local configuration data file from the disk. The listen URL is retrieved from the configuration data file at 3606. This listen URL is the TCP/IP address of the local computer in dotted notation (e.g., 111.222.333.444). If the listen URL value retrieved from the configuration data file is NULL (all zeros) at 3604 then the local TCP/IP address is retrieved from the operating system at 3608—in this case, from the Windows version of sockets( ).

At 3610 a listen request command (CMD_LISTEN_RQST) is sent to the security server with the data PROAV_LISTEN_RQST object (described below). At this point 3612 the security server process the command so the client waits 3612 for the server to accept the listen request 3614. When the server accepts the listen request, it returns a PROAV_LISTEN_REPLY object and flow returns 3616; otherwise, the client keeps a listening channel open 3618.

The data fields contained in the PROAV_LISTEN_RQST structure are as follows:

| Type | Name | Description |
|---|---|---|
| DWORD | action | A numeric request code. The code can assume the following values: |
| | | PROAV_LISTEN_START - Creates a two-way listen channel. |
| | | PROAV_LISTEN_STOP - Deletes a current two-way listen channel. |
| char | listenerIPAddress | TCP/IP address of the remote computer in dotted notation (e.g., |
| | | 111.222.333.444). |
| | | The security server uses its available “sockets” library to connect to |
| | | this address. The remote computer places a “listen” on this address. |
| DWORD | portAddress | Port address of the TCP/IP address. TCP/IP address typically goes to |
| | | port 20 hex unless directed to a different port. The combination of the |
| | | listenerIPAddress and the portAddress give a complete address to the |
| | | remote computer. |

The data fields contained in the PROAV_LISTEN_REPLY structure are as follows:

| Type | Name | Description |
|---|---|---|
| PROAV_SERVER_REPLY | serverReply | Object containing reply |
| | | code and message. |
| | | Described above. |
| PROAV_SERVER_IDENT | serverIdent | Identifies the security |
| | | server name and |
| | | version. Described below. |

The data fields contained in the PROAV_SERVER_IDENT structure are as follows:

| Type | Name | Description |
|---|---|---|
| char | serverName[80] | The server name in human |
| | | readable form. |
| PROAV_VERSION | proAVVersion | Server version. |
| | | Described below. |

The data fields contained in the PROAV_VERSION structure are as follows:

| Type | Name | Description |
|---|---|---|
| DWORD | majorVersion | The major version of software. |
| DWORD | minorVersion | The minor version of software. |
| DWORD | revisionNumber | The software revision number. Used |
| | | for different build configurations. |
| | | For example, a build configuration |
| | | might eliminate any encryption |
| | | components, which may not be exported. |
| DWORD | buildNumber | A sequential number representing the |
| | | number of times the product |
| | | has undergone compilation. |
| char | buildDate | The last build date. |

CMD_LISTEN_RQST—Security Server

If a remote operator specifies that any changes to a profile must be immediately reflected to remote computers, a remote computer upon connection will send the CMD_LISTEN_RQST command to the security server. The details of the security server processing the CMD_LISTEN_RQST command are shown at 3620 in FIG. 36b. The server receives the CMD_LISTEN_RQST command and its associated PROAV_LISTEN_RQST object and at 3622 inspects the action flag contained within the PROAV_LISTEN_RQST object. If the action flag is PROAV_LISTEN_START (3624) then the security server's GUI thread's listening function is called. If the action flag is PROAV_LISTEN_STOP (3626) then the GUI thread's delete listening function is called. The GUI thread's listening function creates a broadcast events thread object at 3628 to hold a TCP/IP session handle with the client. The creation and management of the TCP/IP handle is through standard Windows “sockets” functions and will not be detailed further. A listen holder object is created for containing the instance of the BroadcastEventsThread object and other management information. The purpose of this object is to be able to support the PROAV_LISTEN_STOP action request. The listen holder object is placed into the listen holder list. The GUI thread's delete listening function destroys the TCP/IP connection associated between the remote computer and the security server at 3630, and removes the listen holder object from the listen holder list.

CMD_EVENT_SVR_UPDATE_PROFILE—Security Server

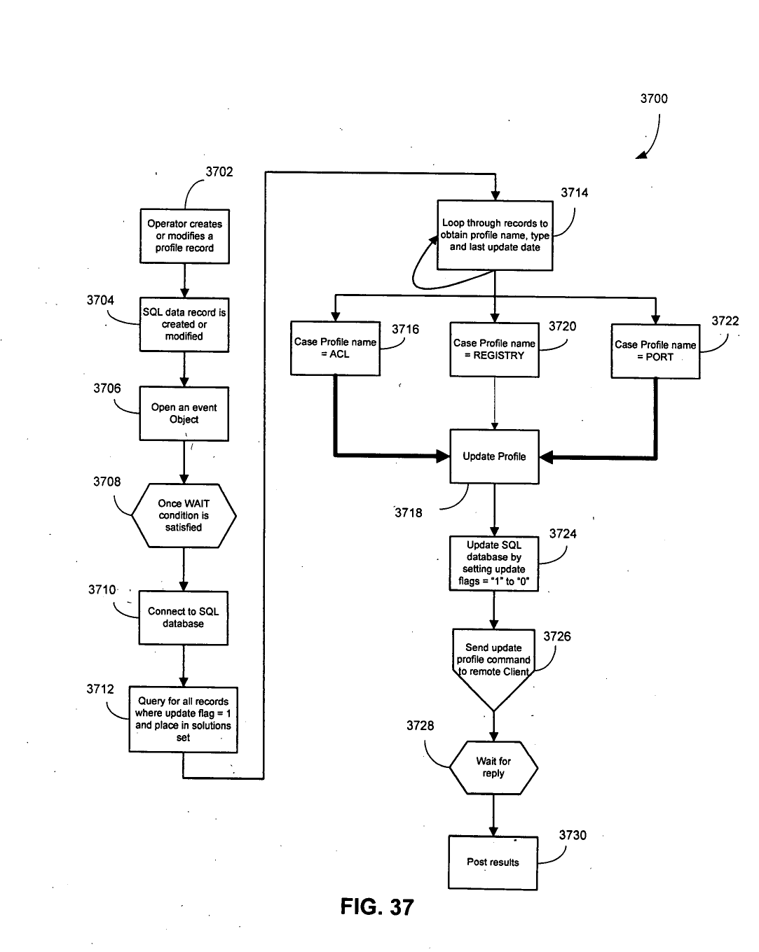

The security server sends the CMD_EVENT_SERVER_UPDATE_PROFILE command to remote computers that have established a listen channel through the CMD_LISTEN_RQST command. This command is generated through the process 3700 as shown in FIG. 37. A remote operator/manager creates or modifies an ACL, Registry or Port profile record at 3702. The modification is preferably performed through HTML code. The modified HTML code is sent from the manager's computer to the HTTP server. The HTTP server runs a CGI program, referred to herein as “ProAVSaveProfile”, that saves the managers input.

The ProAVSaveProfile program processes the HTML code and either creates or modifies the SQL data record pertaining to the modified profile at 3704, after which it opens a Windows event object 3706 having an associated handle name. As well known, Windows events are objects managed by the Window operating system that allows separate processes to synchronize and or communicate. When two or more processes hold an event process, they can be “signaled”.

The process ProAVSaveProfile raises the event opened above. Within the security server process, there is a “wait” condition set for the handle. When the process ProAVSaveProfile raises the event, the wait condition within the security server is satisfied at 3708 and processing continues. In response to satisfying the wait condition for the UPDATE_ACL_EVENT_NAME handle, the message WM_PROFILE_UPDATED is posted to the GUI thread which receives the UPDATE_ACL_EVENT_NAME causing a connection to the to the SQL database at 3710. A query is then performed 3712 whereby all records with the field value UpdateFlag=‘1’ are placed into a solution set.

A loop is then entered at 3714 whereby each record from the solution set is queried for the profile name, type and last update date. More particularly the profile name acquired from the SQL query is compared with the value “ACL” and, if equal (3716), results in the profile being update at 3718. A comparison is also made of the profile name acquired from the SQL query with the name “Registry” and, if equal (3720) also results in the profile being updated. The same occurs if a comparison of the profile name acquired from the SQL query with the name “Port” is the same (3722).

When the update profile message (BTMSG_UPDATE_PROFILE) is posted to the broadcast events thread along with the object SVR_UPDATE_PROFILE (described below), the SQL database is updated at 3724 by setting all records with the field value updateFlag=‘1’ to updateFlag=‘0’. Thereafter, at 3726, a command (CMD_SVR_UPDATE_PROFILE) is sent to the remote computer associated with the broadcast events thread object. At this point 3728, the remote computer processes the command, so the server enters a waiting mode. When results are received from the remote computer, results are posted 3730 to the GUI thread, preferably in human readable form so that they appear in the log file and on the computer screen.

The data fields contained in the SVR_UPDATE_PROFILE structure are as follows:

| Type | Name | Description |
|---|---|---|
| TRUSTED_ID | computerID | 128-bit computer ID of the remote |
| | | computer. |
| char | profileType | Specifies the profile name that was |
| | | updated. This value is “ACL”, |
| | | “Registry” or “Port”. |
| PROFILE_INFO | ProfileInfo | Information about the specific |
| | | profile (named in the field above) |
| | | that has been update. See above |
| | | for details about the |
| | | PROFILE_INFO structure. |

CMD_EVENT_SVR_UPDATE_PROFILE—Remote Computer

If the remote computer establishes a listen (via the CMD_LISTEN_RQST command described above), then there is a Windows socket receive command waiting for activity on the TCP/IP channel established between the remote computer and the security server. When the security server sends the CMD_EVENT_SERVER_UPDATE_PROFILE command, the remote computer receives the command and updates its profile as discussed above.

CMD_EVENT_ASSESS_THREATS—Security Server

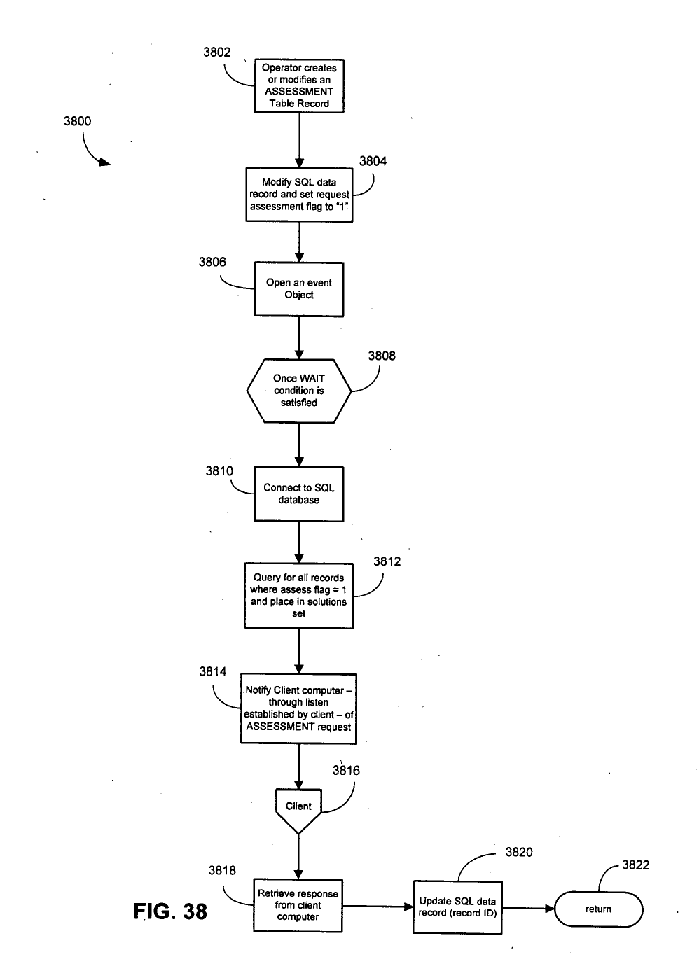

The security server sends the CMD_EVENT_ASSESS_THREATS command to remote computers that have established a listen channel through the CMD_LISTEN_RQST command. The CMD_EVENT_ASSESS_THREATS command is generated through the process 3800 (FIG. 38). A manager creates or modifies an Assessment Table record at 3802. The Assessment Table is an SQL table under the general SQL database. The Assessment Table preferably has the following structure:

| Type | Name | Description |
|---|---|---|
| CHAR | ComputerID | 128-bit unique identifier for the remote computer. |
| CHAR | RecordID | 128-bit unique record identifier that uniquely identifies this record. |
| CHAR | ResultsTable | The name of the table created to hold the results of the |
| | | assessment result. The structure of this table is described below. |
| TIMESTAMP | RequestDateTime | Date and time this record is created. |
| INT | DoRebootAnalysis | A flag indicating whether the remote computer is to perform |
| | | reboot analysis. If set to ‘1’, the remote computer will perform a |
| | | reboot analysis as part of the overall analysis procedure. |
| DATETIME | AssessmentDateTime | Date and time assessment is completed. |
| DATETIME | CleanDateTime | Date and time cleaning is completed. |
| INT | AssessmentResult | Result value from the remote computer. If this value is not zero, it |
| | | then contains an error code indicating why the assessment |
| | | process could not be completed. |
| INT | CleanResult | Result value from the remote computer. If this value is not 0, it |
| | | contains an error code indicating why the clean process could not |
| | | complete. |
| INT | RequestAssessmentFlag | If ‘1’, then an assessment event is for the remote computer |
| | | defined by the computerID field above, or, if queried, the remote |
| | | computer is informed to perform an assessment. |
| INT | RequestCleanFlag | If ‘1’, then a clean event is created for the remote computer |
| | | defined by the computerID field above, or, if queried, the remote |
| | | computer is informed to perform a clean. |
| INT | CleanAfterAssessment | If ‘1’, then remote computer is immediately cleaned after the |
| | | assessment results have been uploaded to the computer. All |
| | | threats defined within the assessment records will be cleaned. |

The creation or modification of the Assessment Table is also preferably performed through HTML code. The modified HTML code is sent from the manager's computer to the HTTP server. The HTTP server runs the CGI program ProAVAssessment. The ProAVAssessment program processes the HTML code and either creates or modifies the SQL Assessment record 3804 pertaining to the assessment request. The assessment record is based on the computer identification key.

The ProAVAssessment program ensures that there is only one record within the Assessment Table that contains the remote computer's 128-bit ID and that the AssessmentDateTime field is NULL (meaning there is no completion date). That is, there can be only one record with a non-complete date. During the record creation process, the field ‘RequestAssessmentFlag’ is set to 1. After creating or saving the SQL record, the ProAVAssessment process opens and raises a Windows event. Within the security server process, there is a “wait” condition set for event handle. When the process ProAVAssessment raises the event, the wait condition within the security server is satisfied 3808 and processing continues.

In response to satisfying the wait condition for the event handle, the message WM_ASSESSMENT_EVENT is posted to the GUI thread which connects to the SQL database at 3810 and performs an SQL query 3812 whereby all records with the field value RequestAssessmentFlag=‘1’ are placed into a solution set. A loop is then entered whereby each record from the solution set is queried for the record identifier field (recordID). A function is then called with the acquired record identifier and the contents of the ‘DoRebootAnalysis’ flag. Ultimately, the broadcast event thread then compares the parameter 128-bit computerID to the 128-bit computerID associated with the broadcast event object. If the two IDs are the same, it creates a PROAV_ASSESS_THREATS_EVENT structure, populates the structure with the record identifier and then posts the message BTMSG_ASSESSMENT_REQUEST to the broadcast events thread along with the object PROAV_ASSESS_THREATS_EVENT (described below). The SQL database is updated by setting all records with the field value RequestAssessmentFlag=‘1’ to RequestAssessmentFlag=‘0’. Upon receipt of the BTMSG_ASSESSMENT_REQUEST message, an ASSESSMENT notification function sends, at 3814, the command CMD_EVENT_ASSESS_THREATS along with the data contained in the PROAV_ASSESS_THREATS_EVENT structure to the remote computer associated with the broadcast events thread object.

At this point, 3816, the remote computer processes the command CMD_EVENT_ASSESS_THREATS. The results received from the remote computer 3824 indicate whether it started the ASSESSMENT process. A connection is then made to the SQL database and the SQL record associated with the assessment record identified by the ‘recordID’ value contained in the PROAV_ASSESS_THREATS_EVENT structure is updated 3820. The field value ‘AssessmentResult’ is set to the return value contained in the PROAV_SERVER_REPLY structure returned from the remote computer. Results are then posted to the GUI thread, again, preferably in human readable form. The results appear in the log file and on the computer screen. Flow then returns 3822.

The data fields contained in the PROAV_ASSESS_THREATS_EVENT structure are as follows:

| Type | Name | Description |
|---|---|---|
| TRUSTED_ID | computerID | 128-bit unique identifier for the |
| | | remote computer. |
| TRUSTED_ID | recordID | The record identifier of the newly |
| | | created Assessment Table record. |
| DWORD | doRebootAnalysis | A value indicating whether the |
| | | remote computer a is to perform a |
| | | reboot nalysis. This value is set to |
| | | 1 if the remote computer is to |
| | | perform a reboot analysis. |

CMD_ASSESS_THREATS—Remote Computer

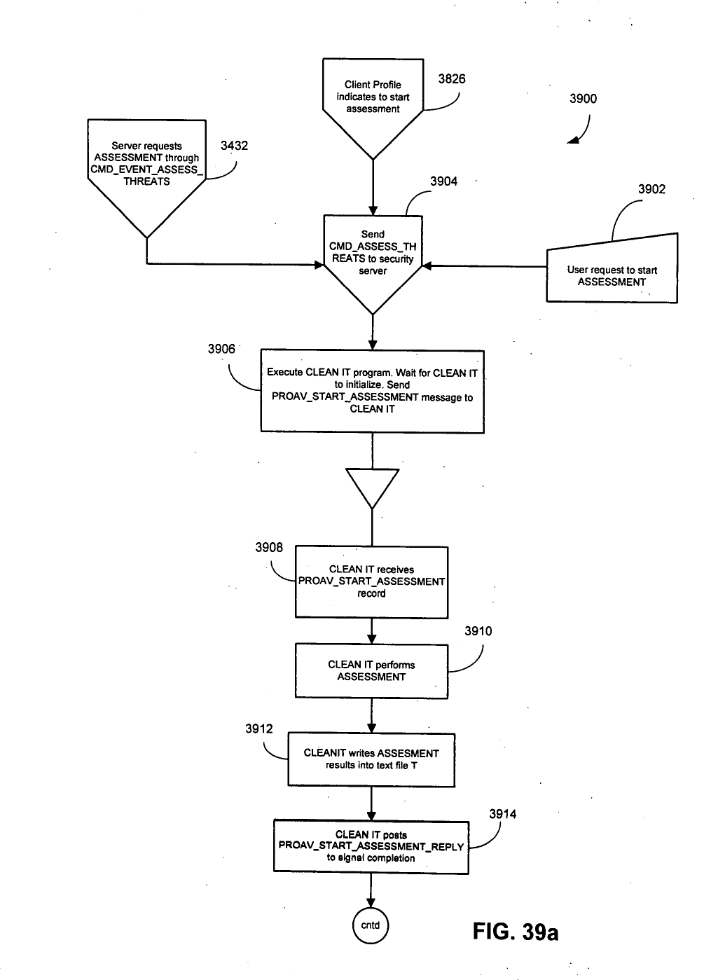

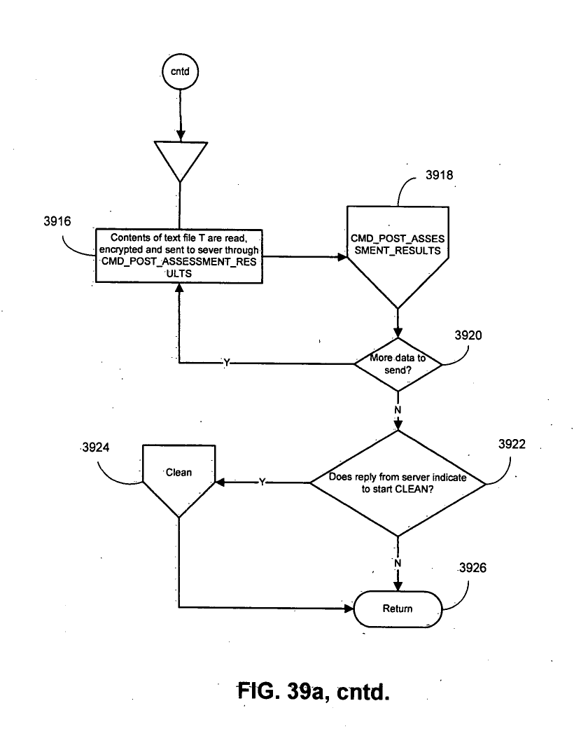

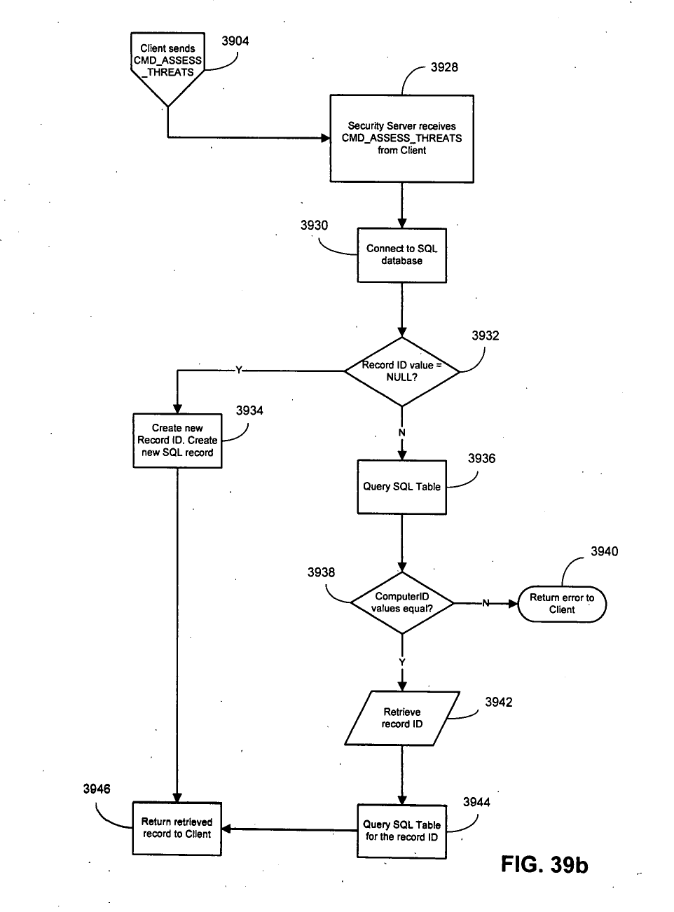

As shown by flow 3900 in FIG. 39a, the CMD_ASSESS_THREATS command is sent from the remote computer to the security server under three different scenarios. The first scenario (3432) arises when the remote computer responds to the CMD_EVENT_ASSESS_THREATS from the security server. The second scenario (3902) is when a local user, usually under the direction of a manager, starts the assessment process through a menu selection. The third scenario (3826 from FIG. 38b) arises when a remote computer attaches to the security server and, as a part of the connection process, the security server fills the CLIENT_SECURITY_INFO structure including the ‘assessThreatsFlag’ member. If this member is not zero, then the remote computer will send the CMD_ASSESS_THREATS command.

The remote computer, even under the first scenario (3432), for security purposes, requires the CMD_ASSESS_THREATS command. This ensures another computer posing as a security server cannot start the assessment process. This process is much like a “dial back” modem, whereby the modem accepts a command to “call”, but only calls a number stored in its memory. Because the assessment process gathers file and registry key information, this information is considered private and high value. Under the first scenario (3432), the remote computer receives the command CMD_EVENT_ASSESS_THREATS. The basic method used by the remote computer in response to the CMD_EVENT_ASSESS_THREATS command is to send the CMD_ASSESS_THREATS command to the security server at 3904 along with the record ID sent by the security server. Under the second scenario (3902), the user at the remote computer preferably enters the record ID through the keyboard, causing the remote computer to then sends the CMD_ASSESS_THREATS command.

Regardless of the origin of the record ID (user input or provided by the security server), the remaining tasks occur. The remote computer waits for a response from the security server. The security server processes the CMD_ASSESS_THREATS command by verifying the SQL Assessment record associated with the CMD_EVENT_ASSESS_THREATS event. Specifically, the security server verifies the 128-bit unique record identifier contained in the PROAV_ASSESS_THREATS object (defined below). Then, at 3906, the remote computer's link program launches the Clean It program 3906 and sends a message to the Clean It program to start the assessment process. Part of the message is a return windows handle. The Clean It program uses the “return” window handle to send a “keep alive” signal. This allows the link program to monitor the Clean It program to detect if it has “hung”. The link program returns status to the security server. The status code reflects with an error code from the Clean It program or an error code indicating the Clean It program could not be launched. It is important to note that the remote computer must have the correct record ID value when communicating with the security server. In the case whereby a user starts the process through a menu selection, the second scenario, then a dialog box is presented to the user whereby they enter the record ID by hand.

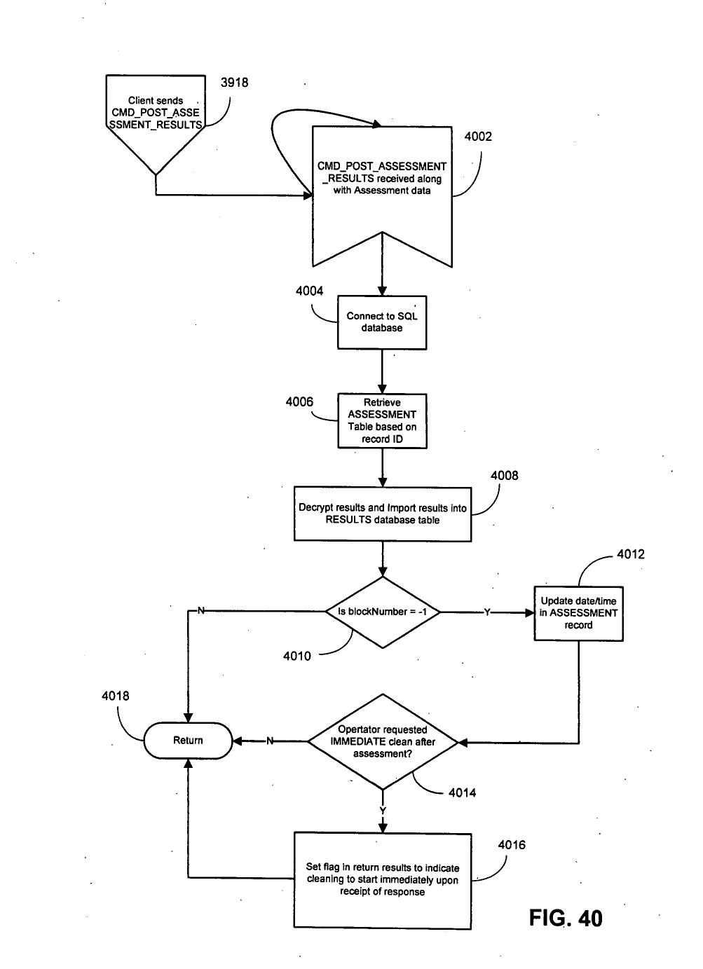

With continued reference to FIG. 39a, the CleanIt program receives the message to start an assessment at 3908 and performs the assessment at 3910 (all as discussed hereinabove in Section I). Results are written to a text file at 3912, and CleanIt posts at 3914 a message signal indicating completion of the assessment process. The contents of the text file are read, encrypted and sent to the security server at 3916, which continues to post the results 3918 (FIG. 40b below) until there is no more data to send at 3920. Then, at 3922, the server will indicated to the client whether or not cleaning is needed. If so, cleaning occurs 3924 (all as discussed above) before flow returns at 3926.

The data fields contained in the PROAV_ASSESS_THREATS structure are as follows:

| Type | Name | Description |
|---|---|---|
| TRUSTED_ID | recordID | Contents of the Assessment |
| | | Table recordID field. |
| PROAV_SERVER_REPLY | reply | Results of launching and |
| | | communicating the Clean It |
| | | program. |
| | | If this value is not 0, then the |
| | | assessment process does not |
| | | precede. |
| | | If the value is 0, the server |
| | | then responds indicating the |
| | | assessment process is to |
| | | proceed. |

The processing of the CMD_ASSESS_THREATS command is described in FIG. 38a with regard to CMD_EVENT_ASSESS_THREATS.
CMD_ASSESS_THREATS—Security Server

As mentioned above, the remote computer sends the CMD_ASSESS_THREATS command to the security server at 3904. The security server processes the command (FIG. 39b) by ensuring the information contained in the PROAV_ASSESS_THREATS structure are accurate. The security server receives the CMD_ASSESS_THREATS command at 3928 and then connects to the SQL data source 3930. At 3932 a comparison is made of the recordID value contained in the PROAV_ACCESS_THREATS with a NULL 128-bit ID value. If the recordID value is NULL value, then the method proceeds to create a new record ID and a new SQL record at 3934; else the method proceeds at 3936 to perform a record query on the SQL table for the record whereby the computerID value contained within the session thread object is compared to the computerID value contained in the PROAV_ACCESS_THREATS object at 3938. Again, the computerID value would have been previously set during the processing of the CMD_OPEN_SESSION command. If the values are not equal, an error code is returned to the remote computer at 3918; else the method proceeds to retrieve the record ID at 3942 from the SQL query performed above. The retrieved recordID value is stored in the PROAV_ASSESS_THREATS_REPLY object. A record query is then performed on the SQL table at 3944 for the record, whereby the recordID value is equal to the value contained in the PROAV_ASSESS_THREATS object. Then, at 3946, a return PROAV_ASSESS_THREATS_REPLY record is created and sent back to the remote computer via TCP/IP.

CMD_POST_ASSESSMENT_RESULTS—Remote Computer

As discussed above the in FIG. 39a (at 3918 thereof), the remote computer sends the CMD_POST_ASSESSMENT_RESULTS command to the security server. The command is sent after an assessment has been performed on the remote computer. Included with the command is the actual assessment data. The assessment data is returned in the structure PROAV_ASSESSMENT_RESULTS structure. Because the size of the resultant data might be larger than what can be transferred to the server in one block, a loop is entered. Each loop sends parts of the result file, preferably in encrypted form, to the security server.

At this point the security server processes the CMD_POST_ASSESSMENT_RESULT command (FIG. 40). The client subsequently receives a reply from the security server in the form of a PROAV_SERVER_REPLY structure until the function returns and no more data is sent to the security server. After the completion of the CMD_POST_ASSESSMENT_RESULTS command, the remote computer and the security server both wait (3922 in FIG. 39) for user input to start the clean process, unless the remote manager otherwise intervenes. The data fields contained in the PROAV_ASSESSMENT_RESULTS structure are as follows:

| Type | Name | Description |
|---|---|---|
| TRUSTED_ID | recordID | Contents of the Assessment Table |
| | | recordID field. |
| DWORD | blockNumber | Value indicating the block number. |
| | | This structure is sent repeatedly and, |
| | | with each transmission, the block |
| | | number is incremented. The security |
| | | server reacts to the block number to a) |
| | | recognize the 1^{st} block, b) recognize |
| | | intervening blocks and c) recognize |
| | | the last block. |
| | | The last block has a special value, −1. |
| DWORD | dataSize | The number of bytes contained in the |
| | | data array below |
| char | data[ ] | An array of data bytes. |

CMD_POST_ASSESSMENT_RESULTS—Security Server

With reference to FIG. 40 the assessment data sent to the security server once the remote computer completes its assessment is in the form of an encoded named pair file. The structure of the file, referred to as PROAV_ASSESSMENT_RESULTS structure is described below. Because the size of the result data might be larger than what can be transferred to the server in one block, a loop 4002 is entered. Each loop sends parts of the result file to the security server. As the security server receives a CMD_POST_ASSESSMENT_RESULTS command, it imports the data sent from the remote computer into an SQL data table named by the ResultsTable field. After the completion of the CMD_POST_ASSESSMENT_RESULTS command, the remote computer and the security server both wait for user input to start the clean process, unless the manager has specified to clean immediately after assessment results have been posted.

More particularly, at 4004 the security server makes a connection to the SQL data source, and a query value is performed on the SQL Assessment Table for the table record with matching unique record identifier value so that it may be retrieved 4006. The record identifier (recordID) is contained in the PROAV_ASSESSMENT_RESULTS structure. After decrypting the results and importing them into the results database table at 4008, a check is made of the block value contained in the PROAV_ASSESSMENT_RESULTS field. If the value is 0, then an SQL command is issued to delete all records contained in the Table named in the ResultsTable record.

Otherwise, if the block value contained in the PROAV_ASSESSMENT_RESULTS field is −1 at 4010, the AssessmentDateTime field value is updated at 4012 to reflect the current security server time, after which the ‘AssessmentResult’ field is set to 0. Unless an operator request and immediate cleaning at 4014, resulting in a flag being set at 4016 in the results field to indicate that cleaning is to start immediate, then flow returns. 4018.

CMD_EVENT_CLEAN—Security Server

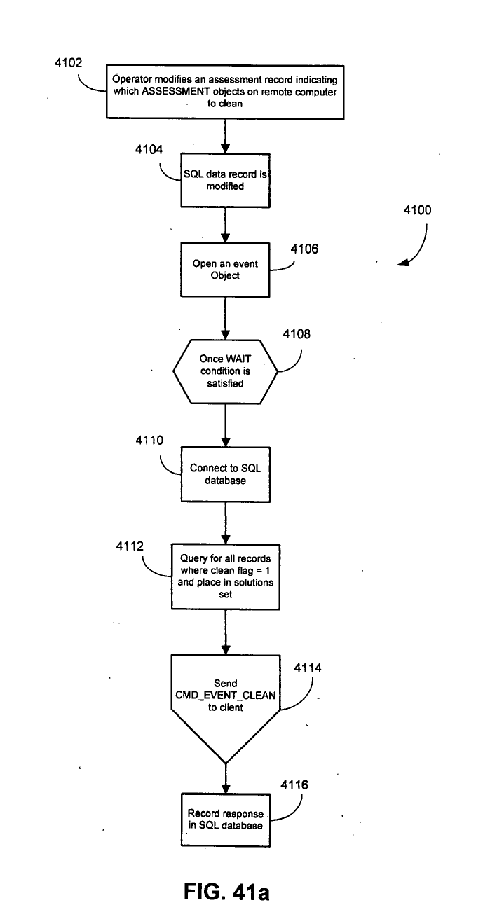

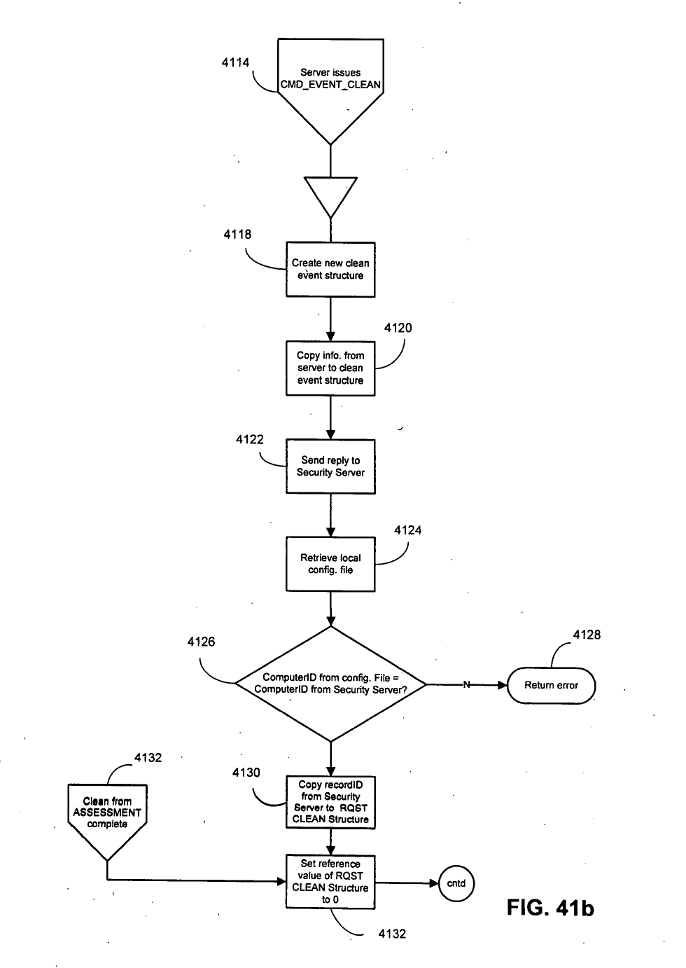

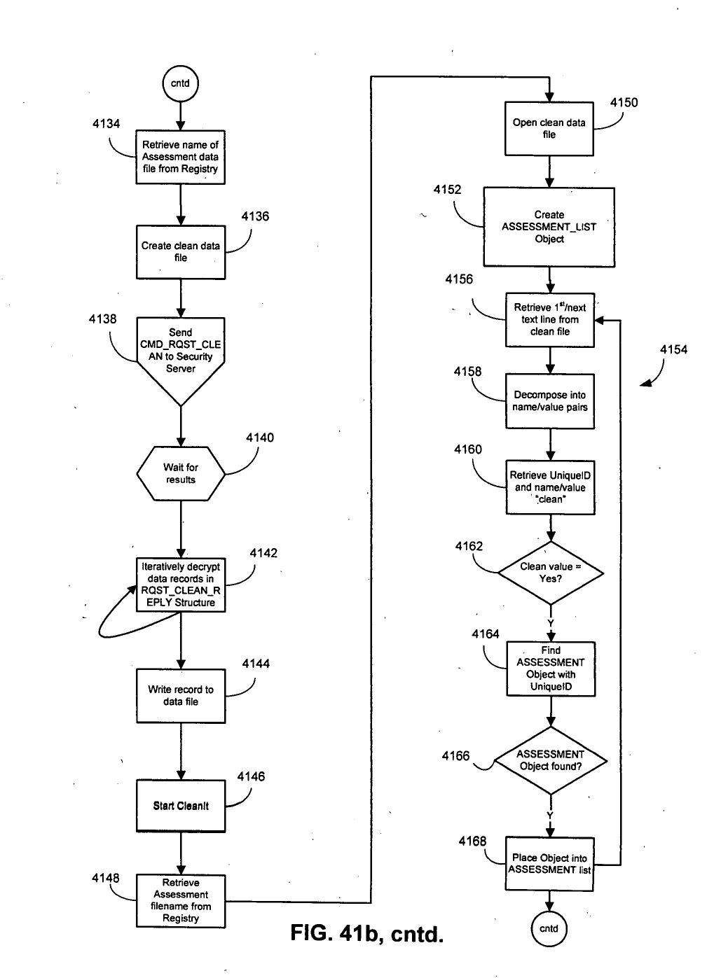

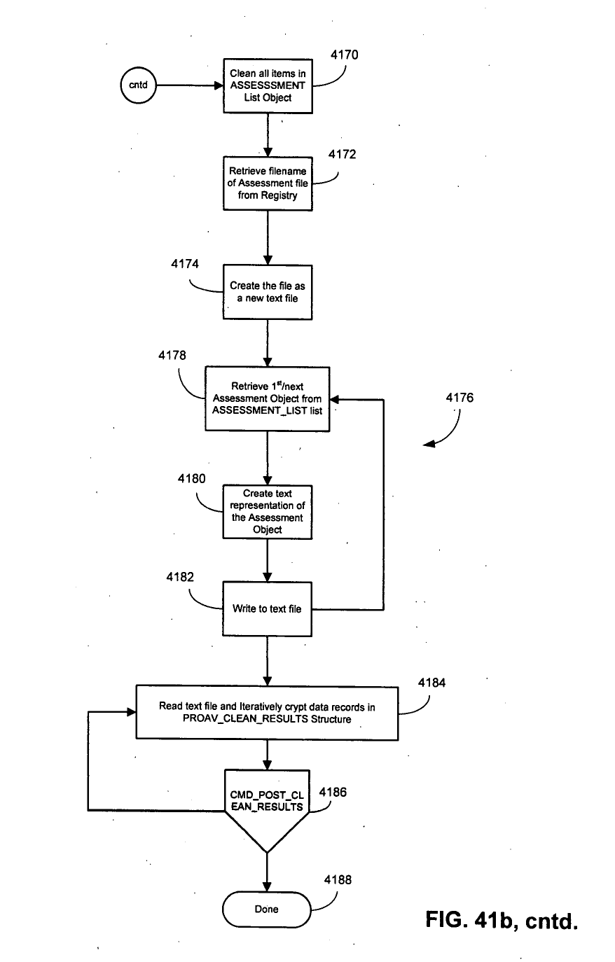

The security server sends the CMD_EVENT_CLEAN command to remote computers that have established a listen channel through the CMD_LISTEN_RQST command. The CMD_EVENT_CLEAN command is generated through the following process 4100 shown in FIG. 41a. At 4102 a manager creates or modifies an Assessment Table record through HTML code. The structure of this the Assessment Table was described above in Section I. The modified HTML code is sent from the manager's computer to the HTTP server. The HTTP server runs the CGI program ProAVAssessment. The ProAVAssessment program processes the HTML code and modifies the SQL Assessment record at 4104 based on the computer identification key (the 128-bit key that uniquely identifies a remote computer to the security server). The ProAVAssessment program seeks the SQL Assessment Table for the record containing the remote computer's 128-bit identifier (ComputerID field) and where the AssessmentDateTime field contains a valid date and where the CleanDateTime field contains a NULL or invalid date.

After saving the modified SQL record, the ProAVAssessment process at 4106 opens the Windows event referred to by appropriate event handle name.

Within the security server process, there is a “wait” condition set for the event handle. When the process ProAVAssessment raises the event, the wait condition within the security server is satisfied 4108 and processing continues.

In response to satisfying the wait condition for the handle, the message WM_CLEAN_EVENT is posted to the GUI thread, at which point 4110, a connection is made to the SQL database. An SQL query 4112 is then made whereby all records with the field value RequestCleanFlag=‘1’ are placed into a solution set. A loop is then entered whereby each record from the solution set is queried for the recordID and the computerID. A function is then called with the acquired record information. A broadcast events thread the compares the computerID associated with the broadcast events thread object with the computerID value sent as a parameter. If the values are not equal the method returns with an error; else the method proceeds to post the message BTMSG_CLEAN_REQUEST to the broadcast events thread, along with the object PROAV_EVENT_CLEAN. The SQL database is then updated by setting all records with the field value RequestCleanFlag=‘1’ to RequestCleanFlag=‘0’. When the BTMSG_CLEAN_REQUEST message is received a function is called which sends at 4114 the command CMD_EVENT_CLEAN to the remote computer associated with the broadcast events thread object.

At this point, the remote computer processes the command. When results are received from the remote computer, the assessment record associated with the recordID contained in the PROAV_EVENT_CLEAN structure is updated 4116, and the field ‘CleanResult’ is set to the value returned from the remote computer. The value is found in the return structure PROAV_SERVER_REPLY member field ‘error Code’. The results indicate whether the remote computer started the assessment process and can be posted to the GUI thread in human readable form on the computer screen, as well as in a log file.

CMD_EVENT_CLEAN—Remote Computer

With reference to FIG. 41b, when the CMD_EVENT_CLEAN command from the security server 4114 is received by the client a new PROAV_CLEAN_EVENT structure is created 4118. The information sent from the security server is then copied 4120 into the new PROAV_CLEAN_EVENT structure (described below). A reply structure, PROAV_SERVER_REPLY, is then sent back to the security server at 4122. The remote client then retrieves the local configuration file 4124 and at 4126 compares the computer ID value retrieved from the local configuration file with the computer ID value contained in the PROAV_CLEAN_EVENT structure. If the values are not the same, an error is returned 4128; otherwise at 4130 the recordID value contained in the PROAV_CLEAN_EVENT structure is copied into the PROAV_RQST_CLEAN structure. The reference value in the PROAV_RQST_CLEAN structure is then set to 0 at 4132. This value is used by the security server to indicate the next record to retrieve from the SQL database to return to the remote computer. The value of 0 indicates that the 1^{st} record is to be retrieved from the Assessment table associated with the 128-bit record identifier.

The name of the ASSESSMENT data file is retrieved from the registry at 4134, and a clean data file created at 4136. The name of the file is found from the remote computer's registry. Each record in the clean data file is associated with an object contained in the ASSESSMENT_LIST list held by the threat list window. The command CMD_RQST_CLEAN is sent to the security server at 4138 along with the contents of the PROAV_RQST_CLEAN structure. At this point, the security server processes the CMD_RQST_CLEAN command, so the client waits 4140. Upon receipt of the results, in the form of a PROAV_RQST_CLEAN_REPLY structure, the client iteratively decrypts the data contained in the PROAV_RQST_CLEAN_REPLY record 4142 until there no more data records available from the security server, and then writes the data to the file created at 4144.

The client returns the “error Code” value contained within the PROAV_SERVER_REPLY structure sent from the security server. If the error code returned is equal to 0 (meaning no error), then CleanIt( ) is called 4146 with the parameter PROAV_START_CLEAN. The CleanIt executable and the message PROAV_START_CLEAN is posted to the current instance of the threat list window, which then invokes a function to start a remote clean. Initially, the filename of the assessment file is retrieved from the registry 4148. Then a clean data file is opened 4150 and an ASSESSMENT_LIST list object created 4152.

A loop 4154 is then entered whereby the next line is retrieved from the file which has been opened at 4156 and decomposed into name value pairs 4158. For each name, there is a corresponding value. The name values are listed below in the table below. At 4160 the name value pair ‘UniqueID’ and the name value pair ‘clean’ are retrieved. If the ‘clean’ value is ‘yes’ at 4162 then flow proceeds to 4164 to find, within the threat list window, the ASSESSMENT object with the same UniqueID identifier value. Assuming the ASSESSMENT object is found at 4166 it is placed into the ASSESSMENT_LIST list object created above at 4152.

| Name | Description |
|---|---|
| UniqueID | 128-bit unique record identifier |
| ThreatLevel | Threat level in string form. For example, |
| | “SEVERE” or “HIGH” |
| Filename | The filename of the threat if exists |
| RegistyKey | The registry key name of the threat if it exists |
| IsInMemory | If true, then filename represents a process in |
| | memory |
| ProcessID | If “IsInMemory” value is true, then this contains |
| | the process identifier. |
| KnownVirus | If threat is found in database of know viruses |
| VirusName | If threat is found in database of known viruses, |
| | this contains the virus name |
| RemovalCodes | Removal instructions for known virus threats |
| ReasonWhyAThreat | Contains human readable text as to why object |
| | is a threat |
| RelatedRegistryEntries | Related registry entries of the threat |

Once loop 4154 is completed, the message GUIMSG_START_REMOTE_CLEAN is then sent to the database thread which cleans all items in the ASSESSMENT_LIST list object 4170. This process is described in detail above in Section I relation to removing items from the computer. After all items have been cleaned the database thread posts the message GUIMSG_FINISH_REMOTE_CLEAN to the threat list window. At 4172 the filename of the assessment file is retrieved from the registry, and a new text file created 4174. Another loop 4176 is entered whereby the next ASSESSMENT object is retrieved from the ASSESSMENT_LIST list 4178, a text representation of the ASSESSMENT object is created 4180 and written to a text file 4182. The data records within the text of the PROAV_CLEAN_RESULTS structure are iteratively decrypted at 4184, after which the CMD_POST_CLEAN_RESULTS command is generated 4186. The message PROAV_START_CLEAN_REPLY is posted to the original window that posted the PROAV_START_CLEAN message, resulting in the server link thread calling the security server at 4200. The security server receives the CMD_POST_CLEAN_RESULTS at 4200, connects to the SQL database at 4202 and retrieves the SQL assessment table name from the SQL record matching the remote computer ID at 4204. The SQL assessment table is then populated with the results of the clean operation at 4026. For each assessment result, the uniqueID referenced above at 4166 is used as a table lookup in the SQL assessment table. When the record is found, name/values collected at 4158 are saved to the record. This iteration continues at 4206 until no more assessment results are available. The security server then sends a status back to the remote computer at 4210.

The data fields contained in the PROAV_CLEAN_EVENT structure are as follows:

| Type | Name | Description |
|---|---|---|
| TRUSTED_ID | computerID | The 128-bit identifier for the remote |
| | | computer. |
| TRUSTED_ID | recordID | The 128-bit identifier for the SQL |
| | | Assessment Table record. |

CMD_RQST_CLEAN—Remote Computer

The CMD_RQST_CLEAN command is sent from the remote computer to the security server under two different scenarios. The first scenario (4138 in FIG. 41b) occurs when the remote computer responds to the CMD_EVENT_CLEAN. The second scenario is when a local user, usually under the direction of a manager, starts the assessment process through a menu selection. As mentioned above, for security purposes the remote client, even under the first scenario, requires the CMD_EVENT_CLEAN command. After sending the command, the remote client receives clean data from the security server along with a value indicating the remote computer can commence with cleaning. This process is iterative (that is, the CMD_RQST_CLEAN command is set repeatedly sent).

The data received from the security server is the same data as sent from the remote computer to the security server. However, the data has been processed by a manager who, through his/her web browser, has been able to select which items are to be cleaned. After the data has been sent to the remote computer through the CMD_RQST_CLEAN command, then a message is posted to the ThreatListWindow to start the cleaning process.

CMD_RQST_CLEAN—Security Server

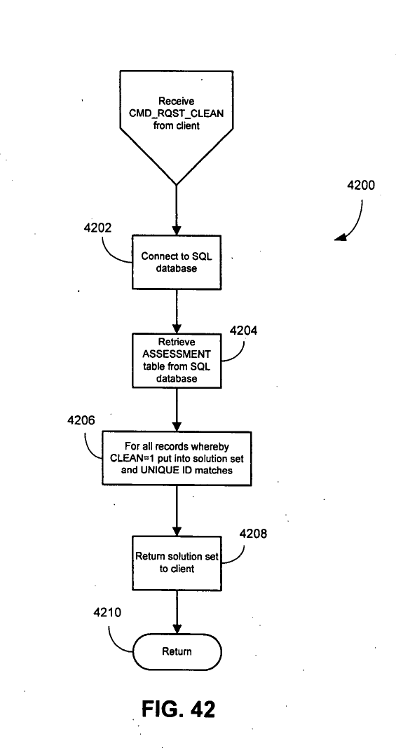

The security server processes the CMD_RQST_CLEAN command at 4200 in FIG. 42 by verifying the information passed in the PROAV_RQST_CLEAN structure to the security server in association with the CMD_RQST_CLEAN command.

The data fields contained in the PROAV_RQST_CLEAN structure are as follows:

| Type | Name | Description |
|---|---|---|
| TRUSTED_ID | recordID | Contains the 128-bit record ID of the |
| | | assessment record. |
| TRUSTED_ID | computerID | Contains the 128-bit computer |
| | | identifier of the remote computer. |
| DWORD | reference | A reference number controlled by the |
| | | Security Servcer. This number represents |
| | | the next data record number used to |
| | | retrieve clean data. |

The security server replies with a PROAV_RQST_CLEAN_REPLY structure. The data fields contained in the PROAV_RQST_CLEAN_REPLY structure are as follows.

| Type | Name | Description |
|---|---|---|
| PROAV_SERVER_REPLY | reply | Results of launching and communicating the Clean It program. |
| | | If this value is not 0, then the assessment process does not |
| | | precede. |
| | | If the value is 0, the server then responds indicating the |
| | | assessment process is to proceed. |
| TRUSTED_ID | recordID | 128-bit record ID |
| DWORD | reference | Reference number. If −1 then this is the last block and the |
| | | CMD_RQST_CLEAN command will not be sent again. This |
| | | value is placed into the PROAV_RQST_CLEAN structure |
| | | reference value. |
| DWORD | dataSize | Size of data in data[ ] array. |
| char | data[ ] | Data array. |

Upon receipt of the CMD_RQST_CLEAN command, the server connects to the SQL data source 4202 and performs a record query on the SQL table for the record whereby the recordID value is equal to the value contained in the PROAV_RQST_CLEAN structure. At 4204, the security server retrieves the name of the ResultsTable name from the SQL query performed above and starts a write pointer where data from the ResultsTable table is placed. A loop is then entered at 4206 whereby the next record from the Results Table table (i.e., the table named in the ResultsTable record) is retrieved, starting at the record number defined by the “reference” value in the PROAV_RQST_CLEAN structure.

The manager has the ability, through his/her web browser, to access the Results Table records and change the “clean” value through HTML code. Thus, for each record encountered during the loop 4206, an inspection is made of the clean field. If this value is 1, then the record is translated into encrypted text and placed into the PROAV_RQST_CLEAN_REPLY structure If there are no more records in the solution set then the “reference” value is set to −1. Then, at 4208, the PROAV_RQST_CLEAN_REPLY structure solution set is returned to the remote client before flow returns at 4210.

CMD_POST_CLEAN_RESULTS—Remote Computer

It is recalled that, at 4186 in FIG. 41b, the remote computer sends the CMD_POST_CLEAN_RESULTS command to the security server. The command is sent after the remote computer has been cleaned. Included with the command is the actual result data. The result data is returned in the structure PROAV_CLEAN_RESULTS structure. The format of the PROAV_CLEAN_RESULTS structure is described below.

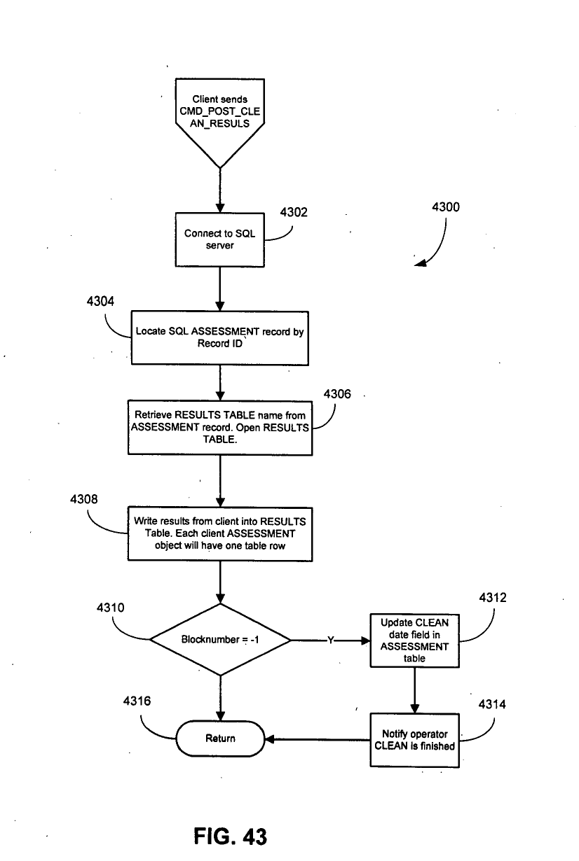

In general terms, the method of the CMD_POST_CLEAN_RESULT command is as follows. The remote computer completes the cleaning process and sends CMD_POST_CLEAN_RESULTS command to the security server along with assessment data contained in a PROAV_CLEAN_RESULTS structure. Because the size of the result data might be larger than what can be transferred to the Server in one block, a loop is entered. Each loop sends parts of the result file to the security server. As the security server receives a CMD_POST_CLEAN_RESULTS command (FIG. 43), it imports the data sent from the remote computer into the data table named by the ResultsTable field. After the completion of the CMD_POST_CLEAN_RESULTS command, the remote computer and the security server both terminate the assessment/clean process. If configured, a security server notification will be sent to the list of respondents listed for notification.

The data fields contained in the PROAV_CLEAN_RESULTS structure are as follows:

| Type | Name | Description |
|---|---|---|
| TRUSTED_ID | recordID | Contents of the Assessment Table |
| | | recordID field. |
| DWORD | blockNumber | Value indicating the block number. This |
| | | structure is sent repeatedly and, with |
| | | each transmission, the block number is |
| | | incremented. The security server reacts |
| | | to the block number to a) recognize the |
| | | 1^{st} block, b) recognize intervening |
| | | blocks and c) recognize the last block. |
| | | The last block has a special value, −1. |
| DWORD | dataSize | The number of bytes contained in the |
| | | data array below. |
| char | data[ ] | An array of data bytes. |

The details of the CMD_POST_CLEAN_RESULTS are more particularly as follows. Initially, the file name of the current assessment file is retrieved from the registry and the PROAV_CLEAN_RESULTS structure is created by allocating the largest block TCP/IP block size (a constant number that has been determined heuristically) and then populating the structure fields. Importantly, sets the “blockNumber” to 0 and sets the recordID field equal to the recordID passed from the security server to the remote computer. The data from the file is then read into a buffer, and the recordID value retrieved from the security server is copied into the PROAV_CLEAN_RESULTS structure.

The PROAV_ASSESSMENT_RESULTS structure is populated and the data buffer in the PROAV_ASSESSMENT_RESULTS structure is encrypted. The CMD_POST_CLEAN_RESULT command to the security server along with the PROAV_CLEAN_RESULTS structure. At this point the security server processes the CMD_POST_CLEAN_RESULT command. (FIG. 43). Eventually, the client receives a reply from the security server in the form of a PROAV_SERVER_REPLY structure. If the error Code value within the PROAV_SERVER_REPLY structure is NOT equal to 0, then the function returns and no more data is sent to the security server.

CMD_POST_CLEAN_RESULTS—Security Server

With reference to FIG. 43, the security server receives the CMD_POST_CLEAN_RESULTS command and essentially “closes” the assessment/cleaning session. The security server update the record associated with the recordID contained in the PROAV_CLEAN_RESULTS structure.

More particularly, as shown by flow 4300, a connection is made to the SQL data source at 4302 and the Assessment table record data indexed by the recordID field in the PROAV_CLEAN_RESULTS structure is located at 4304, the RESULTS TABLE name from ASSESSMENT record. Is retrieved and opened at 4306, and results are written from client into the RESULTS Table at 4308. At this point. each client ASSESSMENT object will have one table.

Then, at 4310, the block value contained in the PROAV_CLEAN_RESULT field is checked. If the value is −1, then the CleanDateTime field value is updated at 4312 to reflect the current security server time, and the ‘CleanResult’ field is set to 0. The data field within the PROAV_CLEAN_RESULTS structure is then decrypted and a loop is entered whereby all information contained in the PROAV_CLEAN_RESULT data field is copied to the SQL table named by the Assessment Table ‘ResultsTable’ record. The loop copies record information contained within the PROAV_CLEAN_RESULTS data to the table named in the ResultsTable record field. The data records within the ResultsTable table are updated, and the ‘UniqueID’ is used as a key. A PROAV_SERVER_REPLY structure back to the remote computer indicating records have been copied or an error, and the operator is notified at 4314 that cleaning has finished before returning 4316.

Accordingly, the present invention has been described with some degree of particularity directed to the exemplary embodiments of the present invention. While a number of exemplary aspects and embodiments have been discussed, those of skill in the art will recognize certain modifications, permutations, additions and sub-combinations thereof, and it is therefore intended that the invention be interpreted to include all such modifications, permutations, additions and sub-combinations within its true spirit and scope.

What is claimed is:

1. A method for assessing threats within a computer system, comprising:
a. detecting hidden processes in the computer system's memory, and identifying each said hidden process as an associated assessment object;
b. performing a reboot check to identify any registry keys that are modified during a computer shutdown process, and identifying each modified registry key as an associated assessment object; and
c. performing a threat assessment on each identified assessment object to ascertain a threat level corresponding thereto.

2. A method according to claim 1 whereby detecting hidden processes is accomplished by:
a. querying the operating system (OS) to return a first set of process IDs corresponding to those processes which are currently in memory;
b. identifying a target set of process IDs ranging from a user-defined lower threshold value to a user-defined higher threshold value which is greater than a maximum process ID within the first set;
c. querying and the OS to return the status of processes in memory having process IDs which correspond to the target set, thereby to generate a second set of process IDs; and
d. identifying as a hidden process in memory each process ID within the second set which is not within the first set.

3. A method according to claim 1 whereby said to reboot check generates a first registry key list prior to reboot, a second registry key list upon restart, and compares the first and second registry key lists to store as an assessment object any detected anomaly between them.

4. A method according to claim 1 whereby said threat assessment is performed by ascertaining at least one of:
a. whether the assessment object represents a COM server;
b. whether the assessment object contains a filename which is within a database of known threats;
c. whether the assessment object contains registry information;
d. whether the assessment object contains process information;
e. whether the assessment object's file attribute is set as “hidden” or “system” by the operating system;
f. whether the assessment object is attempting to conceal itself;
g. whether the assessment object is attempting to prevent itself from being unloaded from memory; and
h. whether the assessment object has an improper file extension.

5. A method according to claim the I whereby said threat assessment corresponds to one of a plurality of a threat levels.

6. A method according to claim 5 wherein said plurality of threat levels corresponds to:
a. a first threat level to indicate that the detected threat is in memory and active;
b. a second threat level to indicate that the detected threat is on disk, but not in memory;
c. a third threat level to indicate that a detected file or registry key was installed into the computer system after the last certification date and is in memory;
d. a fourth threat level to indicate that a detected file or registry key was installed into the computer system after the last certification date but is not in memory; and
e. a death threat level to indicate the absence of a threat.

7. A method according to claim 1 comprising removing the threat to the computer system that is associated with each identified assessment object.

8. A method according to claim 4 wherein the database of known threats is selected from a group consisting of an open-source anti-virus database, a trusted manufacturer database, and a user-defined threats database.

9. A method according to claim 4 whereby, upon determining that the assessment object represents a COM server, at least one of the following determinations are made:
a. whether the class ID (CLSID) associated with the assessment object is within a CLSID table of known threats; and
b. whether the assessment object's program ID (PROGID) is within a table of known PROGID threats.

10. A method according to claim 4 whereby, upon determining that the assessment object contains registry information, a determination is made to ascertain if it's corresponding registry key is new.

11. A method according to claim 10 whereby said assessment object is deemed a threat if its corresponding registry key is new.
